(19) United States
(12) Patent Application Publication
(10) Pub. No.: US 2006/0187676 A1
(43) Pub. Date: Aug. 24, 2006

(54) Light guide plate, light guide device, lighting device, light guide system, and drive circuit

(75) Inventor: Takuro Ishikura, Kashihara-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/355,615

(22) Filed: Feb. 15, 2006

(30) Foreign Application Priority Data
Feb. 18, 2005 (JP) JP2005-043221
Apr. 27, 2005 (JP) JP2005-130564
Sep. 21, 2005 (JP) JP2005-274745

(51) Int. Cl. F21V 7/04

(52) U.S. Cl. 362/615

(57) ABSTRACT

A light guide plate 2 in accordance with the present invention includes a bend section 13 in which external light incident to a surface opposite a surface 11a is turned into a direction from a surface 13d to the surface 11c by one reflection so that the light enters a light guide section 11. Therefore, a light guide plate realized which is applicable in reducing the thickness of a backlight device and increasing the illumination surface of the backlight device in area.

This nonprovisional application claims priority under 35 U.S.C. § 119(a) on Japanese Patent Applications (Tokugan) No. 2005-43221 filed Feb. 18, 2005, No. 2005-130564 filed Apr. 27, 2005, and No. 2005-274745 filed Sep. 21, 2005, the entire contents of which are hereby incorporated by reference.

### FIELD OF THE INVENTION

The present invention relates to a light guide plate (light guide device) which guides incident light inside it so that the guided light can exit through a predetermined surface. The invention also relates to a lighting device including the light guide plate, a light guide system including a set of such light guide plates, and a drive circuit for the lighting device.

### BACKGROUND OF THE INVENTION

Liquid crystal displays have been well known. The liquid crystal display has a backlight which projects light from behind the liquid crystal panel. The backlight is either of a direct type or an edge-lit type.

In direct backlighting, a fluorescence lamp or like light source projects light to an opaque plate from behind the plate. The projected light is diffused uniformly by the opaque plate so that light is projected from behind the liquid crystal panel.

In contrast, in edge-lit types, a transparent acrylic plate is used as light guide unit with a light source provided at an end of that plate. After undergoing multiplex reflections inside the light guide unit, light is projected to the liquid crystal panel from the surface of the acrylic plate facing the panel.

FIG. 76 is a schematic illustration of a cross-section of a liquid crystal display equipped with an edge-lit type backlight. As shown in the figure, a liquid crystal display 280 includes a backlight 281, a reflection sheet 282, and a liquid crystal panel 283. The backlight 281 includes an edge light 291, a transparent acrylic plate 292, and light scattering sections 293.

In the following, a surface of the acrylic plate 292 on which light from the edge light 291 impinges will be referred to as a surface 292a. Likewise, other surfaces of the acrylic plate 292 which sit parallel to the display surface of the liquid crystal panel 283 will be referred to as a surface 292b and a surface 292c in the order as viewed from the liquid crystal panel. Further, the surface of the acrylic plate 292 which is opposite the surface 292a will be referred to as the surface 292d.

Light (predetermined light) from the edge light 291 enters the acrylic plate 292 through the surface 292a. The light undergoes total reflections from the surfaces, or interfaces, 292b, 292c as it is being guided toward the surface 292d. Some of the total reflection is scattered by light scattering sections 293 on the surface 292c. Part of the scattered light, which does not undergo total reflection from the surface 292b of the acrylic plate 292, exits through the surface 292b toward the liquid crystal panel 283.

The light scattering sections 293 are made of, for example, multiple circular geometric patterns as shown in FIG. 77. The circular patterns have circles with centers being separated by the same intervals from each other; the radii of the circles grow with the distance from the surface 292a. In other words, the farther away from the edge light 291, the larger the radii of the circles. The following explains why this is so.

The amount of light which enters the acrylic plate 292 from the edge light 291 decreases as it is being guided. Therefore, the increasing radii of the circles with the distance from the surface 292a prevents the amount of scattered light from decreasing, thereby rendering uniform the light exiting through the surface 292b. This explains why the circles' radii are changed monotonously as above.

The reflection sheet 282 returns the light leaking through the surface 292c other than those parts corresponding to the light scattering sections 293 to the acrylic plate 292. The sheet 282 thus increases the amount of light projected to the liquid crystal panel.

In addition, Nikkei Electronics, 20 Dec. 2004 Issue, pp. 57 to 62 describes the structure of a backlight with an edge light. The edge light is built around light emitting diodes (“LEDs”) as illustrated in FIG. 78 as a backlight 300. In this structure, light from an LED 301 reflects from a first mirror 302 so that it is directed to a first light guide plate 303. The light having exited the first light guide plate 303 reflects from a second mirror 304 so that it is directed to a second light guide plate 305 installed opposite a liquid crystal panel.

Back to the conventional direct backlight, its opaque plate does not allow for multiplex reflections of light inside it as does the edge-lit type backlight. Therefore, to achieve lighting with sufficient and uniform luminance, the light source needs be sufficiently separated from the opaque plate. This requirement is a hindrance in the attempt to reduce the size of the liquid crystal display.

The conventional edge-lit type backlight allows for reductions in the thickness of the liquid crystal display. Problems arise as below however if one wants to increase the size of the acrylic plate 92 along the light guide (that is, the length L in FIG. 77).

If the radii of the circles (dark circles in the figure) were increased with the distance from the surface 292a as above, the circles would be completely distorted beyond a certain distance due to the extra size of the acrylic plate 92. The light exiting through the surface 292b is no longer uniform.

Another approach to size enlargement is to dispose all multiple backlights 281 in a direction as shown in FIG. 79. However, it is difficult to arrange the edge lights 291 at desired positions with high accuracy, because the edge lights 291 are placed between two acrylic plates.

In addition, in the structure described in the aforementioned Nikkei Electronics article, LED-emitted light is reflected multiple times, which makes it difficult to reduce the thickness of the device itself.

### SUMMARY OF THE INVENTION

The present invention has an objective to provide a light guide plate/device applicable to a thin backlight device with a large illumination surface. It is also the objective of the invention to provide a lighting device including such a light guide plate/device, a light guide system including the light guide plate/device, and a drive circuit for the lighting device.

To achieve the objectives, a light guide plate in accordance with the present invention includes: a light guide section for guiding predetermined light incident from a pre-set direction along a predetermined surface so that the incident light exits through the predetermined surface; and a bend section for turning external light incident to a surface opposite the predetermined surface into the pre-set direction by one reflection so that the external light enters the light guide section.

According to the structure, the bend section turns the external light incident to a surface opposite the predetermined surface into the pre-set direction by one reflection so that the light enters the light guide section. In addition, the light guide section guides the light turned into the pre-set direction and entering the light guide section so that the light exits through the predetermined surface.

Since a single reflection brings the light into the light guide section, the light guide plate itself can be made relatively thin when compared to structures where multiple reflections are involved.

In addition, the light guide section guides the predetermined light along the predetermined surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface.

Therefore, the resultant light guide plate is suitable for reducing the thickness of the backlight device and increasing the illumination surface of the backlight device in area.

To achieve the objectives, another light guide plate in accordance with the present invention includes: a light guide section for guiding light incident from a fifth direction along an illumination surface so that the incident light exits through the illumination surface; and a second surface including: a reflection region for turning external light incident to a surface opposite the illumination surface into the fifth direction by one reflection so that the external light enters the light guide section; and a transmission region allowing the external light to pass therethrough toward the illumination surface.

According to the structure, the reflection region on the second surface turns the external light incident to the surface opposite the illumination surface into the fifth direction by one reflection so that the light enters the light guide section. In addition, the light guide section guides the light turned into the fifth direction and entering the light guide section so that the light exits through the illumination surface.

Since a single reflection brings the light into the light guide section, the light guide plate itself can be made relatively thin when compared to structures where multiple reflections are involved.

In addition, the light guide section guides the light incident from the fifth direction along the illumination surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the illumination surface can be readily combined with other such surfaces in a matrix when compared to the structure of conventional edge-lit type backlights. These individual factors all facilitate the realization of a large illumination surface for a backlight device.

Therefore, the resultant light guide plate is suitable for reducing the thickness of the backlight device and increasing the illumination surface of the backlight device in area.

To achieve the objectives, another light guide plate in accordance with the present invention includes: a light guide section for guiding predetermined light incident from a sixth direction along a predetermined surface so that the incident light exits through the predetermined surface; a bend section for turning external light incident to a surface opposite the predetermined surface into a seventh direction by one reflection; and another light guide section for guiding inside thereof the external light turned into the seventh direction by total reflection and reflecting that light into the sixth direction from a plurality of reflection surfaces so that the light enters the light guide section, wherein the reflection surfaces grow in area with increasing distance from the bend section.

According to the structure, the bend section turns the external light incident to a surface opposite the predetermined surface into the seventh direction by one reflection. In addition, the other light guide section reflects the external light turned into the seventh direction from the reflection surfaces into the sixth direction so that the light enters the light guide section. Further, the light guide section guides the light reflecting into the sixth direction and being incident to the light guide section so that the light exits through the predetermined surface.

Since a single reflection brings the light into the other light guide section, the light guide plate itself can be made relatively thin when compared to structures where multiple reflections are involved.

In addition, the light guide section guides the predetermined light along a predetermined surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface.

Therefore, the resultant light guide plate is suitable for reducing the thickness of the backlight device and increasing the illumination surface of the backlight device in area.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1 is a perspective view of a light guide plate in accordance with the present embodiment.

FIG. 2 is an illustration of a layout of LEDs.

FIG. 3 is a cross-sectional view of the light guide plate taken along line A-A′.

FIG. 4 is a graph representing a relationship between the angle of radiation, φ, of light from an LED and the angle α between an optical path of light immediately after entering a light guide section and the surface of the light guide section facing liquid crystal.

FIG. 5 is a cross-sectional view of a light guide plate in accordance with another embodiment.

FIG. 6 is a graph representing relationships between the angles φ and α for various tilt angles of the surface of the light guide section.

FIG. 7 is a perspective view of a light guide plate in accordance with another embodiment.

FIG. 8 is an enlarged view of a major part of a light guide plate with a reflection plate.

FIG. 9 an illustration of the structure of a light guide plate in accordance with another embodiment.

FIG. 10 is an illustration of an illumination surface of a light guide system including a matrix of light guide plates.

FIG. 11 is an illustration of a drive circuit for the light guide system.

FIG. 12 is an illustration of an exemplary layout of photodiodes.

FIG. 13 is an illustration of another exemplary layout of photodiodes.

FIG. 14 is a perspective view of a light guide plate in accordance with another embodiment.

FIG. 15 is a top view of the light guide plate.

FIG. 16 is an enlarged view of a major part of the light guide plate.

FIG. 17 is an illustration of optical paths in the light guide plate.

FIG. 18 is an illustration other optical paths in the light guide plate.

FIG. 19 is an illustration of the optical path of a reflection from a bend section of a light guide plate and also the optical path of that reflection as it impinges on a light guide section.

FIG. 20 is an illustration of a relationship between the angles, β and γ, indicated in FIG. 19 when two surfaces of the bend section produce a square projection on the illumination surface of the light guide section.

FIG. 21 is an illustration of a relationship between the angles, β and γ, indicated in FIG. 19 when two surfaces of the bend section produce a rectangular projection on the illumination surface of the light guide section, with sides of the rectangle parallel to the intersecting line of the two surfaces being as long as 1.5 times the other sides.

FIG. 22 is an enlarged view of a major part of the light guide plate together with the light guide section contained in it when the light guide section is changed in shape.

FIG. 23 is an illustration of a layout of two red LEDs, two green LEDs, and two blue LEDs.

FIG. 24 is an illustration of a layout of one red LED, two green LEDs, and two blue LEDs.

FIG. 25 is a perspective view of a light guide plate in accordance with the present embodiment.

FIG. 26 is a perspective view of a first member which is a structural member of the light guide plate in FIG. 25.

FIG. 27 is a perspective view of a second member which is a structural member of the light guide plate in FIG. 25.

FIG. 28 is an illustration of a layout of LEDs.

FIG. 29 is a cross-sectional view of the light guide plate taken along line A-A′ in FIG. 25.

FIG. 30 is a graph representing a relationship between the angle of radiation, φ, of light from an LED and the angle α between an optical path of light immediately after entering a light guide section and the surface of the light guide section facing liquid crystal.

FIG. 31 is a cross-sectional view of the light guide plate taken along line A-A′ in FIG. 25, illustrating optical paths of light entering the second member through a transmission region of the second member.

FIG. 32 is a cross-sectional view of the light guide plate taken along line A-A′ in FIG. 25, illustrating the size and shape of the light guide plate.

FIG. 33 is a graph representing, using an X coordinate, positions on the bottom surface of the first member which are reached by first light, second light, and third light from LEDs.

FIG. 34 is a perspective view of a light guide plate in accordance with another embodiment.

FIG. 35 is an enlarged view of a major part of a light guide plate constructed including a reflection plate.

FIG. 36 is an enlarged view of a major part of the light guide plate together with the light guide section contained in it when the light guide section is changed in shape.

FIG. 37 is a perspective view of a light guide plate in accordance with another embodiment.

FIG. 38 is a cross-sectional view of the light guide plate taken along line B-B′ in FIG. 37, illustrating optical paths in the light guide plate.

FIG. 39 is a cross-sectional view of a light guide plate for comparison with the light guide plate in FIG. 37.

FIG. 40 is a cross-sectional view of the light guide plate taken along line B-B′ in FIG. 37, illustrating the size and shape of the light guide plate.

FIG. 41 is a graph representing a relationship between the exit angle of light from an LED and the distance, Lx, from a reached position to a fourth virtual plane.

FIG. 42 is a perspective view of a light guide plate in accordance with another embodiment.

FIG. 43a is a top view of a light guide plate in accordance with another embodiment.

FIG. 43b is a cross-sectional view of the light guide plate taken along line C-C′ in FIG. 43a.

FIG. 44 is an illustration of optical paths in the light guide plates in FIGS. 43a and 43b.

FIG. 45a is a cross-sectional view of a light guide plate for comparison with the light guide plate in FIG. 42.

FIG. 45b is a cross-sectional view of a light guide plate for comparison with the light guide plate in FIG. 42.

FIG. 46a is an enlarged view of a major part of the light guide plates in FIG. 43a FIG. 43b.

FIG. 46b is a cross-sectional view of the light guide plate taken along line E-E′ in FIG. 46a.

FIG. 47a is an enlarged view of a major part of the light guide plates in FIG. 45a FIG. 45b.

FIG. 47b is a cross-sectional view of the light guide plate taken along line F-F′ in FIG. 47a.

FIG. 48 is a graph representing, using angles, a relationship between the direction of light emitted by an LED and the direction of that light as it is incident to the light guide plate for the light guide plate in FIG. 42 and for the light guide plate in FIG. 45a and FIG. 45b.

FIG. 49 is a top view of a light guide plate in accordance with another embodiment.

FIG. 50 is a top view of a light guide plate in accordance with another embodiment.

FIG. 51a is a top view of a light guide plate in accordance with another embodiment.

FIG. 51b is a cross-sectional view of the light guide plate taken along line G-G′ in FIG. 51a.

FIG. 52 is a perspective view of a light guide plate in accordance with the present embodiment.

FIG. 53 is a top view of the light guide plate in FIG. 52.

FIG. 54 is a bottom view of the light guide plate in FIG. 52.

FIG. 55 is an enlarged view of a major part of a bend section of the light guide plate.

FIG. 56 is a cross-sectional view of the light guide plate taken along line A-A′ in FIG. 53.

FIG. 57 is an enlarged view of a major part of one of light guide sections in the light guide plate.

FIG. 58 is a cross-sectional view of the light guide plate taken along line B-B′ in FIG. 53.

FIG. 59 is an illustration of a layout of LEDs.

FIG. 60 is a cross-sectional view taken along line A-A′ in FIG. 53, illustrating an optical path.

FIG. 61 is a graph representing a relationship between the angle of radiation, φ, of light from an LED and the angle α between an optical path of light immediately after entering a light guide section and the surface of the light guide section facing liquid crystal.

FIG. 62a is a top view of a part of the light guide section in FIG. 57, illustrating an exemplary optical path.

FIG. 62b is a cross-sectional view of the light guide plate taken along line D-D′ in FIG. 62a.

FIG. 63a is a top view of a part of the light guide section in FIG. 57, illustrating another exemplary optical path.

FIG. 63b is a cross-sectional view of the light guide plate taken along line E-E′ in FIG. 63a.

FIG. 64a is a top view of a part of the light guide section in FIG. 57, illustrating another exemplary optical path.

FIG. 64b is a cross-sectional view of the light guide plate taken along line F-F′ in FIG. 64a.

FIG. 65 is a cross-section taken along line C-C′ in FIG. 53, illustrating an optical path.

FIG. 66 is a cross-sectional view of a light guide plate in accordance with another embodiment corresponding to the cross-sectional view taken along line A-A′ in FIG. 53.

FIG. 67 is a graph representing relationships between the angles φ and α for various tilt angles of the surface of the light guide section.

FIG. 68 is a perspective view of a light guide plate in accordance with another embodiment.

FIG. 69 is an illustration of an illumination surface of a light guide system including a matrix of light guide plates.

FIG. 70 is an illustration of a drive circuit for the light guide system.

FIG. 71 is an illustration of an exemplary layout of photodiodes.

FIG. 72 is an illustration of another exemplary layout of photodiodes.

FIG. 73 is a perspective view of a light guide plate in accordance with another embodiment.

FIG. 74 is an illustration of a layout of two red LEDs, two green LEDs, and two blue LEDs.

FIG. 75 is an illustration of a layout of one red LED, two green LEDs, and two blue LEDs.

FIG. 76 is a cross-sectional view of a conventional liquid crystal display.

FIG. 77 is an enlarged view of part of a pattern of a diffusing section on a light guide plate in the liquid crystal display.

FIG. 78 is a cross-sectional view of another conventional backlight.

FIG. 79 is a cross-sectional view of conventional edge-lit type backlights being disposed end to end.

### DESCRIPTION OF THE EMBODIMENTS

### Embodiment 1

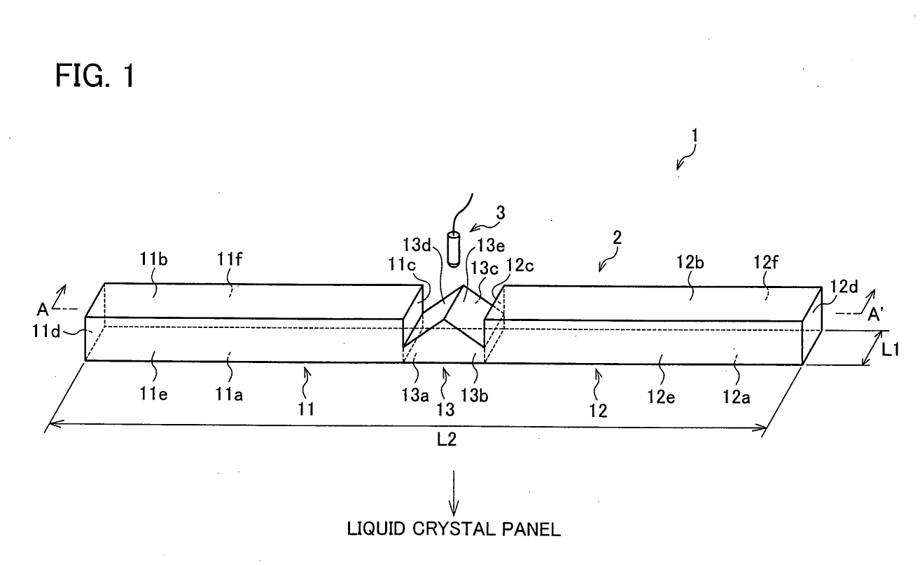

The following will describe an embodiment of the present invention in reference to FIGS. 1 to 13.

FIG. 1 is a schematic perspective view showing the structure of a backlight in accordance with the present invention. As shown in the figure, a backlight (lighting device) 1 includes a light guide plate 2 and an LED section 3. Still referring to the figure, the light guide plate 2 includes a light guide section (first light guide section) 11, another light guide section (second light guide section) 12, and a bend section 13. The bend section 13 is flanked by the light guide section 11 and the light guide section 12. Throughout the following, it is assumed for ease of description that the light guide sections 11 and 12 are symmetric with respect to the bend section 13.

The light guide section 11 is substantially of the shape of a rectangular parallelepiped. The light guide section 11 has surfaces 11a to 1 if. The surface (predetermined surface) 11a faces a liquid crystal panel. The surface 11b faces the LED section 3. The surface (first surface) 11c is adjacent to the bend section 13 and faces the outside. The surface 11d is opposite the surface 11c. The remaining surfaces 11e and 11f are in front and in back of the figure respectively.

The light guide section 12 has surfaces 12a to 12f which are located analogous to the surfaces 11a to 11f on the light guide section 11. The surface 12a is one of the predetermined surfaces recited in claims. So is the surface 11a. The surface 12c is one of the first surfaces recited in claims. So is the surface 11c.

The bend section 13 has surfaces 13a to 13e. The surface 13a faces the liquid crystal panel. The surface 13b is adjacent to the surface 11e of the light guide section 11 and the surface 12e of the light guide section 12. The surface 13c is adjacent to the surface 11f of the light guide section 11 and the surface 12f of the light guide section 12. The surface (first reflection surface) 13d faces the LED section 3 and is adjacent to the surface 11c of the light guide section 11. The surface (second reflection surface) 13e faces the LED section 3 and is adjacent to the surface 12c of the light guide section 12.

The surfaces 13d and 13e are adjacent to each other and have an intersecting line parallel to the surface 11c of the light guide section 11 and the surface 12c of the light guide section 12. The surface 13d has the same shape as the surface 13e. Assuming a first virtual plane which includes the intersecting line and is perpendicular to the surface 13a, the surfaces 13d and 13e are tilted a predetermined angle θ with respect to the first virtual plane in mutually opposite directions.

The light guide sections 11 and 12 are composed at least internally of a material capable of guiding light: for example, a transparent acrylic material or a glass material. The surfaces 13d and 13e of the bend section 13 are composed of a material which reflects light: for example, aluminum. To prevent the bend section 13 from projecting a shadow, the surfaces 13d and 13e are composed of a material which transmits a small amount of light: for example, a white paint. If the surfaces 13d and 13e are composed of a reflective material which completely blocks light (for example, aluminum), the bend section 13 preferably has a structure allowing light to leak out from some parts of the bend section 13.

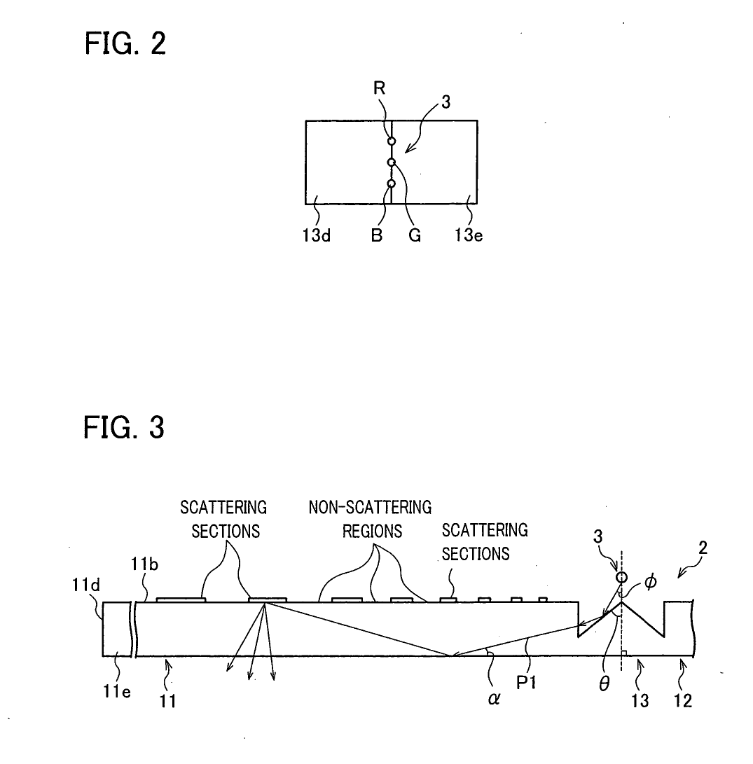

The LED section 3 includes three light emitting diodes (“LEDs”): a red (R) light emitting diode (“red LED”), a green (G) light emitting diode (“green LED”), and a blue (B) light emitting diode (“blue LED”). The structure enables generation of white light (external light). As shown in FIG. 2, each LED has a light emitting surface in the first virtual plane with that plane equally dividing the light emitting surface. The LEDs are the light emitting elements recited in claims.

The surface 11a of the light guide section 11, the surface 13a of the bend section 13, and the surface 12a of the light guide section 12 form a single plane (“LC-facing plane”). The LC-facing plane is rectangular. In the LC-facing plane, the length of a side parallel to the intersecting line is labeled L1, and the length of a side perpendicular to the intersecting line is labeled L2.

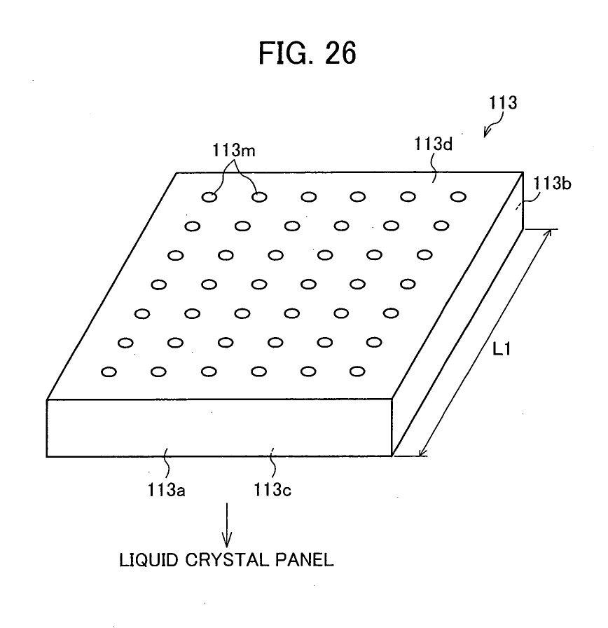

The surface 11b of the light guide section 11 and the surface 12b of the light guide section 12 have a predetermined light scattering pattern. An example of the pattern is shown in FIG. 26. The pattern is by no means limited to this example; any of the various, publicly known patterns may be used. The pattern only needs to have geometry which grows in size with the distance from the surfaces 11c and 12c. In the following, the geometry will be referred to as the light scattering sections. The rest of the surface 11b (i.e., excluding the light scattering sections) will be referred to as the non-scattering region.

Next, optical paths when the LED section 3 is lit will be described in reference to FIG. 3. Since the light guide plate 2 is symmetrical with respect to the first virtual plane, the following description will focus on optical paths in the light guide section 11. FIG. 3 is a cross-sectional view of the light guide plate taken along line A-A′ in FIG. 1.

As shown in the figure, light leaves the LED section 3 at a predetermined angle φ with respect to the first virtual plane and reflects from the surface 13d of the bend section 13. The reflection (predetermined light) passes through the surface 11c and enters the light guide section 11. Upon entering the section 11, the light is refracted by the surface 11c. The light, after entering the light guide section 11, experiences total reflections from the non-scattering regions (i.e. interface) of the surfaces 11a and 11b as it propagates in the light guide section 11. Of the incident light, the part hitting a scattering section of the surface 11b is scattered by that scattering section. Of that scattered light, the part subjected to no total reflections from the surface 11a, etc. exit through the surface 11a. Thus, the liquid crystal panel is illuminated.

Some of the light emitted by the LED section 3 is directly incident to the surface 11a, entering the light guide section 11, without being reflected from the surface 13d.

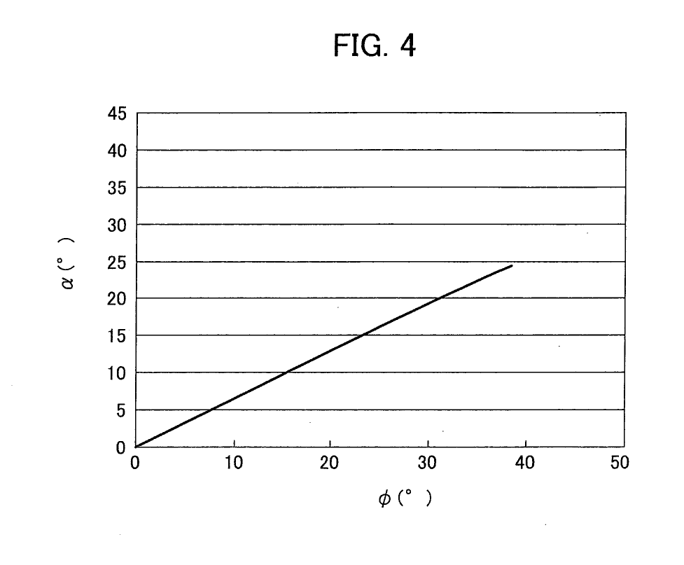

FIG. 4 is a representation of a relationship between the angle φ and an angle α (“first angle”). α is the angle of the optical path (P1 in FIG. 3) of light immediately after incident to the surface 11c (that is, after being refracted by the surface 11c) with respect to the LC-facing plane. The figure assumes that θ is 45°. When the light guide section 11 is composed internally of an acrylic material of a refractive index of 1.5, light does not undergo total reflection from the surfaces (interface) 11a and 11b of the light guide section 11 if the first angle is in excess of about 48°. However, with this composition and structure, total reflection takes place on the surfaces 11a and 11b of the light guide section 11 even when φ takes a maximum value (here, about 38°) as indicated in FIG. 4.

As mentioned above, the value of α changes with that of φ. Therefore, the light emitted by the LED section 3 is scattered by the scattering sections disposed at different locations. Moreover, the scattering sections occupy a progressively increasing proportion of the surface 11b as they are farther away from the surfaces 11c and 12c. This renders the light leaving through the surface 11a substantially uniform. The uniformity of the outgoing light will be increased by advance calculational simulation of an optimal pattern for the scattering sections.

The light leaving the light guide section 12 through the surface 12a is also uniform for the same reasons.

If the interior of the bend section 13 and the surface 13a are constructed from a light-transmitting member like the interior of the light guide section 11, the light scattered or otherwise manipulated inside the light guide section 11 can be output from the surface 13a. When this is the case, the light guide plate 2 projects light of increased uniformity toward the liquid crystal panel.

In the foregoing, the surfaces 13d and 13e of the bend section 13 were composed of a reflective material. If some parts of the surfaces 13d and 13e are composed of a light-transmitting material, and the bend section 13 is constructed internally of a light-transmitting member like, for example, the light guide section 11, it is possible to output the light emitted by the LED section 3 directly from the surface 13a of the bend section 13. When this is the case, the light guide plate 2 projects light of further increased uniformity toward the liquid crystal panel.

In the foregoing, the light source consisted of LEDs, or point sources. If the value of L1 is increased in excess, it becomes difficult to output uniform light through the surfaces 11a and 12a. In contrast, the value of L2 can be increased to a certain level because of the internal light-guiding capability of the light guide sections 11 and 12 and the patterns formed on the surfaces 11b and 13b. These facts indicate that because of the use of the LED section 3, the LC-facing plane of the light guide plate 2 is preferably elongated relative to its width so as to output uniform light through the surfaces 11a and 12a. In such a case, the light guide plate 2 acts as a surface light source which resembles in function a line light source like a fluorescence lamp with a circular column shape.

As described in the foregoing, the light guide plate 2 is a structure which includes the light guide section 11 and the bend section 13. The section 11 guides the predetermined light incident from a pre-set direction (from the surface 13d toward the surface 11c) so that the light exits through the surface (predetermined surface) 11a as it travels down along the surface 11a. The bend section 13 turns the external light incident to the surface opposite the surface 11a by one reflection into the pre-set direction so that the light enters the light guide section 11.

In the structure, the bend section 13 turns the external light incident to the surface opposite the surface 11a by one reflection into the pre-set direction so that the light enters the light guide section 11. Also, the light having turned into the pre-set direction and entered the light guide section 11 is guided by the light guide section 11 so as to exit through the surface 11a.

Since a single reflection brings the light into the light guide section 11, the light guide plate 2 itself can be made relatively thin when compared to structures where multiple reflections are involved.

In addition, the light guide section 11 guides the predetermined light along the surface 11a; the LED (light source) 3, emitting external light, can therefore be disposed in relatively close proximity to the surface opposite the light guide plate 2 when compared to the structure of conventional direct backlights. Further, since the LED section 3 does not need to be disposed on an edge of the light guide plate 2, the plane consisting of the surface 11a (that is, the LC-facing plane) can be readily combined with other such planes in a matrix when compared to the structure of conventional edge-lit type backlights. These individual factors all facilitate the realization of a large illumination surface.

Therefore, the light guide plate 2 is suited for reducing the thickness of the backlight device and increasing the illumination surface of the backlight device in area.

The light guide plate 2 is a structure which includes the light guide section 12 and the bend section 13. The section 12 guides predetermined light incident from a pre-set direction (from the reflection surface 13e toward the surface 12c) so that the light exits through the surface (predetermined surface) 12a as it travels down along the surface 12a. The bend section 13 turns the external light incident to the surface opposite the surface 12a by one reflection into the pre-set direction, that is, toward the light guide section 12. The structure achieves the same effects as those detailed above.

The light guide plate 2 is also a structure which includes the light guide section (first light guide section) 11 and the light guide section (second light guide section) 12. The light guide sections 11 and 12 are disposed flanking the bend section 13. The bend section 13 turns the external light into a first direction (pre-set direction), that is, toward the light guide section 11, and into a second direction (pre-set direction), that is, toward the light guide section 12.

In the structure, the bend section 13 turns the external light incident to the surfaces opposite the surfaces 11a and 12a into the first direction and the second direction by only one reflection.

Thus, the light exits the light guide sections 11 and 12 flanking the bend section 13.

The light guide plate 2 is also a structure in which: the bend section 13 has the surface (first reflection surface) 13d and the surface 13e (second reflection surface) which reflects the external light; and the surface 13d turns the external light into the first direction, and the surface 13e turns the external light into the second direction.

In the structure, the surface 13d turns the external light into the first direction. In addition, the surface 13e turns the external light into the second direction. Therefore, the bend section 13 has a simple structure.

The light guide plate 2 is also a structure in which the surfaces 13d and 13e are: identical in shape and disposed adjacent to each other to provide two side faces of a triangular column; and tilted an angle, θ, with respect to the first virtual plane in opposite directions, where the first virtual plane (specified plane) includes the intersecting line of the surfaces 13d and 13e and is perpendicular to the surfaces 11a and 12a (LC-facing plane).

In the structure, the amounts of light reflecting from the surfaces 13d and 13e are made equal to each other by projecting external light from a position on the first virtual plane toward the LC-facing plane. Therefore, the same amounts of light (predetermined light) enter the light guide sections 11 and 12.

The light guide plate 2 is a structure in which: the light guide sections 11 and 12 are symmetric.

In the structure, the light guide sections 11 and 12 are symmetric. Therefore, the structure of the light guide plate 2 is relatively simple when compared to cases where the light guide sections 11 and 12 are non-symmetric.

To increase the amount of light exiting through the surfaces 11a and 12a, the surfaces 11d, 11e, 11f, 12d, 12e, and 12f are preferably adapted to scatter or reflect light. For example, the surfaces may be composed of a white paint (thin film).

If there is provided a reflection sheet facing the surfaces 11b and 12b, the amounts of light exiting through the surfaces 11a and 12a are further increased.

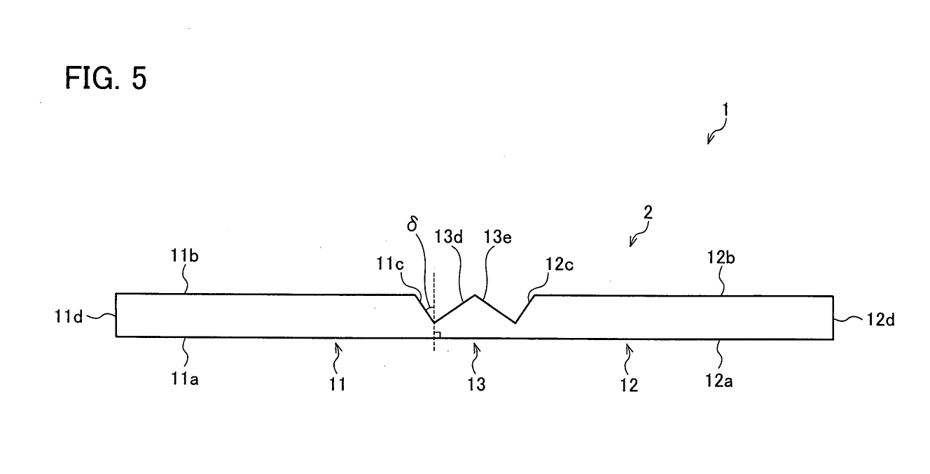

In the light guide plate 2, the surface 11c of the light guide section 11 and the surface 12c of the light guide section 12 are adapted to be perpendicular to the LC-facing plane. However, this is by no means intended to be limiting the invention. For example, as shown in FIG. 5, the surface 11c may be tilted with respect to the first virtual plane in such an orientation that the surface 11c refracts the light turned (reflected) by the surface 13d toward the LC-facing plane, and the surface 12c may be tilted with respect to the first virtual plane in such an orientation that the surface 12c refracts the light turned (reflected) by the surface 13e toward the LC-facing plane. Specifically, the angles between the surfaces 11c and 13d and between the surfaces 12c and 13e may be set to a value greater than θ. In the following, the tilt angle with respect to the first virtual plane will be labeled δ.

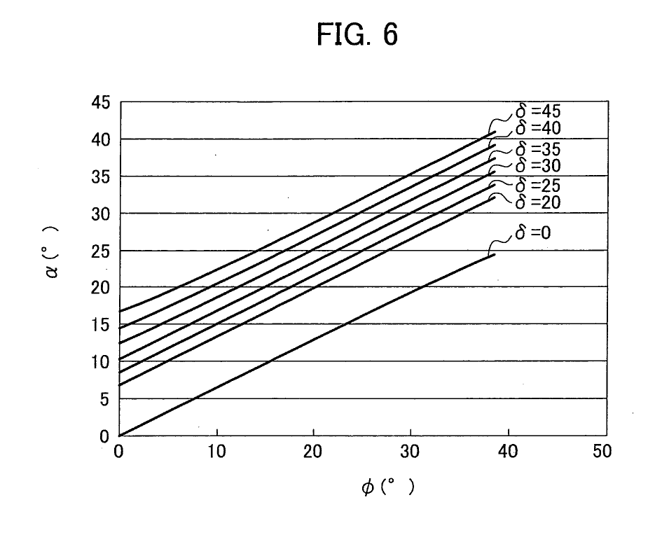

FIG. 6 is a representation of a relationship between the angles φ and α for various δ values with θ=45°.

As shown in the figure, when δ is increased, α is also increased. To put it differently, when δ is increased, the incident angle to the surfaces 11a and 12a is decreased. The figure also indicates that α is no greater than 48° for the maximum φ value when δ=45°, which means that light undergoes total reflection from the surfaces of the light guide sections 11 and 12.

Hence, the greater the δ value, the smaller the incident angle to the surfaces 11a and 12a. Therefore, the guided light is scattered by scattering sections, on the surfaces 11b and 12b, which are closer to the bend section 13. Therefore, the light exiting through the surfaces 11a and 12a have increased uniformity.

Further, the greater the δ value, the more total reflections occur in the light guide sections 11 and 12. Therefore, more light is incident to and scattered by the scattering sections. Thus, light exits through the surfaces 11a and 12a more efficiently.

As described immediately above, the light guide plate 2 may be said to be a structure in which: the predetermined light is incident to the surface (first surface) 11c of the light guide section 11; and the surface 11c is tilted with respect to the surface perpendicular to the surface 11a in such an orientation that the surface 11c refracts the external light, after the bending, toward the surface 11a. The light guide plate 2 is also a structure in which: the predetermined light is incident to the surface (first surface) 12c of the light guide section 12; and the surface 12c is tilted with respect to the surface perpendicular to the surface 12a in such an orientation that the surface 12c refracts the external light, after the bending, toward the surface 12a.

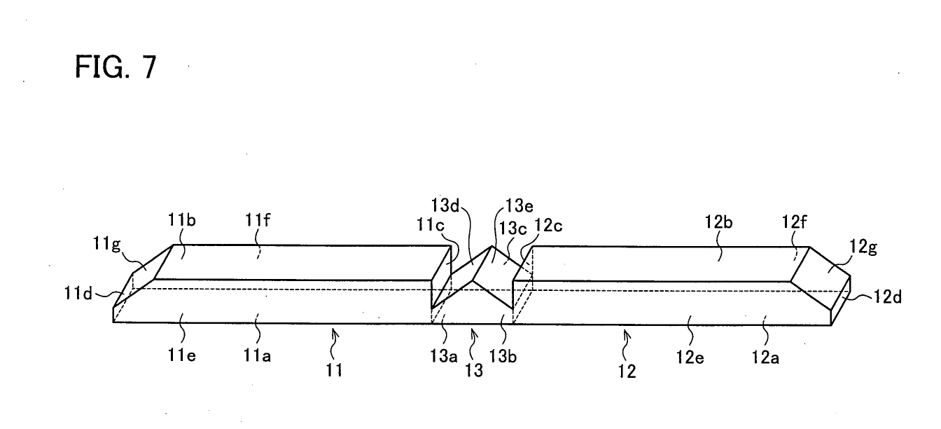

In the light guide plate 2, the light guide sections 11 and 12 are of the shape of a rectangular parallelepiped. This is by no means intended to be limiting the invention. For example, as shown in FIG. 7, the light guide sections 11 and 12 may have a tilt surface 11g and a tilt surface 12g respectively. The surface 11g is adjacent to the surfaces 11b and 11d. The surface 11g is composed of a light-reflecting material or a light-scattering material. The surface 11g is tilted with respect to the LC-facing plane toward the surface 11c. The surface 12g is adjacent to the surfaces 12b and 12d. The surface 12g is composed of a light-reflecting material or a light-scattering material. The surface 12g is tilted with respect to the LC-facing plane toward the surface 12c.

When this is the case, in the light guide section 11, the light guide plate 2 may be said to be a structure in which: the predetermined light is incident to the surface (first surface) 11c of the light guide section 11; the light guide section 11 has an end surface, opposite the surface 11c, to which is applied a light-reflecting material or a light-scattering material; and the end surface has the tilt surface 11g tilted with respect to the surface 11a toward the surface 11c.

In the structure, the tilt surface 11g at least reflects or scatters the light guided to the end surface back to the light guide section 11 without letting the light exits through the end surface. Therefore, the external light is efficiently utilized. An increased amount of light exits through the surface 11a when compared to cases where no tilt surface 11g is provided. This description about the light guide section 11 applies also to the light guide section 12.

Alternatively, the tilt surfaces 11g and 12g may be provided with the surfaces 11c and 12c being tilted with respect to the first virtual plane as mentioned earlier.

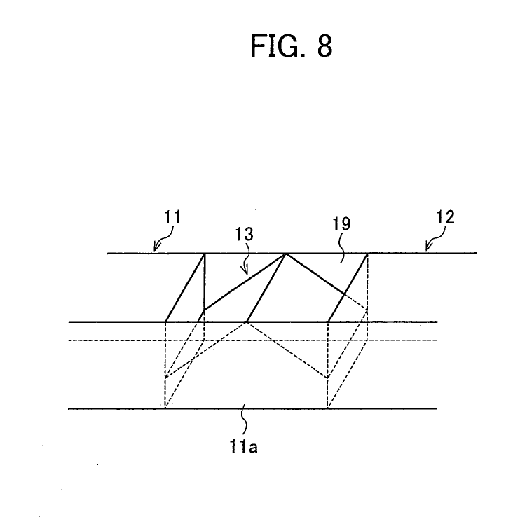

Further, as shown in FIG. 8, the light guide plate 2 preferably has reflection plates 19 on the surfaces 13b and 13c of the bend section 13 toward the LED section 3. When this is the case, for example, the part of the reflection from the surfaces 13b and 13c of the bend section 13, which would not be incident to the surface 11c of the light guide section 11 and the surface 12c of the light guide section 12 without the presence of the reflection plates 19, is fed to the light guide sections 11 and 12.

Therefore, a greater part of the light emitted by the LED section 3 is fed to the light guide sections 11 and 12. The liquid crystal panel projects an increased amount of light.

When the surfaces 11c and 12c are tilted with respect to the first virtual plane as mentioned earlier, the reflection plates 19 may be expanded covering the surfaces 11e and 12e (or surfaces 11f and 12f) so that, for example, the reflection from the surface 13d does not exit without passing through the light guide section 11. When this is the case, similarly to the preceding case, the liquid crystal panel projects an increased amount of light.

In the light guide plate 2, the light guide section 11 has the same shape as light guide section 12. This is by no means intended to be limiting the invention. The surface 11a of the light guide section 11 may differ in area from the surface 12a of the light guide section 12; still, the surfaces 11a and 12a can be adapted to allow the same amount of light per unit area to exit therethrough by changing the patterns of the surfaces 11b and 12b. Therefore, when this is the case, the light guide plate 2 again projects uniform light toward the liquid crystal panel.

If there are restrictions on the position of the LED section 3, the surfaces 11a and 12a can project light by changing the size ratio of the light guide sections 11 and 12.

In the above embodiment, the value of L1 needed to be small because of the use of a point source. To replace the LED section 3 with a line light source or an elongated surface light source, the value of L1 may be large. Therefore, in such a structure, the light guide plate may have illumination surfaces (surfaces 11a and 12a) occupying a large area. In the following, for ease of description, the light guide plate that has a greater L1 value than that of the light guide plate 2 will be referred to as light guide plate 2′.

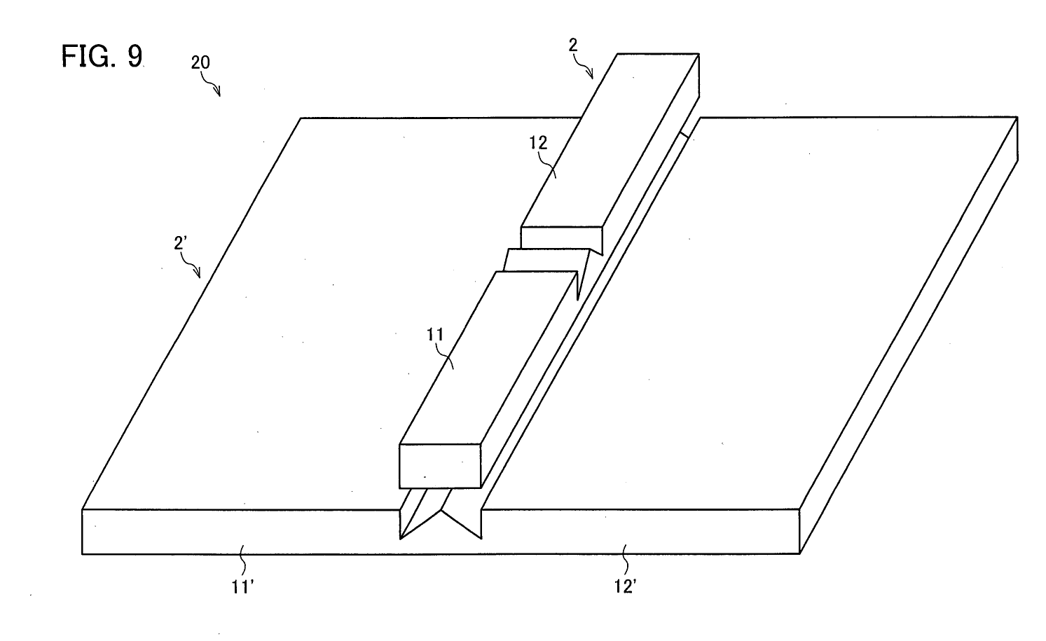

When this is the case, as shown in FIG. 9, the light guide plate 2 can be used as the elongated surface light source. In this structure, the light emitted by the LED section 3 is first tweaked in the light guide plate 2 to obtain planar light of which the amount of light per unit area is uniform. The planar light is further tweaked in the light guide plate 2′ to obtain wider planar light. Accordingly, the liquid crystal display panel can be illuminated by light in various quadrilateral shapes (for example, a square) using the point source.

In the following, for ease of description, the above combination of the light guide plate (first light guide plate) 2 and the light guide plate (second light guide plate) 2′ will be referred to as the light guide plate (light guide device) 20. In addition, those sections in the light guide plate 2′ which are equivalents to the light guide sections 11 and 12 in the light guide plate 2 will be referred to as the light guide section 11′ and the light guide section 12′.

The light guide plates 2 and 2′ may be manufactured as a single unit from one plate (e.g. acrylic plate) by, for example, processing (cutting) and surface-treating it.

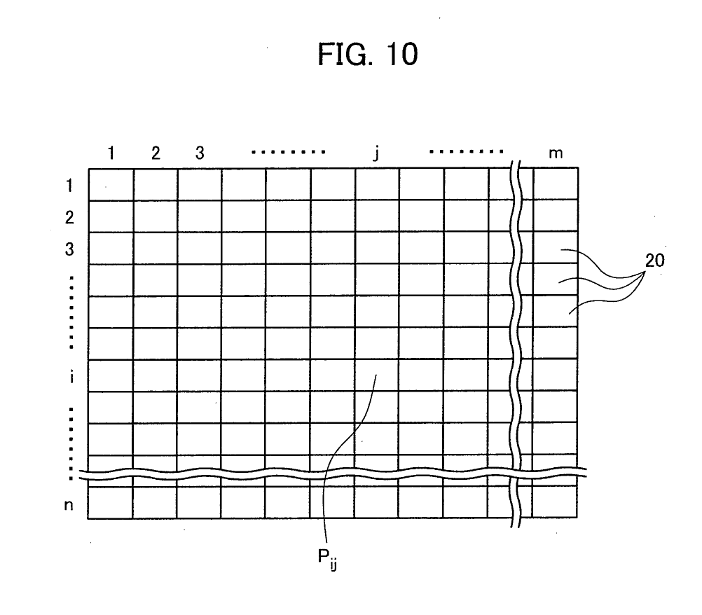

Next, a drive circuit and method for LEDs for an n×m matrix of light guide plates 20 (see FIG. 10) will be described. In the following, each individual light guide plate 20 in the matrix will be denoted by Pij (1≦i≦n, 1≦j≦m).

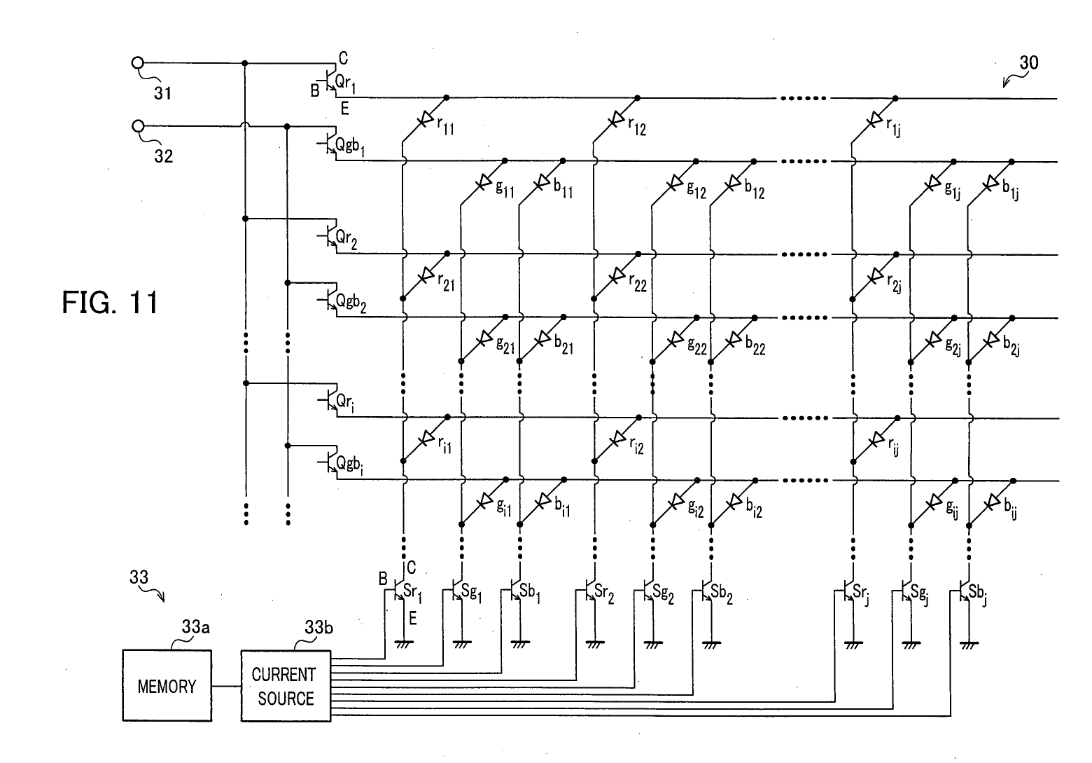

As shown in FIG. 11, a drive circuit 30 includes an LED section 3 for each light guide plate Pij. That is, each light guide plate Pij has its own red LED, green LED, and blue LED. The LEDs are arranged at the positions shown in FIG. 2. In the following, the red, green, and blue LEDs for the plate Pij will be denoted by rij, gij, and bij respectively.

The drive circuit 30 includes a constant voltage source 31, another constant voltage source 32, switching elements Qri and Qgbi, a first controller 33, and a second controller (not shown). The first controller 33 includes switching elements Srj, Sgj, and Sbj, a memory 33a, and a current source 33b. The following description will assume that the switching elements Qri and Qgbi and the switching elements Srj, Sgj, and Sbj are all transistors.

The combined structure of the matrix of light guide plates, the LED sections, one for each light guide plate, and the drive circuit is the light guide system recited in claims. The first controller is the controller recited in claims.

The constant voltage source 31 applies a constant voltage to the inputs of the red LEDs ri1, ri2, ri3, . . . , and rim via the switching elements Qri. The constant voltage source 32 applies a constant voltage to the inputs of the switching elements gi1, gi2, gi3, . . . , and gim and to the inputs of the switching elements bi1, bi2, bi3, . . . , and bim via the switching elements Qgbi.

The switching elements Qri and Qgbi conduct the current supplied by the constant voltage sources 31 and 32 from the collector (C) to the emitter (E) by means of, for example, the second controller supplying current to the base (B). In addition, the second controller supplies current to the bases of the switching elements Qri and Qgbi (i-th element of each group) at the same time so that the elements start conducting simultaneously. After switching the switching elements Qri and Qgbi from conduction to non-conduction, the second controller simultaneously switches the adjacent switching elements Qri+1 and Qgbi+1 to conduction.

The first controller 33 will be next described.

The memory 33a stores information indicating current to be supplied to the bases of all the switching elements Srj, Sgj, and Sbj (3m elements).

The current source 33b simultaneously supplies current to the bases of all the switching elements Srj, Sgj, and Sbj (i.e. 3 m elements) to simultaneously switch the switching elements Srj, Sgj, and Sbj to conduction. The control section (not shown) for the current source 33b determines the current to be supplied to each switching element from the information stored in the memory 33a. Based on the determinations, the current source 33b supplies current to the switch elements.

With this current supply at the base, each switching element Srj, Sgj, and Sbj conducts current from the collector (C) to the emitter (E) in accordance with the base current.

LEDs, even if they generate light of the same color, will still differ in the nature of the light they produce (e.g. luminance and hue). Therefore, the current at which the individual LEDs produce light in the amount predetermined for each color is determined for each LED on the basis of the characteristics of that LED. The memory 33a stores the information on the determined currents. Thus, all the LEDs for each specific color (for example, ri1, ri2, ri3, . . . , and rim for red) produce light in the same amount predetermined for that particular color.

Therefore, the LED sections 3, one for each light guide plate Pij, produce the same amount of white light per unit time. Thus, the light guide plates Pij project uniform, white light.

LEDs degrade with time, producing light in progressively decreasing amount. Accordingly, the first controller 33 is first adapted to operate in a mode where the LEDs (rij, gij, bij) for the light guide plates Pij are lit at different timings from one light guide plate to the next, and the three individual LEDs for each plate are lit again at different timings. Further, the drive circuit 30 includes a photodiode (converter) for each LED section 3 at a predetermined position relative to the LED section 3. The photodiode converts to an electric signal an optical signal generated when an LED lights.

The first controller 33 is further adapted to receive the electric signal from each LED, so that the control section of the current source 33b changes the information stored in the memory 33a in accordance with the received signal intensity. Specifically, while the first controller 33 is operating in the above mode, the control section changes the information so that the current supplies to the bases of the switching elements Srj, Sgj, and Sbj increase with a decrease in the received signal intensity.

When the LEDs degrade, this structure is capable of increasing the amount of LED light to a certain extent.

When this is the case, the control section preferably changes the information so that at least the LEDs of the same color emit the same amount of light. This makes it possible to always project uniform light onto the liquid crystal display panel.

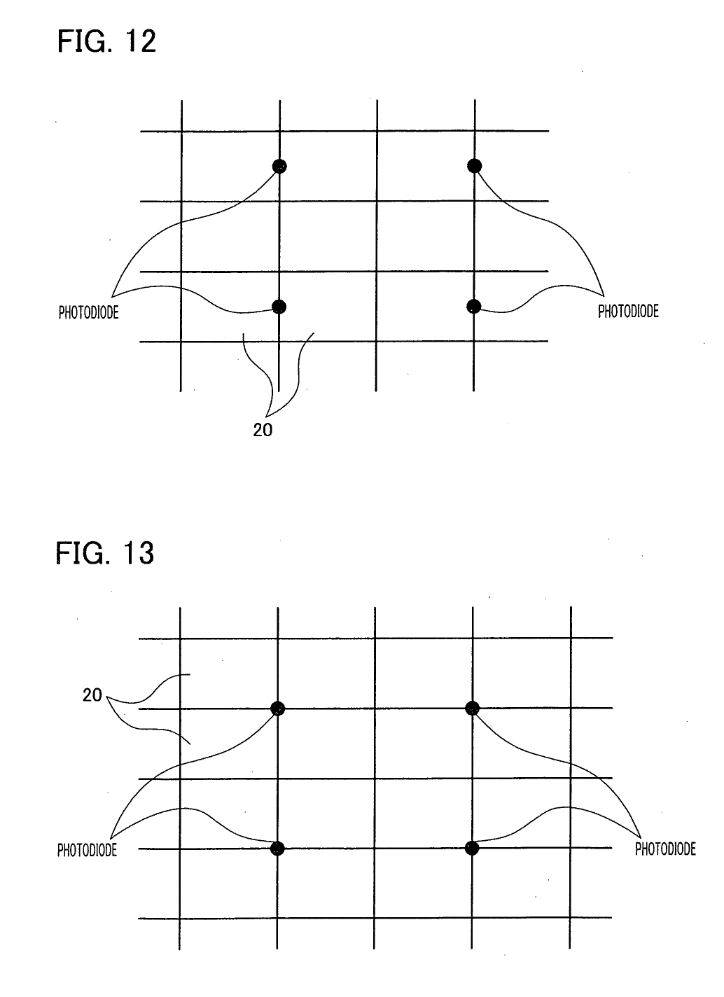

Further, in the foregoing, a photodiode was disposed for each LED section 3. This is by no means intended to be limiting the invention. For example, a photodiode may be disposed on the boarder of every two adjacent light guide plates that are paired up as shown in FIG. 12. When this is the case, the total photodiode count is decreased, allowing for lowering of the manufacturing cost of the drive circuit 30.

Another example is sets of four (2×2) light guide plates shown in FIG. 13 where one photodiode is disposed at the center of those light guide plate. When this is the case, the total photodiode count is decreased further, allowing for further lowering of the manufacturing cost of the drive circuit 30.

FIG. 11 shows an example where a green LED and a blue LED are driven by the same line. This is by no means intended to be limiting the invention. For example, the switching elements Qgbi may be replaced with color-specific switching elements Qgi and switching elements Qbi to drive the green LEDs and the blue LEDs separately.

### Embodiment 2

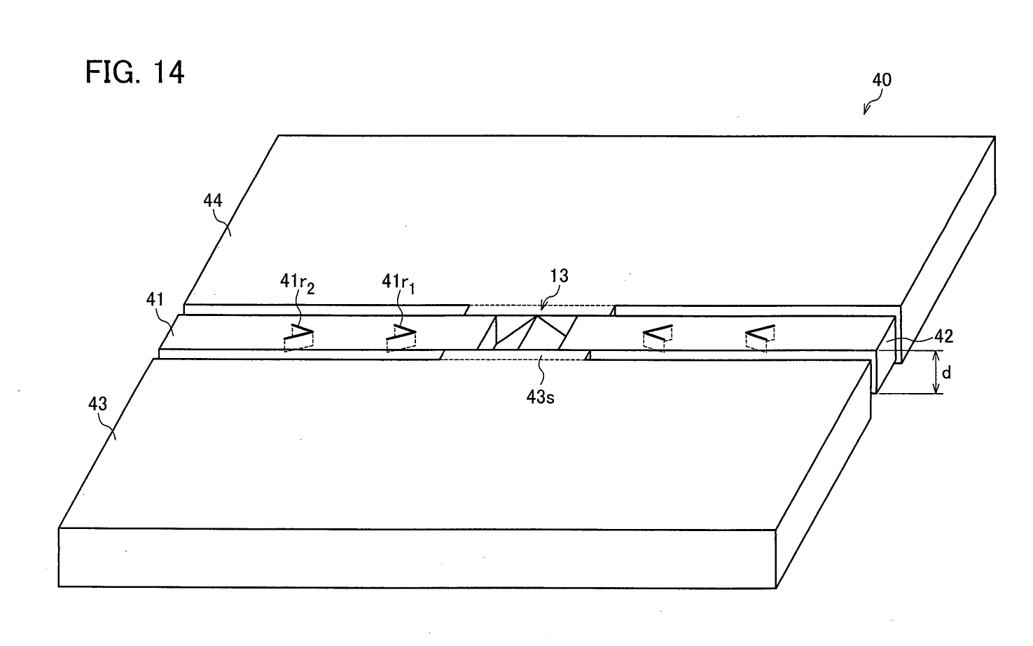

The following will describe another embodiment of the present invention in reference to FIGS. 14 to 22. Here, for ease of description, members of the present embodiment that have the same arrangement and function as members of embodiment 1, and that are mentioned in that embodiment are indicated by the same reference numerals and description thereof is omitted.

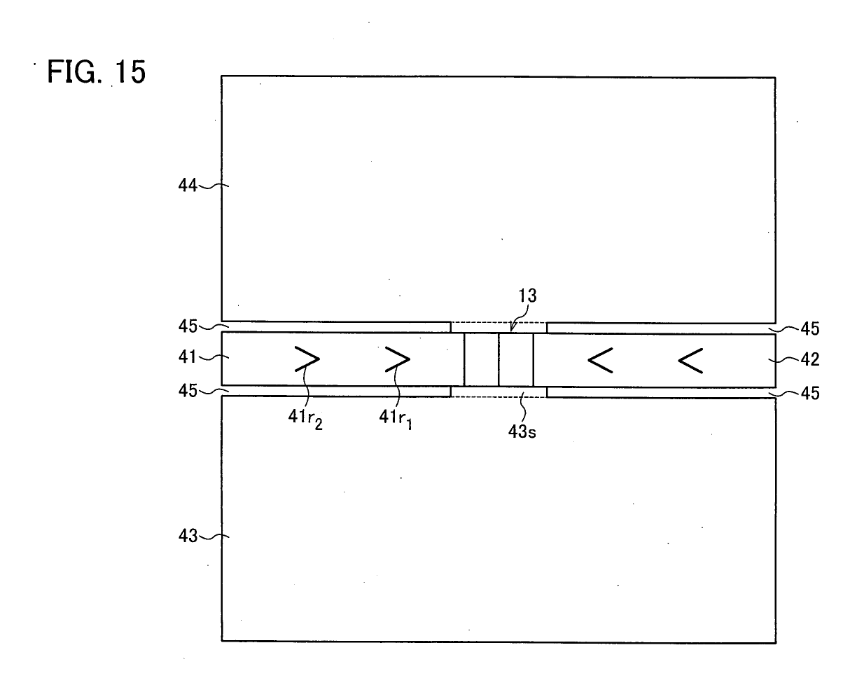

Referring to FIGS. 14 and 15, a light guide plate 40 in accordance with the present embodiment includes a bend section 13, a light guide section (other light guide section, first light guide section) 41, a light guide section (other light guide section, second light guide section) 42, a light guide section (third light guide section) 43, and a light guide section (fourth light guide section) 44. The light guide sections 41 and 42 are symmetric with respect to the bend section 13. Further, the light guide sections 43 and 44 are symmetric with respect to the bend section 13, the light guide section 41, and the light guide section 42. Therefore, in the following, description of the light guide sections 42 and 44 will be basically omitted.

The light guide section 41 has the same structure as the light guide section 11 of embodiment 1 except for the following points. The surface 11b of the light guide section 11 had a predetermined pattern, whereas the light guide section 41 has no such a pattern. Also, the light guide section 41 includes reflection plates 41r1 and 41r2 in it. The number of reflection plates is by no means limited to two.

The light guide section 43 has the same structure as the light guide section 11′ of the light guide plate 2′ of embodiment 1 except for the following points. The light guide section 43 is in contact with at least the bend section 13 and includes a convex section 43s which guides light from the bend section 13 into the light guide section 43. In the figure, the convex section 43s is shown to be in contact only not with the bend section 13, but also with the light guide sections 41 and 42. This structure provides improved mechanical strength to the light guide plate 40.

In the following, the surfaces of the light guide section 41 which correspond to the surfaces 11a to 11f of the light guide section 11 will be referred to as the surfaces 41a to 41f respectively. Also, the surfaces of the light guide section 42 which correspond to the surfaces 12a to 12f of the light guide section 12 will be referred to as the surfaces 42a to 42f respectively. See FIG. 16. The surfaces 41a and 42a are the predetermined surfaces recited in claims. Further, the surfaces of the light guide sections 43 and 44 which face a liquid crystal panel will be referred to as the surfaces 43a and 44a respectively. The surfaces 43a and 44a are the predetermined surfaces recited in claims.

The light guide plate 40 further has plate-shaped gaps 45 along a surface 41e, a surface 41f, a surface 42e, and a surface 42f. So, there is a gap of a predetermined width separating the light guide section 41 from the light guide sections 43 and 44. There is also a gap of a predetermined width separating the light guide section 42 from the light guide sections 43 and 44.

As shown in FIG. 14, the thickness of the light guide section 41 (measured perpendicular to the surface 41a) is labeled “d.” The figure shows a structure where the thickness of the light guide section 41 is less than that of the light guide section 43 (measured perpendicular to the surface 43a).

The reflection plates 41r1 and 41r2 are positioned perpendicular to the surface 41a as shown in FIGS. 14 and 15. Each reflection plate 41r is a rectangle measuring d on a side folded along a center line (line parallel to that side passing through the center of the rectangle). Further, the reflection plates 41r1 and 41r2 are symmetric with respect to a surface parallel to the surfaces 41e and 41f which equally divides the light guide section 41 (“second virtual plane”).

In the following, as shown in FIG. 16, the direction perpendicular to the surface 13a of the bend section 13 from the LED section 3 to the surface 13a will be termed the Z direction.

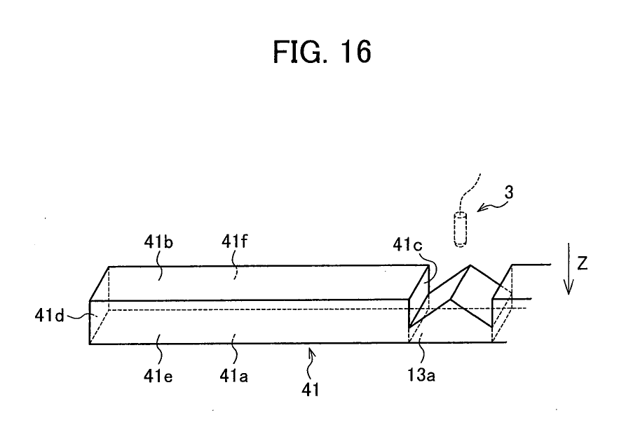

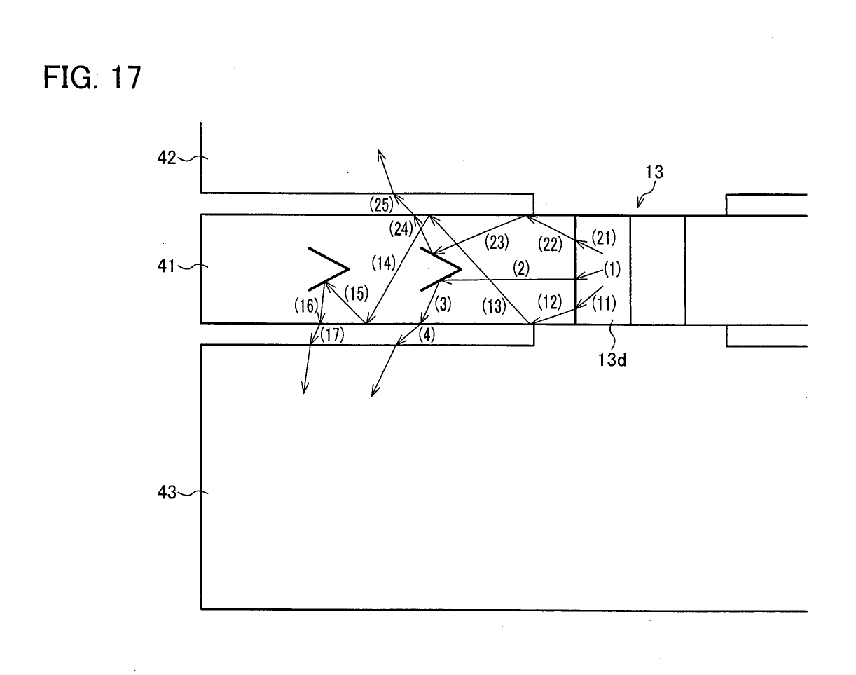

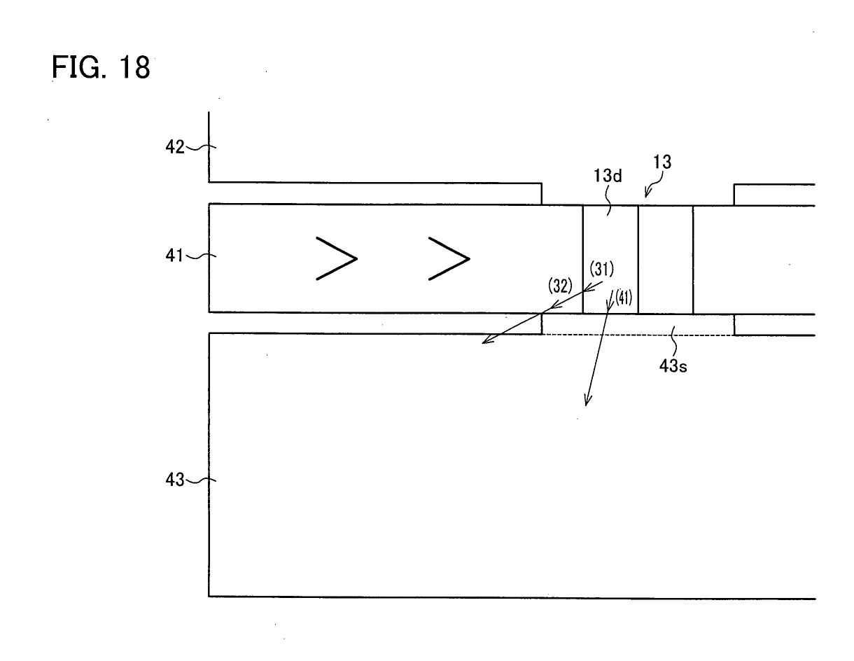

Now, optical paths in the light guide plate 40 will be described in reference to FIGS. 17 and 18. The positional relationship of the LED section 3 and the bend section 13 is the same as in embodiment 1. The optical paths described below provide a mere example for the purpose of illustration and are by no means intended to be limiting the invention.

Light emitted in a direction from the LED section 3 reflects from the surface 13d of the bend section 13 as shown in FIG. 17. The reflection, for example, takes optical path (1) in the figure and enters the light guide section 41 through the surface 41c of the light guide section 41. The light then travels along optical path (2) in the figure while undergoing total reflection from the surfaces 41a and 41b (interfaces). When this is the case, the light reflects from the reflection plate 41r1 and travels further along optical path (3) in the figure toward the surface 41e as shown in the figure. As the light reaches the surface 41e, it assumes optical path (4) in the figure (crossing the gap 45) before entering the light guide section 43.

Light emitted in another direction from the LED section 3 reflects from the surface 13d of the bend section 13 similarly to the foregoing as shown in the figure. The reflection, for example, assumes optical path (11) in the figure and enters the light guide section 41 through the surface 41c of the light guide section 41. The light takes optical path (12) in the figure without total reflection and travels toward the surface 41e. As the light reaches the surface 41e, it undergoes total reflection from the surface 41e and travels along optical path (13) in the figure toward the surface 41f. Along optical path (13), the light undergoes total reflection from the surfaces 41a and 41b.

Further, as the light reaches the surface 41f and undergoes total reflection from the surface 41f, assuming optical path (14) in the figure again toward the surface 41e. Along this optical path (14), the light also undergoes total reflection from the surfaces 41a and 41b.

As the light reaches the surface 41e, it assumes optical path (15) in the figure. When this is the case, the light reflects from the reflection plate 41r2 and travels along optical path (16) in the figure toward the surface 41e shown in the figure. As the light reaches the surface 41e, it assumes optical path (17) in the figure (crossing the gap 45) before entering the light guide section 43.

As described in the foregoing, the incident light to the light guide section 43 undergoes total reflection from a surface (interface) of the light guide section 43 and is scattered by the pattern provided on the LED section 3 as with the aforementioned light guide section 11′ of the light guide plate 2′. Thus, light is projected onto the liquid crystal panel opposite the LED section 3. The incident light to the light guide section 43 is the predetermined light recited in claims.

Light emitted in a further direction from the LED section 3 reflects from the surface 13d of the bend section 13 similarly to the forgoing as shown in the figure. The reflection, for example, assumes optical path (21) in the figure and enters the light guide section 41 through the surface 41c of the light guide section 41. The light takes optical path (22) in the figure without total reflection and travels toward the surface 41f. As the light reaches the surface 41f, it undergoes total reflection from the surface 41f and travels along optical path (23) in the figure toward the reflection plate 41r1. As the light reaches the reflection plate 41r1, it reflects from the reflection plate 41r1 and travels along optical path (24) in the figure toward the surface 41f. The light, reaching the surface 41f, assumes optical path (25) in the figure (crossing the gap 45) before entering the light guide section 44 opposite the light guide section 43. Description of the optical paths after the entering into the light guide section 44 is omitted. The incident light to the light guide section 44 is the predetermined light recited in claims as is the incident light to the light guide section 43.

Light emitted in yet another direction from the LED section 3 reflects from the surface 13d of the bend section 13 as shown in FIG. 18. The reflection, for example, assumes optical path (31) in the figure and enters the light guide section 41 through the surface 41c of the light guide section 41. The light travels along optical path (32) in the figure without total reflection from the surface of the light guide section 41 before exiting through the surface 41a toward the liquid crystal panel. In this manner, some light directly exits through the surface 41a without total reflection from the light guide section 41.

Light emitted in still another direction from the LED section 3 reflects from the surface 13d of the bend section 13 as shown in the figure. The reflection, for example, takes optical path (41) in the figure and incident to the convex section 43s of the light guide section 43 without passing inside the light guide section 41. In this manner, some light enters the light guide section 43 directly without passing through the light guide section 41.

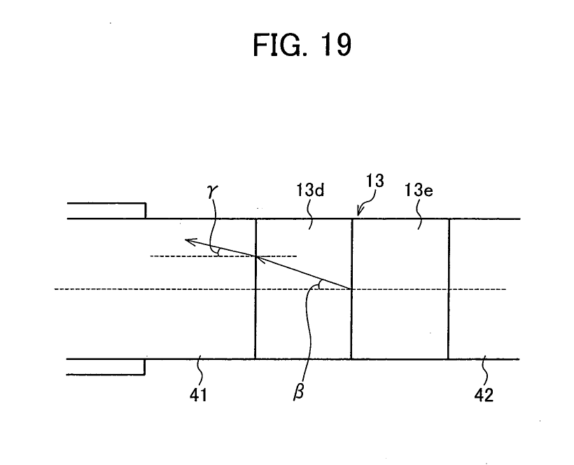

Here, as shown in FIG. 19, the angle between the second virtual plane and the optical path of the light projected in the Z direction from the LED section 3 onto the surface 11a will be termed a second angle (β). Further, the angle between the second virtual plane and the optical path of the light projected in the Z direction onto the surface 11a, the light having reflected from the surface 13d of the bend section 13 and just entered the light guide section 41 or the convex section 43s, will be termed a third angle (γ).

Now, a relationship between the second and third angles will be described for the light guide plate 40 having such a bend section 13 that the surfaces 13d and 13e, when projected in the Z direction, cast square images (“projection shape”) on the surface 13a.

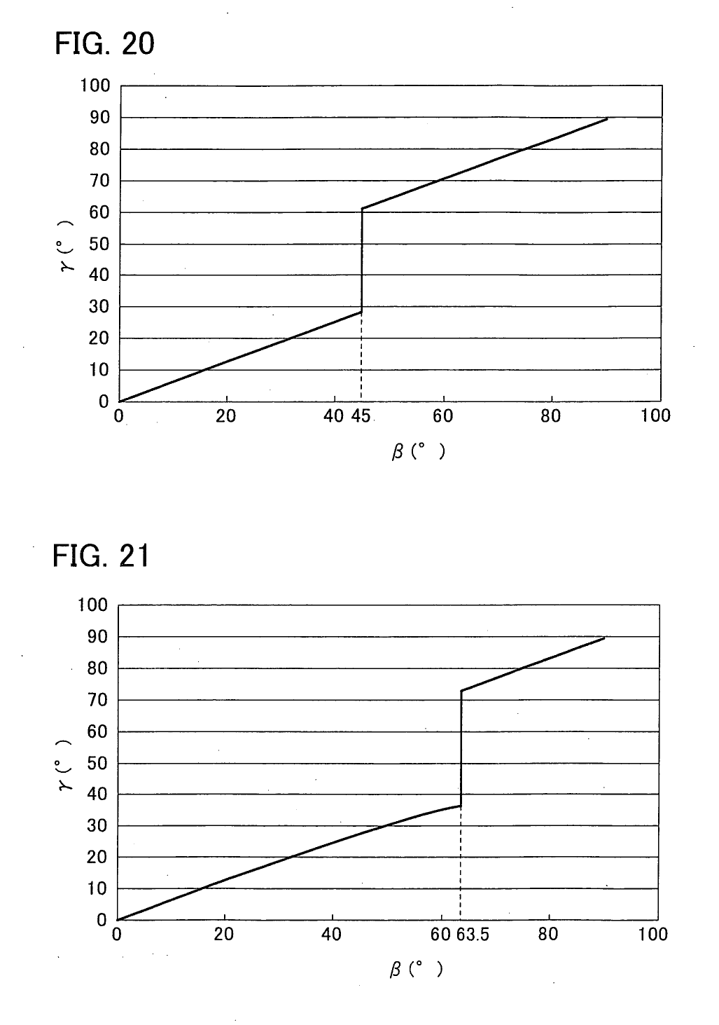

Under these circumstances, as shown in FIG. 20, γ=K×β at β<45°, where γ is the third angle, β is the second angle, and K is a constant of proportionality. β reaches a critical point at 45° at which the rate of change of γ jumps. At β>45°, γ=K×β+C where C is a constant. The figure also shows that at β>45°, γ≧61°.

Next, the relationship between the second and third angles will be described for the light guide plate 40 having such a bend section 13 that the projection shape is a predetermined rectangle. Assume that the sides of the rectangle that are parallel to the intersecting line detailed above have a length 1.5 times that of the remaining sides that are perpendicular.

Under these circumstances, as shown in FIG. 21, γ=K×β at β<63.5°, where K is again a constant of proportionality. β reaches a critical point at 63.5° at which the rate of change of γ jumps. At β>63.5°, γ=K×β+C. The figure also shows that at β>63.5°, γ≧72°.

As described immediately above, the light guide section 41 is made to receive a greater amount of light by specifying the sides parallel to the intersecting line to be longer than the other sides. However, if the sides parallel to the intersecting line are made too long, the light emitted by the LED section 3 cannot reach some regions of the surfaces 13d and 13e, because the LED section 3 is a point source. It is therefore preferable if those sides are restricted not to exceed a certain length.

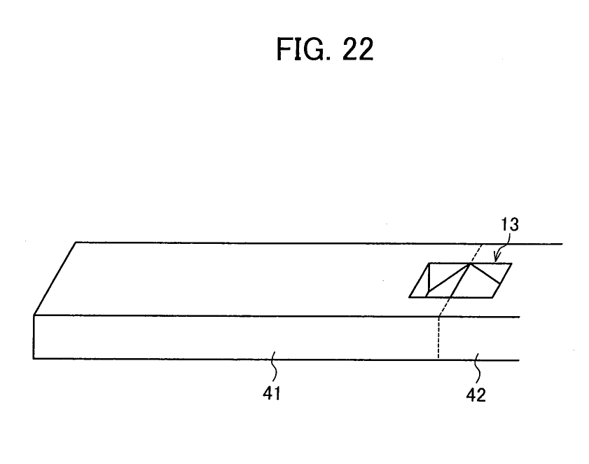

The light guide sections 41 and 42 may be shaped, as shown in FIG. 22, to encircle the surfaces 13b and 13c of the bend section 13.

The light guide plate 40 may be manufactured as a single unit from one plate (e.g., acrylic plate) by, for example, processing (cutting) and surface-treating it.

Varying the d value can change the optical paths in the light guide sections 41 and 42 and the amount of incident light to the light guide sections 41, 42.

As described in the foregoing, the light guide plate 40 is a structure which includes the light guide section 43, the bend section 13, and the light guide section (other light guide section) 41. The section 43 guides the predetermined light incident from a pre-set direction (from the surface 41e to the surface of the light guide section 43 facing the surface 41e) so that the light exits through the surface (predetermined surface) 43a as it travels down along the surface 43a. The bend section 13 turns the external light incident to the surface opposite the surface 43a into a predetermined direction by one reflection. The light guide section 41 reflects the total external light previously turned into the predetermined direction to guide the light inside thereof and turns the light into the pre-set direction by means of the reflection plates 41r1 and 41r2 so that the light enters the light guide section 43. The positions of the reflection plates 41r1 and 41r2 are the predetermined positions recited in claims.

With the structure, the bend section 13 turns the external light incident to the surface opposite the surface 43a into the predetermined direction by one reflection. In addition, the light guide section 41 turns the external light previously turned into the predetermined direction into the pre-set direction by means of the reflection plates 41r1 and 41r2 so that the light enters the light guide section 43. Also, the light having turned into the pre-set direction and entered the light guide section 43 is guided by the light guide section 43 so as to exit through the predetermined surface.

Since a single reflection brings the light into the light guide section 41, the light guide plate itself can be made relatively thin when compared to structures where multiple reflections are involved.

In addition, the light guide section 43 guides the predetermined light along the predetermined surface; the light source, emitting the external light, can therefore be disposed in relatively close proximity to the surface opposite the light guide plate when compared to the structure of conventional direct backlights. Further, since the light source, emitting the external light, does not need to be disposed on an edge of the light guide plate 40, the predetermined surface can be readily combined with other such surfaces in a matrix when compared to the structure of conventional edge-lit type backlights. These individual factors all facilitate the realization of a large illumination surface.

Therefore, the light guide plate 40 is suited for reducing the thickness of the backlight device and increasing the illumination surface of the backlight device in area.

Further, the light guide section 41 turns the external light by means of the reflection plates 41r1 and 41r2 at least toward the light guide section 43 in the pre-set direction. For these reasons, the predetermined light entering the light guide section 43 is linear even when the light source, emitting the external light, is a point source (LED). The light guide section 43 then tweaks the linear light so that planar light exits through the predetermined surface.

Therefore, in the light guide plate 40, the light source, emitting the external light, can be a point source.

The light guide plate 40 can also be said to be a structure which includes the light guide section 44. The section 44 guides predetermined light incident from a pre-set direction (from the surface 41f toward the surface of the light guide section 43 facing the surface 41f) so that the light exits through the surface (predetermined surface) 44a as it travels down along the surface 44a. The plate 40 includes the bend section 13 and the light guide section (other light guide section) 41. The bend section 13 turns the external light incident to the surface opposite the surface 44a by one reflection into the predetermined direction. The light guide section (other light guide section) 41 turns the external light previously turned into the predetermined direction by total reflections so that the light travels therein. The reflection plates 41r1 and 41r2 turns the light at least toward the light guide section 44 and the pre-set direction. When this is the case, similar effects to those detailed above are achieved.

The light guide plate 40 is also a structure which includes the light guide section (first light guide section) 41 and the light guide section (second light guide section) 42. The light guide sections 41 and 42 are disposed flanking the bend section 13. The bend section 13 turns the external light into a first direction (predetermined direction), that is, toward the light guide section 41, and a second direction (predetermined direction), that is, toward the light guide section 42.

In the structure, the bend section 13 turns the external light incident to the surface opposite the surfaces (predetermined surfaces) 43a and 44a into the first direction and the second direction respective by one reflection.

Thus, the light travels in the two light guide sections 41 and 42 flanking the bend section 13 and exits through the surfaces 43a and 44a of the light guide sections 43 and 44.

The light guide plate 40 is also a structure which includes the light guide section (third light guide section) 43 and the light guide section (fourth light guide section) 44. The light guide sections 43 and 44 are disposed flanking the bend section 13 and the light guide sections 41 and 42. Both the light guide sections 41 and 42 turn the internally guided light into the pre-set direction (third direction), that is, toward the light guide section 43, and the pre-set direction (fourth direction), that is, toward the light guide section 44.

In the structure, the light guide section 41 turns the internally guided light into the pre-set direction (third direction), that is, toward the light guide section 43, and the pre-set direction (fourth direction), that is, toward the light guide section 44. In addition, the light guide section 42 similarly turns the internally guided light into the third and fourth directions.

Thus, the light travels in the two light guide sections 41 and 42 and exits through the surfaces 43a and 44a of the two light guide sections 43 and 44 flanking the bend section 13 and the light guide sections 41 and 42.

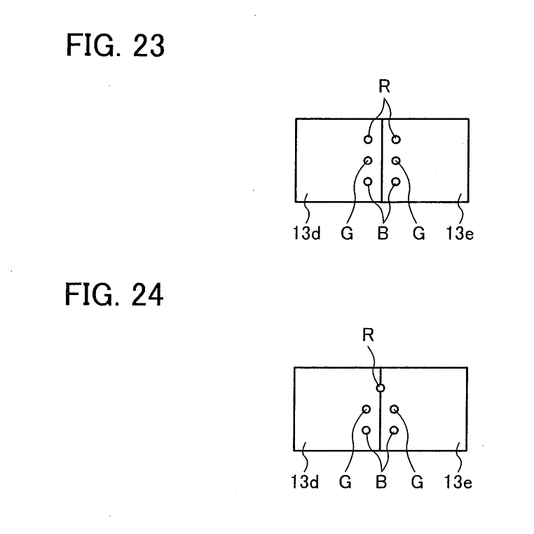

The LED section 3 with three LEDs shown in FIG. 2 was used for the light guide plate 2 of embodiment 1 and the light guide plate 40 of embodiment 2. This is by no means intended to be limiting the invention. For example, as shown in FIG. 23, there may be provided two red LEDs, two green LEDs, and two blue LEDs with each pair of LEDs of the same color being positioned symmetric with respect to the intersecting line thereof.

Further, the LED section 3 may have one LED for one of the colors (for example, R) and two LEDs for each of the remaining colors. When this is the case, as shown in FIG. 24, the green LEDs and the blue LEDs may be positioned so that they are symmetric with respect to the intersecting line thereof.

In embodiments 1 and 2, the light emitted by the LED section 3 have been reflected (turned) from the two surfaces 13d and 13e of the bend section 13. This is by no means intended to be limiting the invention.

Any structure that reflects the light emitted by the LED section 3 may be used. An example is the side surface of a circular cone. Another example is four side surfaces of a quadrangular cone.

In embodiments 1 and 2, the surfaces 13d and 13e have been composed of a material that efficiently reflects light. The surfaces 13d and 13e however do not need to be entirely composed of such a material. The surfaces 13d and 13e may have a pattern consisting of regions where the surface is made of the material and those where the surface is made of something else, so that the light emitted by the LED section 3 is partly guided to directly enter the bend section 13.

In the foregoing, the point sources (light emitting elements) were LEDs. This is by no means limiting the invention. Light sources other than LEDs may be used.

Further, the point sources may be replaced by line light sources disposed along the intersecting lines.

### Embodiment 3

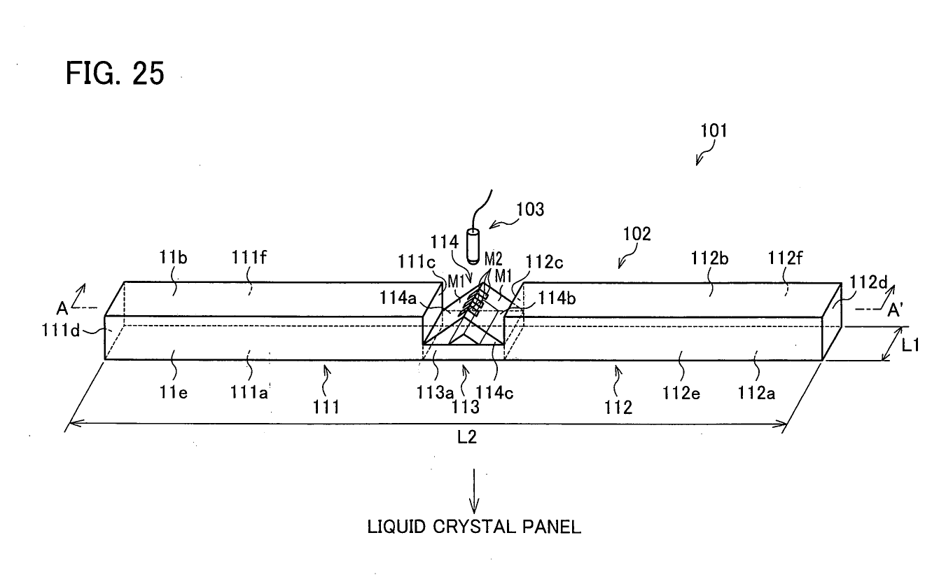

The following will describe another embodiment of the present invention in reference to FIGS. 25 to 36.

FIG. 25 is a schematic perspective view showing the structure of a backlight in accordance with the present invention. As shown in the figure, a backlight (lighting device) 101 includes a light guide plate 102 and an LED section 103. The light guide plate 102, as shown in the figure, includes a light guide section (fifth light guide section) 111, another light guide section (sixth light guide section) 112, a first member 113, and a fourth member 114. The first and second members 113 and 114 are located between the light guide sections 111 and 112. In the following, for ease of description, it is assumed that the light guide sections 111 and 112 are symmetric with respect to the first and second members 113 and 114.

The light guide section 111 is substantially of the shape of a rectangular parallelepiped. The light guide section 111 has surfaces 111a to 11 if. The surface (illumination surface) 111a faces a liquid crystal panel. The surface 111b faces the LED section 103. The surface 111c is adjacent to the first member 113 and faces the outside. The surface 111d is opposite the surface 111c. Further, the remaining surfaces 111e and 111f are in front and in back of the figure respectively.

The light guide section 112 has surfaces 112a to 112f which are located analogous to the surfaces 111a to 111f on the light guide section 111. The surface 112a, like the surface 111a, is the illumination surface recited in claims.

The light guide sections 111 and 112 are composed at least internally of a material capable of guiding light: for example, a transparent acrylic material or a glass material.

The first member 113 is substantially of the shape of a rectangular parallelepiped as shown in FIG. 26. The first member 113 has surfaces 113a to 113d.

The surface 113a is adjacent to the surface 111e of the light guide section 111 and the surface 112e of the light guide section 112. The surface 113b is adjacent to the surface 11 if of the light guide section 111 and the surface 112f of the light guide section 112. The surface 113c faces the liquid crystal panel. The surface 113d is opposite the surface 113c.

Further, the first member 113 includes a plurality of scattering bodies (scattering means) 113m near the surface 113d. The scattering bodies 113m are not limited in any particular manner in shape, material, etc. so long as they are able to scatter light projected onto them. Also, the arrangement of the scattering bodies 113m is not limited in any particular manner. It is nevertheless preferable if the scattering bodies 113m are located uniformly across the surface 113c.

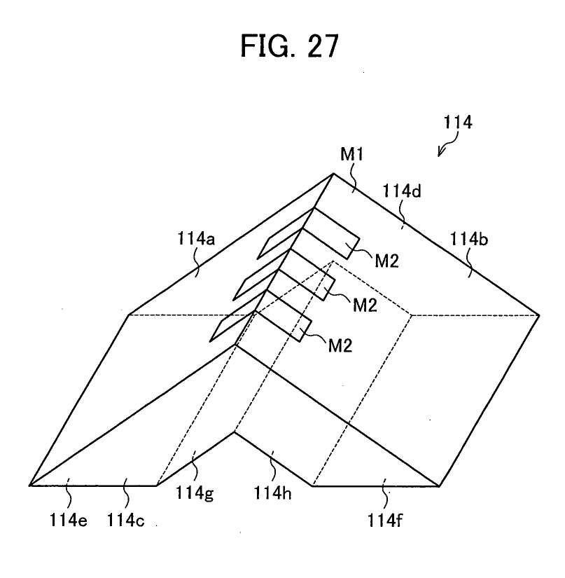

The second member 114 has surfaces 114a to 114h as shown in FIG. 27. The surface (second surface) 114a faces the LED section 103 and is adjacent to the surface 111c of the light guide section 111. The surface (second surface) 114b faces the LED section 103 and is adjacent to the surface 112c of the light guide section 112.

The surfaces 114a and 114b are adjacent to each other and have an intersecting line parallel to the surface 11c of the light guide section 111 and the surface 112c of the light guide section 112. The surfaces 114a and 114b have the same shape. Assuming a third virtual plane which includes the intersecting line and is perpendicular to the surface 113c of the first member 113, the surfaces 114a and 114b are tilted a predetermined angle θ1 with respect to the third virtual plane in mutually opposite directions.

The surface 114c is adjacent to the surface 113a of the first member 113. The surface 114d is adjacent to the surface 113b of the first member 113. The surface 114e is in surface contact with the surface 113d of the first member 113 and is adjacent to the surface 114a. The surface 114f is in surface contact with the surface 113d of the first member 113 and is adjacent to the surface 114b.

The surface 114g is opposite the surface 114a with respect to the surface 114e and is adjacent to the surface 114e. The surface 114h is opposite the surface 114b with respect to the surface 114f and is adjacent to the surface 114f. The surfaces 114g and 114h are adjacent to each other.

The surfaces 114g and 114h are adjacent to each other and have an intersecting line parallel to the surface 111c of the light guide section 111 and the surface 112c of the light guide section 112. The surfaces 114g and 114h have the same shape. The intersecting line is in the third virtual plane. The surfaces 114g and 114h are tilted a predetermined angle θ2 with respect to the third virtual plane in mutually opposite directions.

The surfaces 114a and 114b each have a reflection-region M1 and transmission regions M2 as shown in FIGS. 25 and 27. With the surfaces 114a and 114b being collectively referred to as the second surface, the FIG. 25 example shows three transmission regions M2 arranged in a row near the center of the second surface. The number of transmission regions M2 is by no means limited. So are their positions.

The surfaces 114a, 114b, 114g, and 114h are the reflection means recited in claims.

Again, the first and second members 113 and 114 are composed internally of a material capable of guiding light. The reflection region M1 of the surfaces 114a and 114b of the second member 114, as well as the surfaces 114g and 114h, is composed of a light-reflecting material (for example, aluminum). In contrast, the transmission regions M2 are composed of a light-transmitting material: for example, the same material as the material constituting the interior of the second member 114.

The second member 114 may be manufactured, for example, by forming an acrylic plate of the shape shown in FIG. 27 after which aluminum is vapor deposited where the reflection region M1 of the surfaces 114a and 114b will be formed. Alternatively, aluminum may be vapor deposited where the reflection region M1 and transmission regions M2 will be formed (surfaces 114a and 114b), followed by the removal of the aluminum where the transmission regions M2 will be formed.

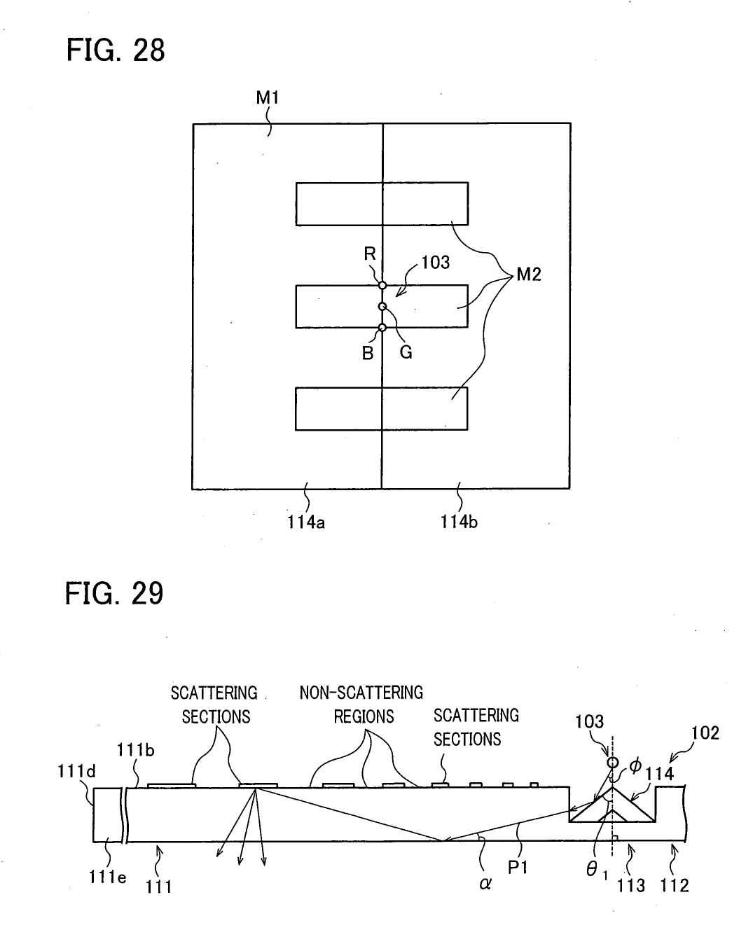

The LED section 3 includes three light emitting diodes (“LEDs”): a red (R) light emitting diode (“red LED”), a green (G) light emitting diode (“green LED”), and a blue (B) light emitting diode (“blue LED”). The structure enables generation of white light (external light). As shown in FIG. 28, each LED has a light emitting surface in the third virtual plane with that plane equally dividing the light emitting surface. The LEDs are the light emitting elements recited in claims.

On the light guide plate 2, the surface 111a of the light guide section 111, the surface 113c of the first member 113, and the surface 112a of the light guide section 112 form a single plane (“LC-facing plane”). The LC-facing plane is rectangular. In the following, assume that the length of the sides of the LC-facing plane parallel to the intersecting line is L1, and that of the sides perpendicular to the intersecting line is L2.

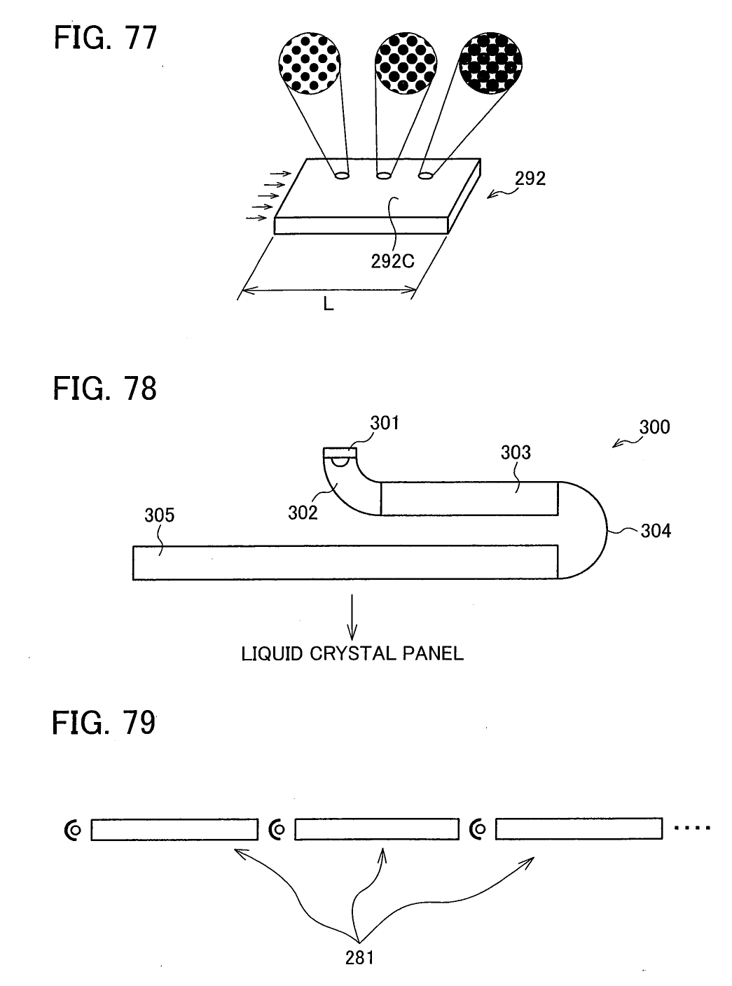

The surface 111b of the light guide section 111 and the surface 112b of the light guide section 112 has a predetermined light scattering pattern. An example of the pattern is shown in FIG. 77. The pattern is by no means limited to this example; any of the various, publicly known patterns may be used. The pattern only needs to have geometry which grows in size with the distance from the surfaces 111c and 112c. In the following, the geometry will be referred to as the light scattering sections. The rest of the surface 111b (i.e., excluding the light scattering sections) will be referred to as the non-scattering region.

Next, optical paths when the LED section 103 is lit will be described in reference to FIG. 29. Since the light guide plate 102 is symmetric with respect to the third virtual plane, the following description will focus on optical paths in the light guide section 111. FIG. 29 is a cross-sectional view of the light guide plate taken along line A-A′ in FIG. 25.

First will be described the optical paths of light emitted by the LED section 103 and reflected from the reflection region M1 of the surface 114a of the second member 114.

As shown in the figure, light leaves the LED section 103 at a predetermined angle φ with respect to the third virtual plane and reflects from the reflection region M1. The reflection (predetermined light) passes through the surface 111c and enters the light guide section 111. Upon entering the section 111, the light is refracted by the surface 111c. The light, after entering the light guide section 111, experiences total reflections from the non-scattering regions (i.e., interface) of the surfaces 111a and 111b as it propagates in the light guide section 111. Of the incident light, the part hitting a scattering section of the surface 111b is scattered by that scattering section. Of that scattered light, the part subjected to no total reflections from the surface 11a, etc. exit through the surface 111a. Thus, the liquid crystal panel is illuminated.

Some of the light emitted by the LED section 103 is directly incident to the surface 111c, entering the light guide section 111, without being reflected from the surface 114a.

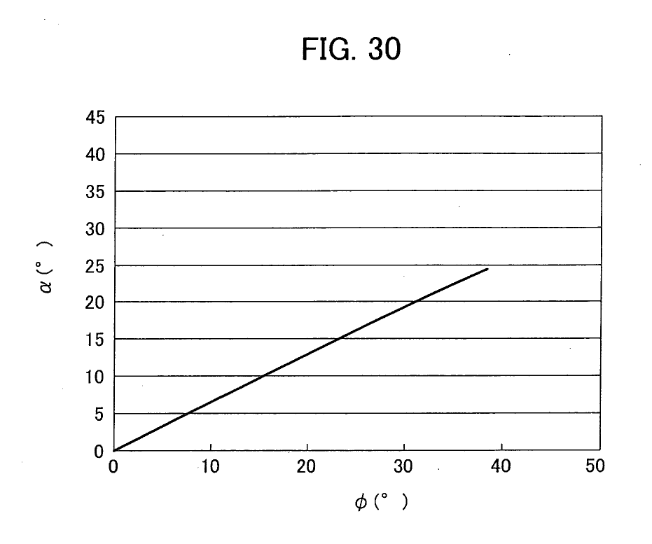

FIG. 30 is a representation of a relationship between the angle φ and an angle α (“fourth angle”). α is the angle of the optical path (P1 in FIG. 27) of light immediately after incident to the surface 111c (that is, after being refracted by the surface 111c) with respect to the LC-facing plane. The figure assumes that 01 is 45°. When the light guide section 111 is composed internally of an acrylic material of a refractive index of 1.5, light does not undergo total reflection from the surfaces (interface) 111a and 111b of the light guide section 111 if the fourth angle is in excess of about 48°. However, with this composition and structure, total reflection takes place on the surfaces 111a and 111b of the light guide section 111 even when φ takes a maximum value (here, about 38°) as indicated in FIG. 28.

As mentioned above, the value of a changes with that of φ. Therefore, the light emitted by the LED section 103 is scattered by the scattering sections disposed at different locations. Moreover, the scattering sections occupy a progressively increasing proportion of the surface 111b as they are farther away from the surfaces 111c and 112c. This means that the light leaving through the surface 111a is substantially uniform. The uniformity of the outgoing light will be increased by advance calculational simulation of an optimal pattern for the scattering sections.

The light leaving the light guide section 112 through the surface 112a is also uniform for the same reasons.

In the foregoing, the light source consisted of LEDs, or point sources. If the value of L1 is increased in excess, it becomes difficult to output uniform light through the surfaces 111a and 112a. In contrast, the value of L2 can be increased to a certain level because of internal light-guiding capability of the light guide sections 111 and 112 and the patterns formed on the surfaces 111b and 112b. These facts indicate that because of the use of the LED section 3, the LC-facing plane of the light guide plate 102 is preferably elongated relative to its width so as to output uniform light through the surfaces 111a and 112a.

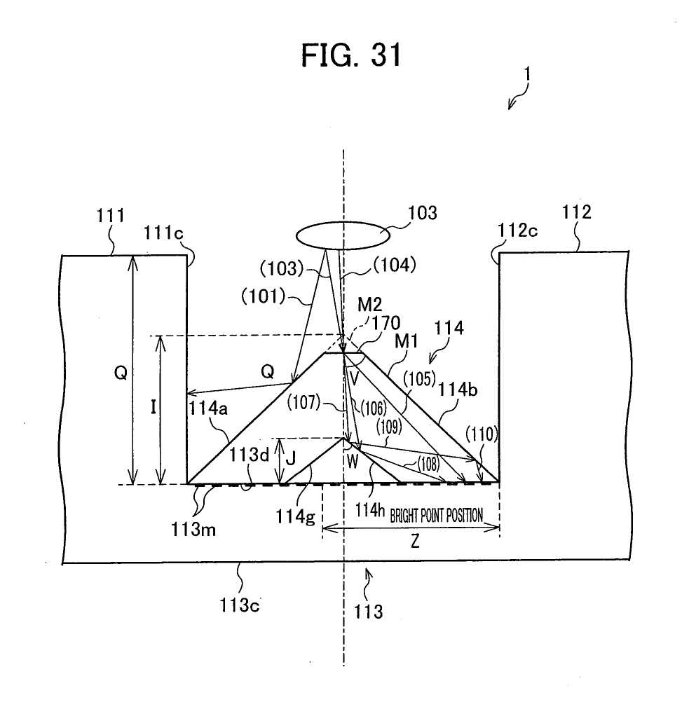

Next, referring to FIG. 31, the optical paths of light emitted by the LED section 103 and passing through the transmission regions M2 of the surfaces 114a and 114b of the second member 114 will be described.

Not all external light projected onto the surfaces 114a and 114b takes optical path (101), reflects from the surface 114a onto optical path (102), and entering the light guide section 111. Some of that external light does not reflect from the surfaces 114a and 114b; it hits the transmission regions M2 and enters the second member 114, which will be described now. Since the light guide plate 102 is symmetric with respect to the third virtual plane, the following description will focus on optical paths in the light guide section 112.

Light incident to a transmission region M2 takes, for example, optical path (103) or (104).

The light is refracted by the transmission region M2. This example assumes a refractive index of 1.5.

Some part of the refracted light propagates along optical path (105) shown in the figure, passing through the surface 113d of the first member 113, and hits a bright point position on the first member 113. The light enters the first member 113 and is scattered by a scattering body 113m. The scattered light takes a plurality of optical paths and exits through the surface 113c toward the liquid crystal panel. In the following, this light which does not reflect from the surfaces 114b and 114h will be referred to as the first light.

Other part of the refracted light propagates along optical path (106) shown in the figure and undergoes total reflection from the surface 114h. The total reflection from the surface 114h takes optical path (108) in the figure, passing through the surface 113d of the first member 113, and hits the bright point position on the first member 113. The light enters the first member 113 and is scattered by a scattering body 113m. The scattered light takes a plurality of optical paths and exits through the surface 113c toward the liquid crystal panel. In the following, this light which reflects from the surface 114h, but not from the surface 114b will be referred to as the second light.

Further part of the refracted light propagates along optical path (107) shown in the figure and undergoes total reflection from the surface 114h. The total reflection from the surface 114h takes optical path (109) in the figure and undergoes total reflection from the surface 114b. This total reflection from the surface 114b takes optical path (110) in the figure, passing through the surface 113d of the first member 113, and hits the bright point position on the first member 113. The light enters the first member 113 and is scattered by a scattering body 113m. The scattered light takes a plurality of optical paths and exits through the surface 113c toward the liquid crystal panel. This light which reflects from the surfaces 114h and 114b will be referred to as the third light.

The foregoing description explained as an example the light which enters the second member 114 via the transmission regions M2 and undergoes total reflection from the surface 114h. The same optical paths are taken by the light which enters the second member 114 via the transmission regions M2 and undergoes total reflection from the surface 114g.

As described in the foregoing, in the light guide plate 2, light is incident to the transmission regions M2, entering the second member 114, and scattered by the scattering bodies 113m. Thus, the liquid crystal panel is illuminated uniformly by the light from the surface 113c when compared to structure including no scattering bodies 113m.

Some of the light scattered by the scattering bodies 113m does not travel toward the surface 113c of the first member 113, but travels toward the second member 114. That is, some of the light returns again into the second member 114. However, most of that light reflects again from the surfaces 114a and 114b and/or surfaces 114g and 114h of the second member 114 and is incident to the surface 113d of the first member 113, again entering the first member 113. Therefore, by providing the surfaces 114a and 114b and the surfaces 114g and 114h as a light-reflecting structure, the light which enters the second member 114 through the transmission regions M2 is efficiently output from the surface 113c of the first member 113.

Some of the light which enters the second member 114 through the transmission regions M2 is not scattered by the scattering bodies 113m, but exits through the surface 113c toward the liquid crystal panel.

The distance between the surfaces 111b and 113d, indicated by arrow Q in FIG. 31, is 4.0 mm. The distance from the surface 113d to a top 70 of the second member, indicated by arrow I, is 2.5 mm. The distance from the surface 113d to the intersecting line of the surfaces 114g and 114h, indicated by arrow J, is 0.7 mm. The range of the bright point position, indicated by arrow Z, 3.0 mm.

The figure shows, using a dash-dot line, a normal line to the surface 113d which crosses the intersecting line of the surfaces 114a and 114b. As shown in FIG. 31, the dash-dot line makes a 50° angle V with the surface 114b and a 45° angle W with the surface 114h. The values of the distances and angles given are mere examples.

The following will describe results of simulation of positions reached on the surface 114f by the light emitted by the LED section 3 and passing through the transmission regions M2.

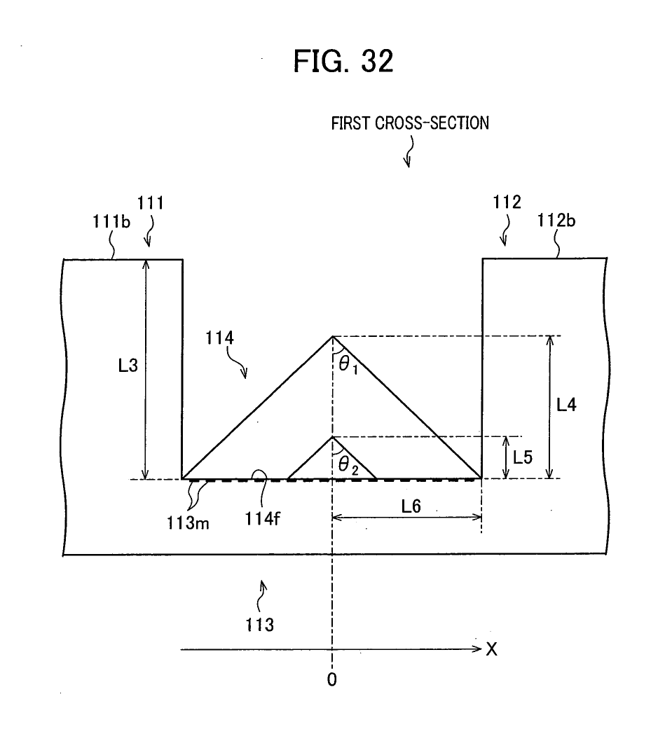

In the following, as shown in FIG. 32, a cross section of the first light guide plate which contains the center of the LED section 103 and that of the light guide plate 102 and which is perpendicular to the third virtual plane will be referred to as a first cross section. Moreover, in the first cross section, a coordinate axis X indicates the normal direction to the third virtual plane. For ease of description, an origin for the X axis is specified to be on the third virtual plane. The positive direction is the direction of the surface 112c.

The distance from the surface 113d of the first member 113 (more specifically, the surface where the scattering bodies 113m are formed) to the surface 111b of the light guide section 111 is labeled L3. In addition, in the figure, the distance from the surface 113d to the intersecting line of the surfaces 114a and 114b is labeled L4. The distance from the surface 113d to the intersecting line of the surfaces 114g and 114h is labeled L5. The distance from the third virtual plane to the surface 112c (or 111c) is labeled L6.

Letting S1 represent the area of the surface 114a projected onto the surface 114f, the sum, S, of the areas of two transmission regions M2 is specified, for example, at a value given by:
S=2×S1/(L1×L2) (1)

The following description will assume, as an example, that L3=4 mm, L4=2.5 mm, L5=0.7 mm, and L6=3 mm. In this case, θ1=50°, and θ2=45°. Assume further that one of the transmission regions M2 is positioned directly under the LED section 3.

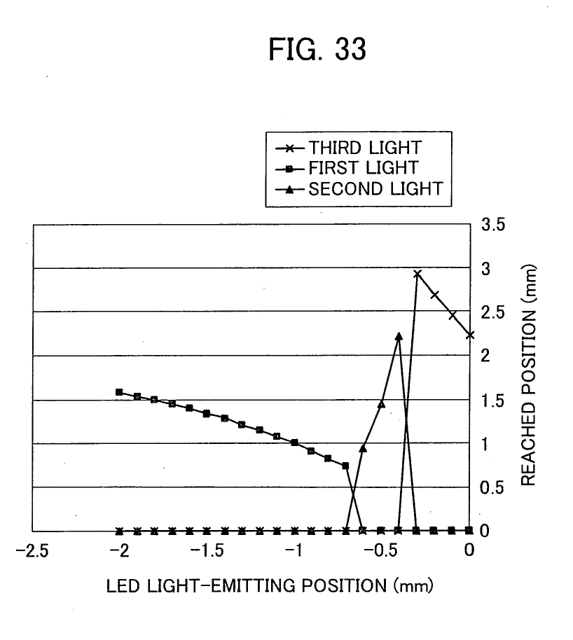

FIG. 33 is a graph representing, using the X coordinate, positions in regions of the surface 114f in the first cross section which are reached by the first, second, and third light (simulation results). To describe it in more detail, the calculations in FIG. 33 are results for the light emitted by the LED section 103 being incident to a plane on the top 170 (see FIG. 31) of the second member 114.

The horizontal axis of the graph indicates a light-emitting position of the LED section 103 on the X axis. The vertical axis indicates the reached positions on the X axis. The figure shows a case where the refractive indices of the light guide sections 111, 112 are specified at 1.5.

As shown in the figure, when the light-emitting position is at −0.3 mm, the position reached by the third light is close to 3 mm. In other words, the third light reaches a region of the surface 114f near the intersecting line of the surfaces 114b and 112c. As would be understood from the graph, one of the first to third light reaches at least a region of the surface 114f in the first cross section.

As described in the foregoing, the light guide plate 2 is a structure which includes the light guide section 111 and the surface 114a (second surface). The section 111 guides the light incident from the direction pointing from the surface 114a toward the surface 111c (fifth direction) so that the light exits through the surface (illumination surface) 11a as it travels down along the surface 111a. The surface 114a has a reflection region M1 and transmission regions M2. The reflection region M1 turns the external light incident to the surface opposite the surface 11a into the fifth direction by one reflection so that the light enters the light guide section 111. The transmission regions M2 allows passage of the external light therethrough toward the illumination surface.

In the structure, the reflection region M1 of the surface 114a turns the external light incident to the surface opposite the surface 111a into the fifth direction by one reflection so that the light enters the light guide section 111. In addition, the light having turned into the fifth direction and entered the light guide section 111 is output by the light guide section 111 from the surface 111a.

Since a single reflection brings the light into the light guide section 111, the light guide plate 102 itself can be made relatively thin when compared to structures where multiple reflections are involved.

In addition, the light guide section 111 guides the light incident from the fifth direction along the surface 11a; the LED section (light source) 103, emitting the external light, can therefore be disposed in relatively close proximity to the surface opposite the light guide plate 102 when compared to the structure of conventional direct backlights.

Further, since the LED section 103 does not need to be disposed on an edge of the light guide plate 102, the plane consisting of the surface 111a (that is, LC-facing plane) can be readily combined with other such planes in a matrix when compared to the structure of conventional edge-lit type backlights. These individual factors all facilitate the realization of a large illumination surface for a device (backlight device) which includes a plurality of combined backlights 1.

Therefore, the light guide plate 102 is suited for reducing the thickness of the backlight device and increasing the illumination surface of the backlight device in area.

The light guide plate 102, having the transmission regions M2 on the surface 114a, allows passage of the external light toward the surface 111a. Therefore, the external light can be output also from the side of the surface 114a facing the surface 111a toward the surface 111a. Therefore, relatively uniform light is projected toward the surface 111a when compared to light guide plates of which the entire surface 114a is the reflection region M1.

The light guide plate 2 is a structure which includes the light guide section 112 and the surface 114b (second surface). The section 112 guides the light incident from the direction from the surface 114b toward the surface 112c (fifth direction) so that the light exits through the surface (illumination surface) 112a as it travels down along the surface 112a. The surface 114b has a reflection region M1 and transmission regions M2. The reflection region M1 turns the external light incident to the surface opposite the surface 112a into the fifth direction by one reflection so that the light enters the light guide section 112. The transmission regions M2 allows passage of the external light therethrough toward the illumination surface. The structure achieves the same effects as those detailed above.

The light guide plate 102 is a structure which includes scattering bodies (scattering means) 113m. The scattering bodies 113m scatter the light transmitted through the transmission regions M2 toward the surface 111a (that is, surface 113c).

In the structure, the scattering bodies 113m scatter the light transmitted through the transmission regions toward the surface 113c. Therefore, relatively uniform light is projected from the side facing the surface 111a when compared to light guide plates having no scattering bodies 113m. The same applies to the light guide section 112.

The light guide plate 102 is a structure which includes surfaces (reflection means) 114a and 114g reflecting the transmitted light and guiding the light toward the surface 111a (that is, the surface 113c).

In the structure, the surfaces 114a and 114g reflect the light transmitted through the transmission regions M2. Also, the surfaces 114a and 114g guide the transmitted light toward the surface 111a.

Therefore, the optical paths of the light which is transmitted through the transmission regions M2 and output from the light guide plate can be elongated when compared to the structure of light guide plates with no surfaces 114a and 114g which have such reflecting functions. Therefore, relatively uniform light is projected from the illumination surface when compared to the structure of light guide plates with no surfaces 114a and 114g which have the aforementioned functions. The same applies to the light guide section 112.

The light guide plate 102 is a structure in which the surfaces (second surface) consisting of the surface 114a and the surface 114b includes a plurality of transmission regions M2. In the structure, relatively uniform light is projected from the illumination surface when compared to light guide plates of a structure in which there is provided only one transmission region M2.

The light guide plate 102 is a structure which includes the light guide section (fifth light guide section) 111 and the light guide section (sixth light guide section)

112. The light guide sections 111 and 112 are disposed to flank the surfaces 114a and 114b. The reflection region M1 turns the external light into a fifth direction toward the fifth light guide section 111 (fifth light guide section direction) and into a fifth direction toward the sixth light guide section 112 (sixth light guide section direction).

In the structure, the surfaces 114a and 114g turns the external light incident from the surfaces opposite the surfaces 111a and 112a into the fifth light guide section direction and the sixth light guide section direction respectively by one reflection. Therefore, the light guide sections 111 and the sixth light guide section 112 flanking the surfaces 114a and 114g can output light.

In the foregoing, the scattering bodies 113m were provided on the first member 113 as an example. They may be provided in close proximity to the surfaces 114e and 114f of the second member 114.

To increase the amount of light exiting through the surfaces 111a and 112a, the surfaces 111d, 111e, 111f, 112d, 112e, and 112f are preferably adapted to scatter or reflect light. For example, the surfaces may be composed of a white paint (thin film).

If there is provided a reflection sheet facing the surfaces 111b and 112b, the amounts of light exiting through the surfaces 111a and 112a are further increased.

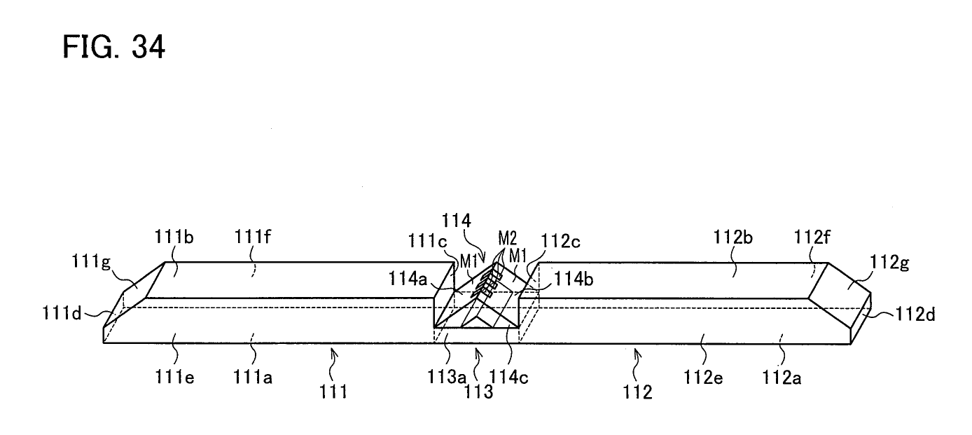

In the light guide plate 102, the light guide sections 111 and 112 are of the shape of a rectangular parallelepiped. This is by no means intended to be limiting the invention. For example, as shown in FIG. 34, the light guide sections 111 and 112 may have a tilt surface 111g and a tilt surface 112g respectively. The tilt surface 111g is adjacent to the surfaces 111b and 111d. The tilt surface 111g is composed of a light-reflecting material or a light-scattering material. The tilt surface 111g is tilted with respect to the LC-facing plane toward the surface 111c. The tilt surface 112g is adjacent to the surfaces 112b and 112d. The tilt surface 112g is composed of a light-reflecting material or a light-scattering material. The tilt surface 112g is tilted with respect to the LC-facing plane toward the surface 112c.

When this is the case, in the light guide section 111, the light guide plate 102 may be said to be a structure in which: the external light is incident to the surface 111c of the light guide section 111; the light guide section 111 has an end surface, opposite the surface 111c, to which is applied a light-reflecting material or a light-scattering material; and the end surface has the tilt surface 111g tilted with respect to the surface 111a toward the surface 111c.

In the structure, the tilt surface 111g at least reflects or scatters the light guided to the end surface back to the light guide section 111 without letting the light exits through the end surface. Therefore, the external light is efficiently utilized. An increased amount of light exits through the surface 111a when compared to cases where no tilt surface 111g is provided. This description about the light guide section 111 applies also to the light guide section 112.

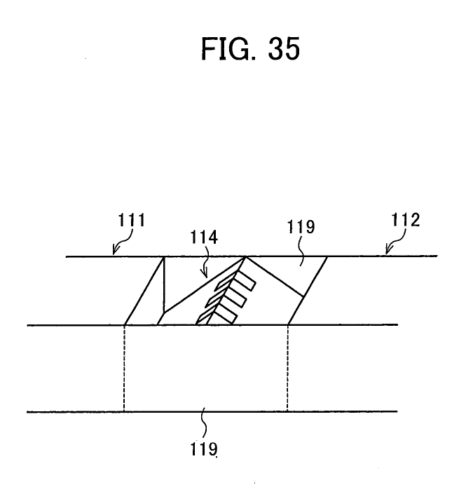

Further, as shown in FIG. 35, the light guide plate 102 preferably has reflection plates 119 on the surfaces 114c and 114d of the second member 114 toward the LED section 103. When this is the case, for example, the part of the reflection from the reflection region M1 of the surfaces 114a and 114b of the second member 114, which would not be incident to the surface 111c of the light guide section 111 and the surface 112c of the light guide section 112 without the presence of the reflection plate 119, is fed to the light guide sections 111 and 112.

Therefore, a greater part of the light emitted by the LED section 103 is fed to the light guide sections 111 and 112. The liquid crystal panel projects an increased amount of light.

In the light guide plate 102, the light guide section 111 has the same shape as the light guide section 112. This is by no means intended to be limiting the invention. The surface 111a of the light guide section 111 may differ in area from the surface 112a of the light guide section 112; still, the surfaces 111a and 112a can be adapted to allow the same amount of light per unit area to exit therethrough by changing the patterns of the surfaces 111b and 112b. Therefore, when this is the case, the light guide plate 102 again projects uniform light toward the liquid crystal panel.

If there are restrictions on the position of the LED section 103, the surfaces 111a and 112a can project light by changing the size ratio of the light guide sections 111 and 112.

In the above embodiment, the value of L1 needed to be small because of the use of a point source. To replace the LED section 3 with a line light source or an elongated surface light source, the value of L1 may be large. Therefore, in such a structure, the light guide plate may have illumination surfaces (surfaces 111a and 112a) occupying a large area.

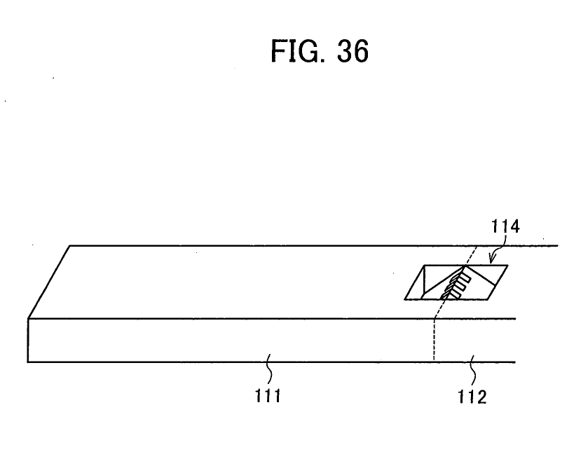

The light guide sections 111 and 112 may be shaped, as shown in FIG. 36, to encircle the surfaces 114a and 114b of the second member 114.

The light guide sections 111 and 112 and the first member 113 (three members) may be manufactured as a single unit from one transparent plate (e.g., acrylic plate) by, for example, processing (cutting) and surface-treating it.

### Embodiment 4

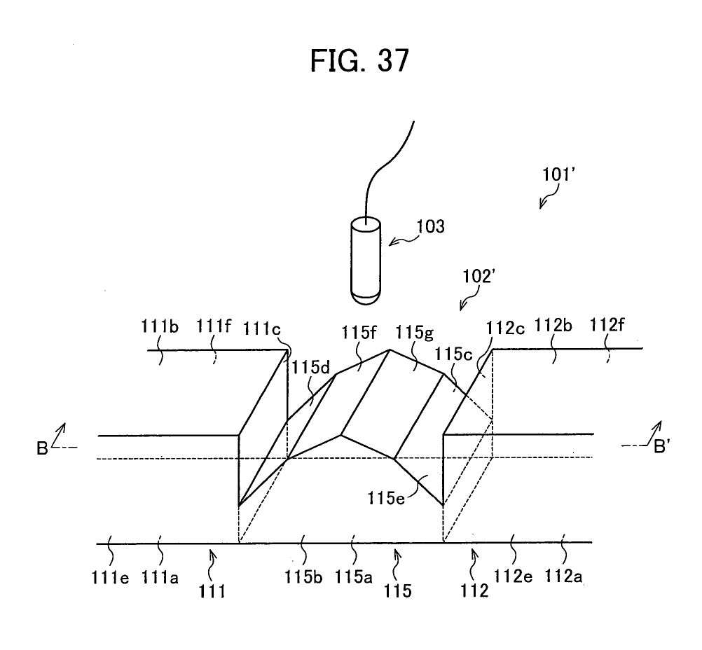

The following will describe another embodiment of the present invention in reference to FIGS. 37 to 42. Here, for ease of description, members of the present embodiment that have the same arrangement and function as members of embodiment 3, and that are mentioned in that embodiment are indicated by the same reference numerals and description thereof is omitted.

FIG. 37 is a schematic, structural perspective view of a backlight in accordance with the present invention. As shown in the figure, A backlight (lighting device) 101′ includes a light guide plate 102′ and an LED section 103. The light guide plate 102′, as shown in the figure, includes a light guide section 111, another light guide section 112, and a bend section 115. The bend section 115 is flanked by the light guide sections 111 and 112. The light guide plate 102′ includes the bend section 115 in place of the first member 113 and the second member 114 of embodiment 3.

The bend section 115 has surfaces 115a to 115g. The surface 115a faces a liquid crystal panel. The surface 111a of the light guide section 111, the surface 115a of the bend section 115, and the surface 112a of the light guide section 112 form a single plane (“LC-facing plane”). The surface 115b is adjacent to the surface 111e of the light guide section 111 and the surface 112e of the light guide section 112. The surface 115c is adjacent to the surface 111f of the light guide section 111 and the surface 112f of the light guide section 112.

The surface (reflection surface, third reflection surface) 115d faces the LED section 103 and is adjacent to the surface 111c of the light guide section 111. The surface (reflection surface, third reflection surface) 115e faces the LED section 103 and is adjacent to the surface 112c of the light guide section 112. The surfaces 115d and 115e have the same shape.

The surface (reflection surface, fourth reflection surface) 115f faces the LED section 103 and is adjacent to the surface 115d. The surface (reflection surface, fourth reflection surface) 115g faces the LED section 103 and is adjacent to the surface 115e. The surfaces 115f and 115g are adjacent to each other and have an intersecting line parallel to the surface 11c of the light guide section 111 and the surface 112c of the light guide section 112. The surfaces 115f and 115g have the same shape. The surfaces 115d, 115e, 115f, and 115g are composed of a light-reflecting material (for example, aluminum).

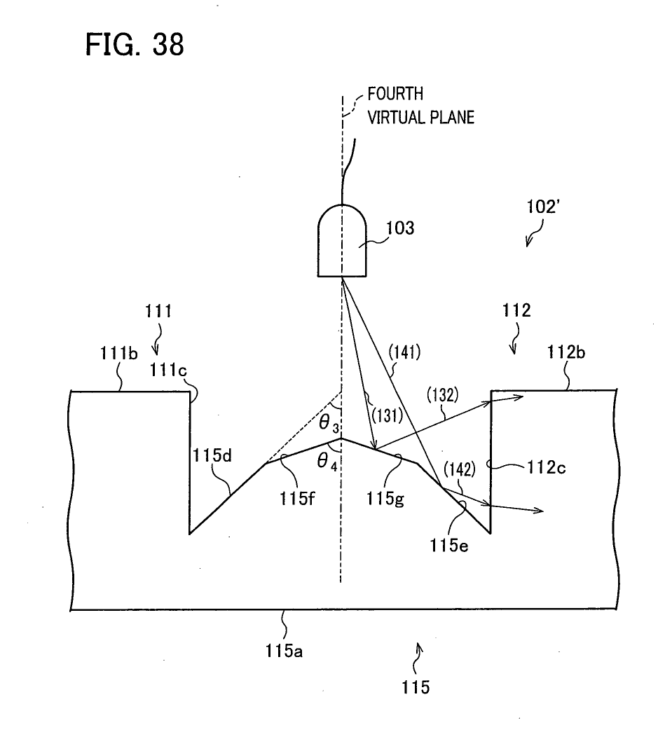

Assuming a fourth virtual plane which includes the intersecting line and is perpendicular to the surface 115a, the surfaces 115d and 115e are tilted a predetermined angle θ3 with respect to the fourth virtual plane in mutually opposite directions as shown in FIG. 38. The surfaces 115f and 115g are tilted a predetermined angle θ4 with respect to the fourth virtual plane in mutually opposite directions as shown in the figure. The figure is a cross-sectional view of taken along line B-B′ in FIG. 36.

θ3 and θ4 satisfies a conditional equation: θ3<θ4<90°. So, comparing the surfaces 115g and 115e (or surfaces 115d and 115f), the surface 115g (surface 115f) facing the LED section 103 is tilted more than the other surface 115e (surface 115d) with respect to the fourth virtual plane. In other words, the surface 115g (surface 115f) facing the LED section 103 is tilted less than the other surface 115e (surface 115d) with respect to the surface 115a.

As described in the foregoing, the bend section 115 is symmetric with respect to the fourth virtual plane.

Next, optical paths when the LED section 103 is lit will be described in reference to FIG. 38. Since the light guide plate 102′ is symmetric with respect to the fourth virtual plane, the following description will focus on optical paths in the light guide section 112.

As shown in the figure, some part of the light emitted by the LED section 103 propagates along optical path (131) shown in the figure and reflects from the surface 115g. The reflection from the surface 115g assumes optical path (132) in the figure, passing through the surface 112c and entering the light guide section 112. Other part of the light emitted by the LED section 3 assumes optical path (141) shown in the figure and reflects from the surface 115e, not from the surface 115g. As described here, the light guide plate 102′ reflects the light emitted by the LED section 103 by means of one of surfaces (115g and 115e) each having a different tilt angle, so as to guide the reflected light to the light guide section 112.

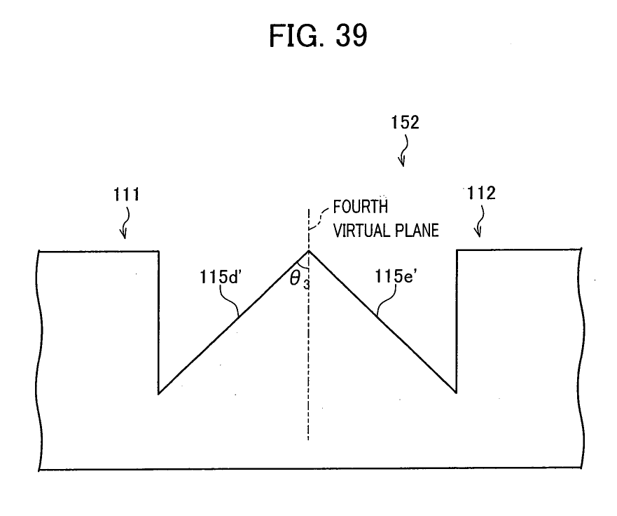

The structure has following advantages over the structure of the light guide plate 52 shown in FIG. 39. First, the structure of the light guide plate 152 will be described. FIG. 39 is a cross-sectional view of the light guide plate 152.

The light guide plate 152, as shown in the figure, has a single plane 115d′ in place of the surfaces 115d and 115f and a single plane 115e′ in place of the surfaces 115e and 115g. The surfaces 115d′ and 115f′ are tilted a predetermined angle θ3 with respect to the fourth virtual plane in mutually opposite directions as shown in the figure. In other words, the surfaces 115d′ and 115f′ are tilted the same angle with respect to the fourth virtual plane as the surfaces 115d and 115e of the light guide plate 152.

The light emitted by the LED section 103 more easily enters the light guide section 112 through a region of the surface 112c which is close to the intersecting line of the surfaces 112c and 112b in the light guide plate 102′ than in the light guide plate 152 to which the plate 102′ is compared. This is due to the greater tilt angle of the surface 115g with respect to the fourth virtual plane than that of the surface 115e′ of the light guide plate 152. The same applies to the light guide section 111.

The following will demonstrate by way of examples that the effects are actually attained.

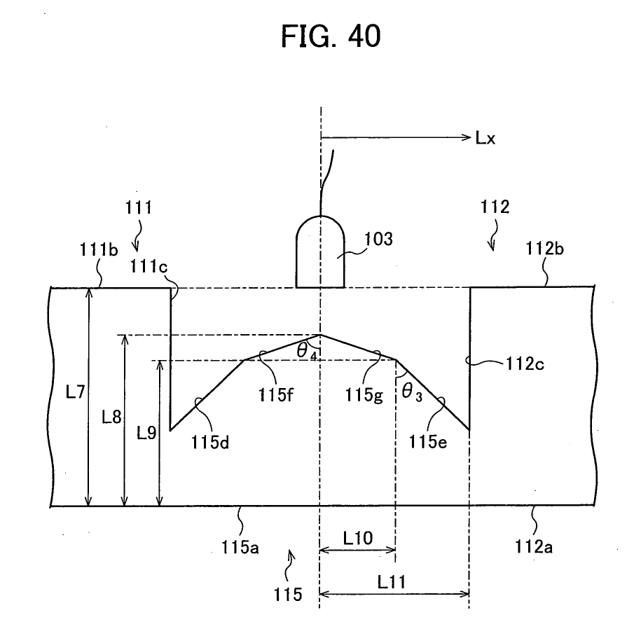

Like FIG. 38, FIG. 40 is a cross-sectional view taken along line B-B′ in FIG. 37. As shown in the figure, The distance between the surfaces 112b and 112a is labeled L7. The distance from the surface 115a to the light emitting surface of the LED section 103 is equal to L7 and so labeled. The distance from the surface 115a to the intersecting line of the surfaces 115f and 115g is labeled L8. The distance between the surfaces 115g and 115e is labeled L9. The distance from the fourth virtual plane to the surface 112c is labeled L11. Further, the positions on the surface 112b which are reached by the light entering the light guide section 112 through the surface 112c will be referred to as reached positions.

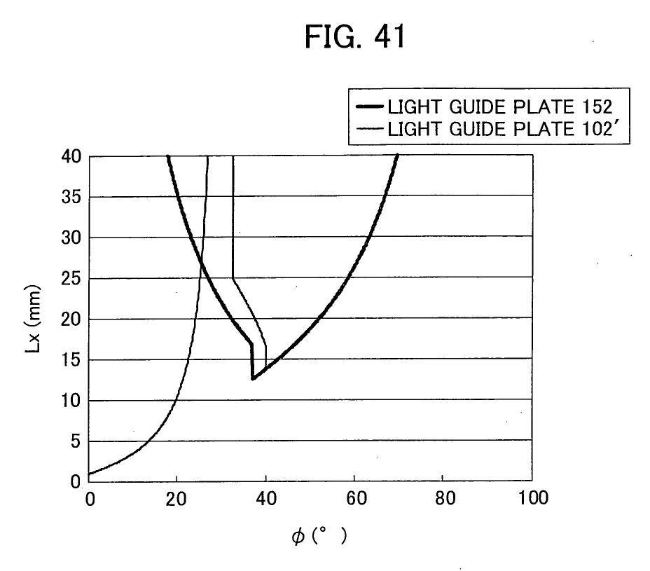

Given that in the light guide plate 102′, L7=5 mm, L8=4 mm, L9=3.4 mm, L10=1 mm, L11=3 mm, θ3=45°, and θ4=60°, FIG. 41 shows a relationship between the exit angle of light from the LED section 103 and the distance, Lx, from the reached position to the fourth virtual plane. The exit angle, equivalent to φ in embodiment 3, is again labeled φ in the figure. The figure shows a case where the refractive indices of the light guide sections 111, 112 are specified at 1.5.

As shown in the figure, in the light guide plate 102′, the light from the LED section 103 reaches a position on the surface 112b where Lx=3 mm, which indicates that the light reaches an end of the surface 112b on the side of the surface 112c. In contrast, in the light guide plate 152, as indicated in the figure, the light from the LED section 103 does not reach a part of the surface 112b beyond the position on the surface 112b at which Lx=12.5 mm toward the fourth virtual plane.

As described immediately above, the light guide plate 102′ allows the light to reach positions on the surface 112b closer to the fourth virtual plane than does the light guide plate 152. The light guide plate 102′ is capable of projecting more uniform light onto the liquid crystal panel than the light guide plate 152.

In FIG. 41, the line segment for the light guide plate 152 where φ is about 37° or greater shows Lx for the light from the LED section 103 which directly enters the light guide section 112 without reflecting from the surfaces 115e and 115g. So does the line segment for the light guide plate 102′ where φ is 40° or greater.

As described in the foregoing, the light guide plate 102′ is a structure which includes the light guide section 112 and the reflection surfaces (surfaces 115d and 115f). In the light guide section 112, the light incident from the direction from the surfaces 115d and 115f to the surface 111c (fifth direction) exits through the surface 111a as it travels down along the surface (illumination surface) 111a. The reflection surfaces turn the external light incident from the surface opposite the surface 111a into the fifth direction by one reflection so that the light enters the light guide section 111. The reflection surfaces include at least the surface (third reflection surface) 115d and the surface (fourth reflection surface) 115f tilted with respect to the surface 111a. The surface 115f is tilted less with respect to the surfaces 111a and 115a than the surface 115d, and positioned opposite the surfaces 111a and 115a with respect to the surface 115d.

With the structure, analogous to the light guide plate 102 of embodiment 3, the light guide plate 102′ is suited for use in reducing the thickness of the backlight device and increasing the illumination surface of the backlight device in area.

In the light guide plate 102′, the surface 115f is tilted less with respect to the surface 11a than the surface 115d. Further, the surface 115f is positioned opposite the surface 11a with respect to the surface 115d.

Therefore, the light turned by the reflection surfaces is incident to a surface of the light guide section 111, thus entering the section 111, at positions on that incident surface which are relatively far from the illumination surface of the light guide section 111 (that is, relatively close to the intersecting line of the surfaces 111c and 111b), when compared to the light guide plate 52 which includes only the reflection surface 115d′ having the same tilt angle as the surface 115d. For this reason, the light reflects from positions close to the surface (incident surface) 111c after entering the light guide section, 111 when compared to the light guide plate 152.

Therefore, the light guide plate 102′ outputs light at positions closer to the surfaces 115f, 115d, and 111c than the light guide plate 152. Therefore, the light guide plate 102′ projects more uniform light than the light guide plate 152.

The light guide plate 102′ is also a structure which includes the light guide section 112 and the reflection surfaces (surfaces 115e and 115g). In the light guide section 112, the light incident from the direction from the surfaces 115e and 115g to the surface 112c (fifth direction) exits through the surface 112a as it travels down along the surface (illumination surface) 112a. The reflection surfaces turn the external light incident from the surface opposite the surface 112a into the fifth direction by one reflection so that the light enter the light guide section 112. The reflection surfaces include at least the surface (third reflection surface) 115e and the surface (fourth reflection surface) 115g tilted with respect to the surface 112a. The surface 115g is tilted less with respect to the surfaces 112a and 115a than the surface 115e, and positioned opposite the surfaces 112a and 115a with respect to the surface 115e. The structure achieves the same effects as those detailed above.

In the above embodiment, as an example, the bend section 115 have been a structure which includes, on one side of the fourth virtual plane, two surfaces (for example, surfaces 115g and 115e) reflecting the light emitted by the LED section 103. This is by no means intended to be limiting the invention. The bend section 115 may be a structure which includes three or more surfaces on one side of the fourth virtual plane.

The bend section 115 has been described as being symmetric. This is by no means intended to be limiting the invention.

Further, to prevent the bend section 115 from projecting a shadow, at least one of the surfaces 115d, 115e, 115f, and 115g may be composed of a material which transmits a small amount of light: for example, a white paint. For the same purpose, if these surfaces 115d to 115g are composed of a reflective material which completely blocks light (for example, aluminum), for example, the bend section 115 preferably is a structure including at least the transmission regions M2 to let light leak into the bend section 115 as in embodiment 3.

The light guide sections 111 and 112 may be shaped, as shown in FIG. 42, to encircle the surfaces 115d to 115g of the bend section 115. In the figure, for ease of description, the light guide section corresponding to the light guide section 111 is labeled 111′, and the light guide section corresponding to the light guide section 112 is labeled 112′. The surfaces corresponding to the surfaces 111a to 111f are labeled 111a′ to 111f′ respectively.

The surface adjacent to the surfaces 111c′, 115d, and 115f are labeled 111s and 111t. The surfaces 111s and 111t are provided facing each other across the bend section 115.

When this is the case, the light emitted by the LED section 103 enters the light guide section 111 also through the surfaces 111s and 111t of the light guide section 111′ shown in the figure.

The above embodiment has described a structure as an example in which, taking the light guide section 111 as an example, either of the two surfaces 115d and 115f turns the external light emitted by the LED section. However, the present invention is by no means limited to such a two surface structure. The number of surfaces may be three or more. When this is the case, the light guide plate may be a structure which includes first to n-th reflection surfaces (none other than the reflection surfaces) (n is an integer equal to or greater than 3), tilted with respect to the surface 111a, which turn the external light. The n-th reflection surface is tilted less with respect to the surface 11a than the third reflection surface, and positioned opposite the surface 11a with respect to the third reflection surface. These settings apply also to the light guide section 122.

If a predetermined amount of light is to be guided into a particular part of the light guide plate, the light can be so guided by suitably specifying the dimensions of the light guide plate.

### Embodiment 5

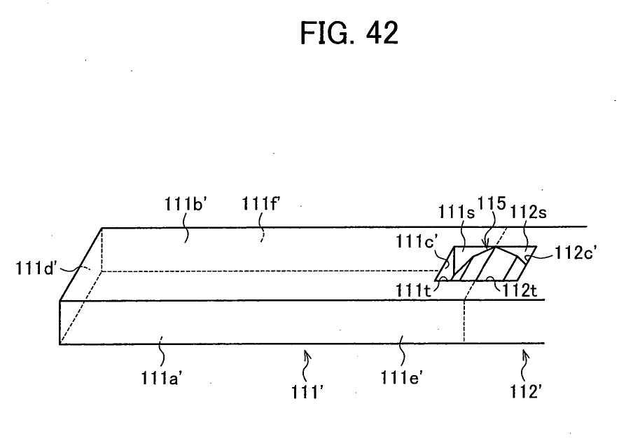

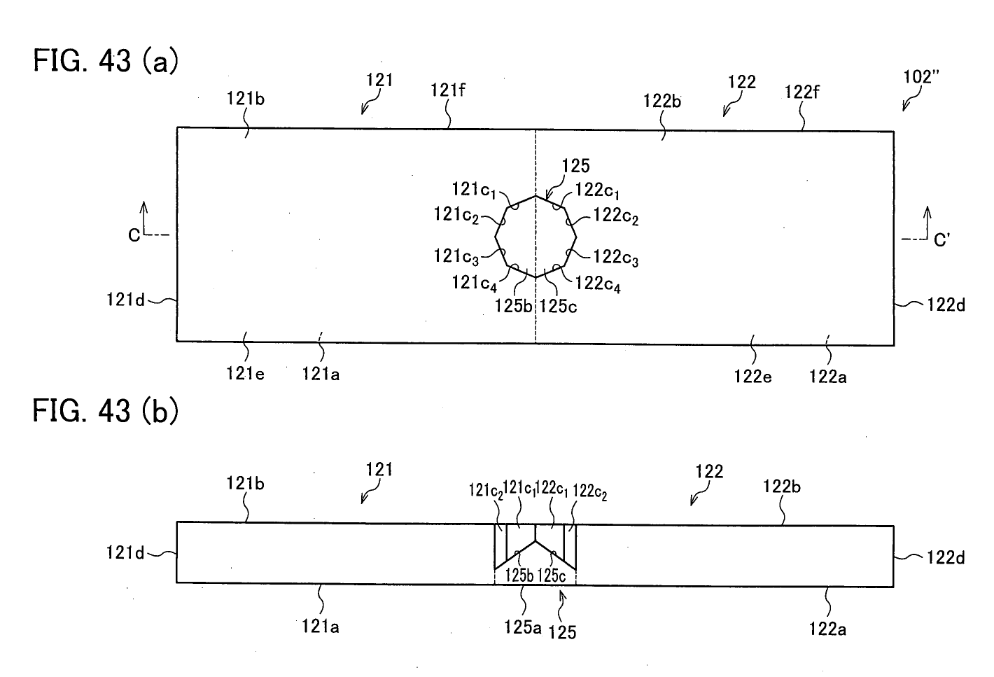

The following will describe another embodiment of the present invention in reference to FIGS. 43a to 51b. Here, for ease of description, members of the present embodiment that have the same arrangement and function as members of embodiment 4, and that are mentioned in that embodiment are indicated by the same reference numerals and description thereof is omitted.

FIG. 43a is a top view of a light guide plate 102″ in a backlight in accordance with the present invention. FIG. 43b is a cross-sectional view taken along line C-C′ in FIG. 43a. The light guide plate 102″, as shown in FIGS. 43a and 43b, includes a light guide section 121, another light guide section 122, and a bend section 125. The bend section 125 is flanked by the light guide sections 121 and 122. In the following, for ease of description, the light guide sections 121 and 122 are symmetric with respect to the bend section 125 and have the same functions.

The light guide section 121 has surfaces 121a, 121b, 121c1 to 121c4, 121d, 121e, and 121f. The surfaces 121a, 121b, 121d, 121e, and 121f have a similar structure and function to the surfaces 111a, 111b, 111d, 111e, and 111f of embodiment 4 respectively (see FIGS. 37 and 42). The light guide plate 102″ in accordance with the present embodiment has a plurality of surfaces 121c1 to 121c4 in place of the surface 111c of the light guide section 111 of embodiment 4.

The light guide section 122 has surfaces 122a, 122b, 122c1 to 122c4, 122d, 122e, and 122f which are located analogous to the light guide section 121. The surfaces 121c1 to 121c4 and 122c1 to 122c4 are the incident surfaces recited in claims.

The surfaces 121a and 122a are the illumination surfaces recited in claims.

The bend section 125 has surfaces 125a to 125c as shown in FIGS. 43a and 43b. The surface 125a faces a liquid crystal panel. The surface 121a of the light guide section 121, the surface 125a of the bend section 125, and the surface 122a of the light guide section 122 form a single plane (“LC-facing plane”). The surface (reflection surface) 125b faces an LED section 103 and is adjacent to the surfaces 121c1 to 121c4 of the light guide section 121. The surface (reflection surface) 125c faces the LED section 103 and is adjacent to the surfaces 122c1 to 122c4 of the light guide section 122. The surfaces 125b and 125c have the same shape. The surfaces 125b and 125c are composed of a light-reflecting material (for example, aluminum).

Assuming a fifth virtual plane which includes the intersecting line of the surfaces 125b and 125c and is perpendicular to the surface 125a, the surfaces 125b and 125c are tilted the same angle from the fifth virtual plane in mutually opposite directions.

In the light guide plate 102″, the surfaces 121c1 to 121c4 and 122c1 to 122c4 each make an angle greater than 90° with adjacent surfaces thereof.

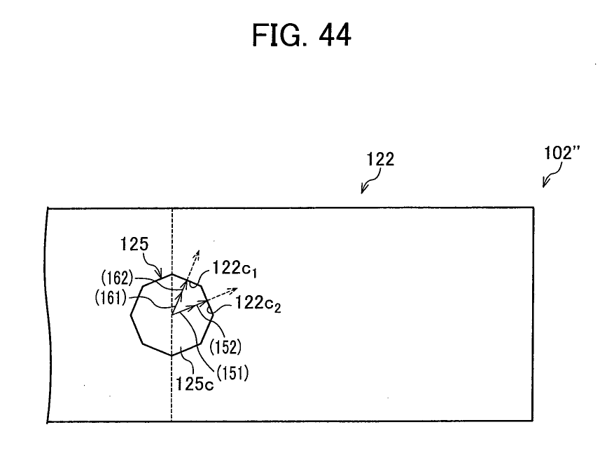

Next, optical paths when the LED section 103 is lit will be described in reference to FIG. 44. Since the light guide plate 102″ is symmetric with respect to the fifth virtual plane, the following description will focus on optical paths in the light guide section 122.

As shown in the figure, some part of the light emitted by the LED section 103 propagates along optical path (151) shown in the figure and reflects from the surface 125c. The reflection from the surface 125c assumes optical path (152) in the figure, passing through the surface 122c2 and entering the light guide section 122. Other part of the light emitted by the LED section 3 assumes optical path (161) shown in the figure and reflects from the surface 125c. The reflection from the surface 125c assumes optical path (162) in the figure, passing through the surface 122c1 and entering the light guide section 122.

As described immediately above, the light guide plate 102″ is a structure which reflects different beams of light emitted by the LED section 103 by means of the same reflection surfaces and directs through different surfaces (surfaces 122c1 and 122c2) so that both beams enter the light guide section 122.

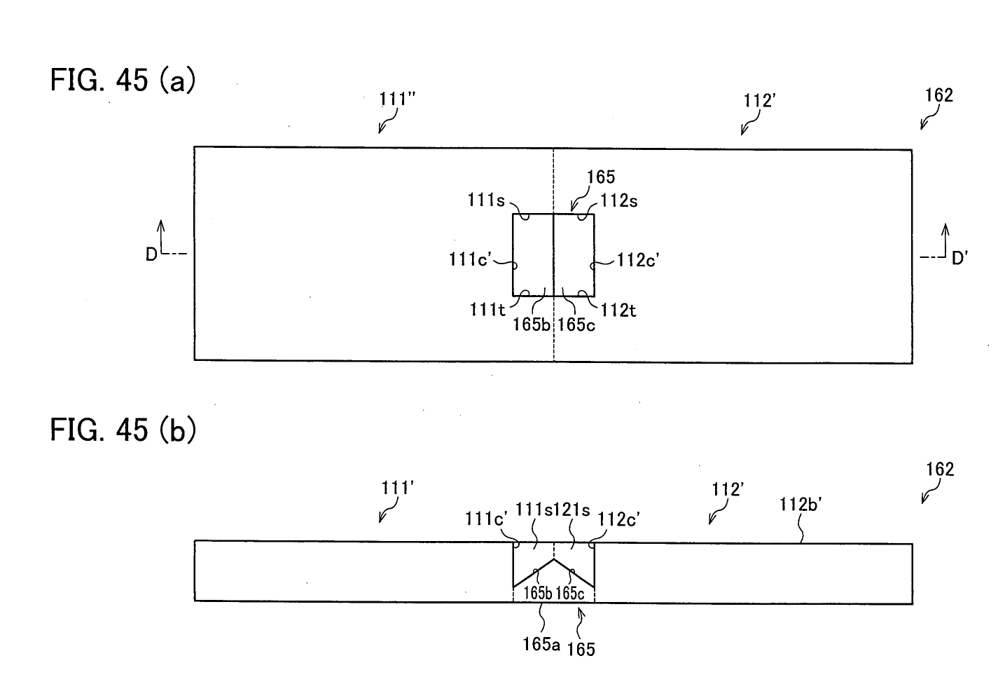

The structure has following advantages over the structure of a light guide plate 162 which includes a bend section 165 shown in FIGS. 45a and 45b, in place of the bend section 125. First, the structure of the light guide plate 162 will be described.

FIG. 45a is a top view of the light guide plate 162. The light guide plate 162 has the same structure as the light guide plate in FIG. 42 except for the bend section's structure. Now, the bend section 165, especially its differences in structure, will be described.

The bend section 165, as shown in FIG. 45a FIG. 45b, has surfaces 165a to 165c. The surface 165a faces the liquid crystal panel. The surface 165b faces the LED section 103 and is adjacent to the surfaces 111c′, 111s, and 111t of the light guide section 111′. The surface 113e faces the LED section 103 and is adjacent to the surfaces 112c′, 112s, and 112t of the light guide section 112′.

The surfaces 165b and 165c are adjacent to each other and has an intersecting line parallel to the surface 111c′ of the light guide section 111′ and the surface 112c′ of the light guide section 112′. The surfaces 165b and 165c have the same shape. Assuming a sixth virtual plane which includes the intersecting line and is perpendicular to the surface 165a, the surfaces 165b and 165c are tilted a predetermined angle with respect to the sixth virtual plane in opposite directions.

The surface 111c′ makes right angles with the surfaces 111s and 111t. The surface 112c′ makes right angles with the surfaces 112s and 112t.

The following will demonstrate by way of examples that the effects are actually attained.

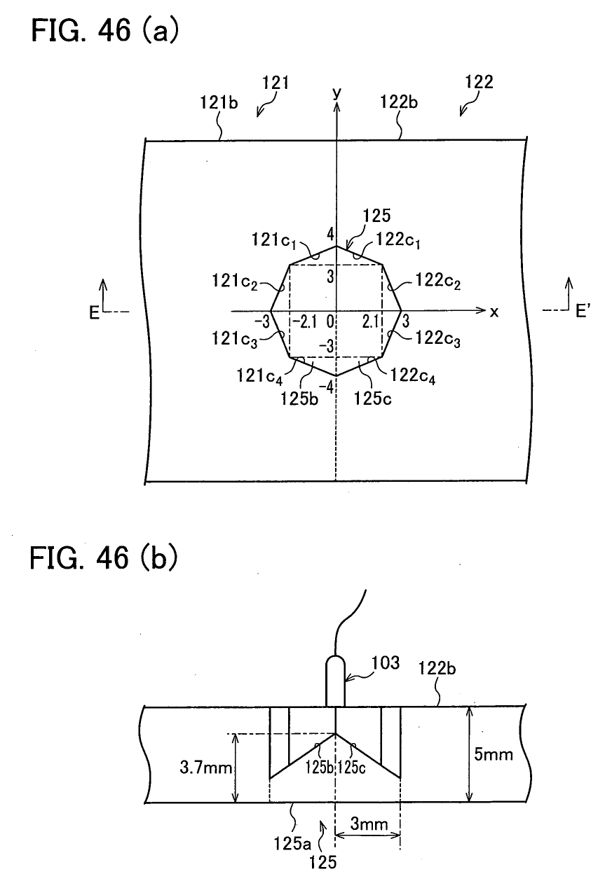

FIG. 46a is a top view of the light guide plate 102″, illustrating the coordinates of the sides of the surfaces 121c1 to 121c4 and 122c1 to 122c4 that are perpendicular to the surface 125a with the center of the surface 125a of the bend section 125 as the origin. FIG. 46b is a cross-sectional view taken along line E-E′ in FIG. 46a.

As shown in FIG. 46a, the coordinates of the intersecting line (side) of the surfaces 122c1 and 122c2 is (x, y)=(2.1, 3). The coordinates of the intersecting line of the surfaces 122c1 and 121c1 is (x, y)=(0, 4). The coordinates of the intersecting line of the surfaces 122c2 and 122c3 is (x, y)=(3, 0). The coordinates of the intersecting line (side) of the surfaces 122c3 and 122c4 is (x, y)=(2.1, −3). The coordinates of the intersecting line of the surfaces 121c4 and 122c4 is (x, y)=(0, −4). The coordinates are all given in millimeters.

As shown in FIG. 46b, the surface 125a is separated from the intersecting line of the surfaces 125b and 125c by a distance of 3.7 mm. The surface 125a is separated from the light emitting surface of the LED section 103 and from the surfaces 125a and 122b by equal distances of 5 mm.

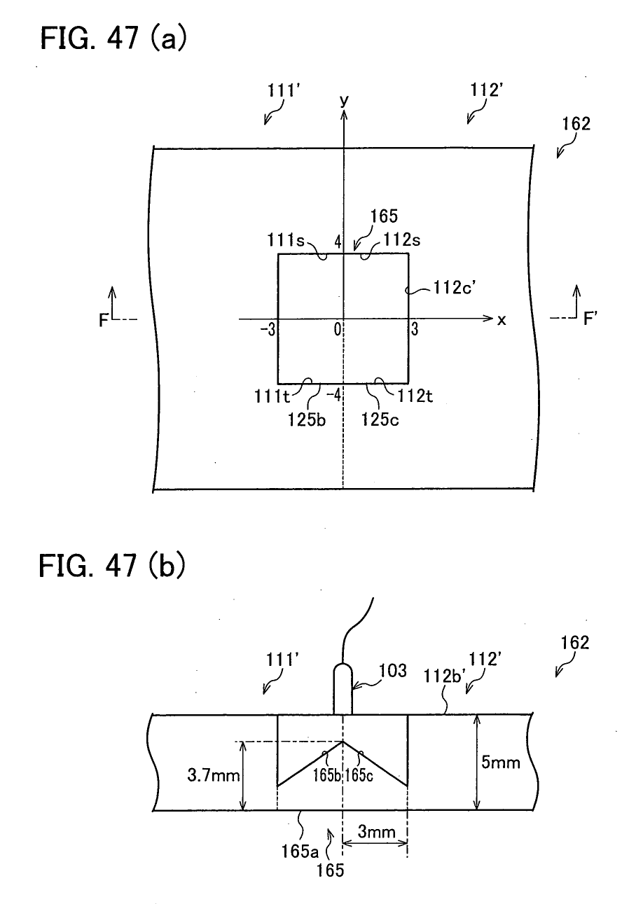

FIG. 47a is a top view of the light guide plate 162, illustrating the coordinates of the sides of the surfaces 112s, 112t, and 112c′ that are perpendicular to the surface 165a with the center of the surface 165a of the bend section 165 as the origin. FIG. 47b is a cross-sectional view taken along line F-F′ in FIG. 47a.

As shown in FIG. 47a, the coordinates of the intersecting line (side) of the surfaces 112s and 112c′ is (x, y)=(3, 4). The coordinates of the intersecting line of the surfaces 112s and 111s is (x, y)=(0, 4). The coordinates of the intersecting line of the surfaces 112t and 112c′ is (x, y)=(3, −4). The coordinates of the intersecting line of the surfaces 112t and 111t is (x, y)=(0, −4).

As shown in FIG. 47b, the surfaces 165a is separated from the intersecting line of the surfaces 165b and 165c by a distance of 3.7 mm. The surface 165a is separated from the light emitting surface of the LED section 3 and from the surfaces 165a and 112b′ by equal distances of 5 mm.

Assume, for the light guide plate 102″, a seventh virtual plane which includes the optical paths taken by a light beam emitted by the LED section 103 to reach the surface 125c and which is perpendicular to the surface 125a. Also, assume an eighth virtual plane which includes the x axis and is perpendicular to the surface 125a. Let β represent the angle (variable) between the seventh and eighth virtual planes.

Assume also a seventh virtual plane which includes the optical paths taken by the reflection from the surface 125c before hitting the surface 122c1 or 122c2 and entering the light guide section 122 and which is perpendicular to the surface 125a. Let γ represent the angle (variable) between the seventh and eighth virtual planes.

Another set of β and γ is similarly defined for the light guide section 162.

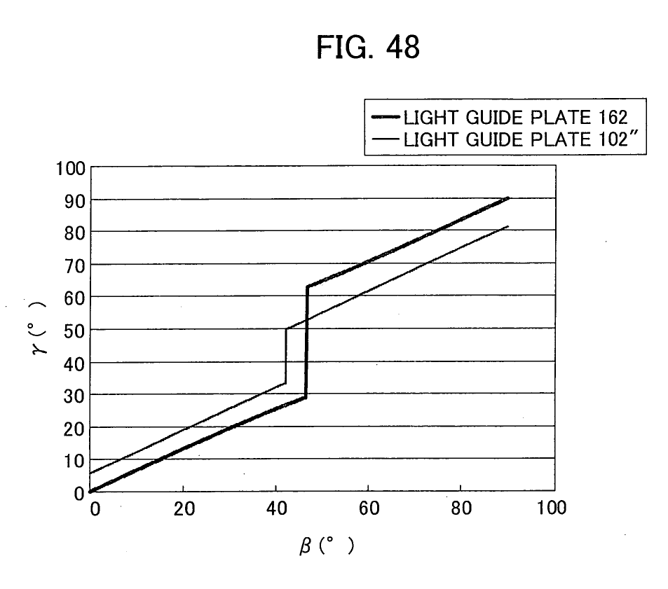

FIG. 48 is a graph representing the relationship between β and γ for the light guide plates 102″ and 162 having the foregoing dimensions. The figure shows a case where the refractive indices of the light guide sections 121, 122 are specified at 1.5. As shown in the figure, the light guide plate 102″ has a smaller y value than the light guide plate 162 at β in excess of about 47°. Therefore, the light guide plate 102″ is capable of guiding a greater amount of light in the x-axis direction than the light guide plate 162.

By determining appropriate dimensions and/or positions for the surfaces 121c1 to 121c4 and 122c1 to 122c4 of the light guide plate 102″, one can direct desired amounts of light to desired parts of the light guide sections (121, 122) of the light guide plate 102″.

As described in the foregoing, the light guide plate 102″ is a structure which includes the light guide section 121 and the surface (reflection surface) 125b. The section 121 guides the light incident for the direction from the surface 125b toward the surfaces 121c1 to 121c4 (fifth direction) so that the light exits through the surface 121a as it travels down along the surface (illumination surface) 121a. The surface 125b turns the external light incident to the surface opposite the surface 121a into the fifth direction by one reflection so that the light enters the light guide section 121. The light guide section 121 has the surfaces (plurality of continuous incident surfaces) 121c1 to 121c4 which guide the external light turned by the surface 125b so that the light enters the light guide section 121. Of the surfaces 121c1 to 121c4, every pair of adjacent ones makes an angle greater than 90° between the paired surfaces.

With the structure, analogous to the light guide plate 102 of embodiment 3 and the light guide plate 102′ of embodiment 4, the light guide plate 102″ is suited for use in reducing the thickness of the backlight device and increasing the illumination surface of the backlight device in area.

The light guide section 121 has the surfaces 121c1 to 121c4 which guide the external light turned by the surface 125b so that the light enters the light guide section 121. Therefore, the light turned by the surface 125b is guided any one of the surfaces 121c1 to 121c4 to enter the light guide section 121. Further, with the light guide plate 102″, those of the surfaces 121c1 to 121c4 which are adjacent to each other make an angle greater than 90°. The light guide plate 102″ therefore guides an increased amount of external light to positions farther away from the surfaces 121c1 to 121c4 (closer to the surface 121d) in the light guide section 121, when compared to light guide plates in which every pair of adjacent surfaces makes a right angle.

Therefore, to project a fixed amount of light through the surface 121a, the light guide section 121 can be longer in the fifth direction than light guide plates in which every pair of adjacent surfaces makes a right angle.

The light guide plate 102″ is a structure which includes the light guide section 122 and the surface (reflection surface) 125c. The section 122 guides the light incident from the direction from the surface 125c toward the surfaces 122c1 to 122c4 (fifth direction) so that the light exits through the surface (illumination surface) 122a as it travels down along the surface 122a. The surface 125c turns the external light incident to the surface opposite the surface 122a into the fifth direction by one reflection so that the light enters the light guide section 122. The light guide section 122 has the surfaces (plurality of continuous incident surfaces) 122c1 to 122c4 which guide the external light turned by the surface 125c so that the light enters the light guide section 122. Of the surfaces 122c1 to 122c4, every pair of adjacent ones makes an angle greater than 90° between the paired surfaces. The structure achieves the same effects as those detailed above.

The above embodiment described a structure in which the light turned by the surface 125b is incident to either of the four surfaces 121c1 to 121c4 as an example. The present invention is by no means limited to a structure with such four surfaces. The number of surfaces with such functions is not limited in any particular manner, provided that the number is more than or equal to two. The same applies to the light guide section 122.

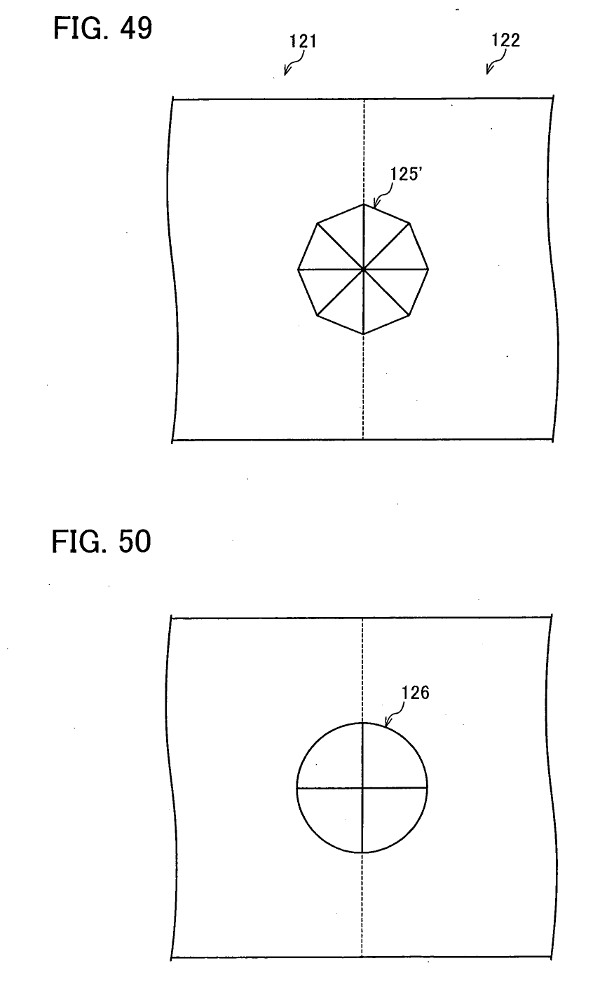

The light guide plate 102″ may be a structure shown in FIG. 49. The light guide plate shown in FIG. 49 is a variation of the light guide plate 102″ where the surfaces 125b and 125c are each divided into four planes (reflection surfaces). Each plane is a triangle with one of the vertices, or the apex, being common with the other planes. The present invention is by no means limited to such four planes. It is sufficient if the surfaces 125b and 125c are each composed of two or more planes. Incidentally, in the figure, the bend section including these planes is denoted by 125′.

The light guide plate 102″ may be a structure shown in FIG. 50. The light guide plate shown in FIG. 50 has curved surfaces (in the example shown, the surfaces are shaped like a ring) in place of the surfaces 121c1 to 121c4 and 122c1 to 122c4 which act as incident surfaces after the light is turned. The light guide plate shown in the figure is a variation of the light guide plate 102″ where the surfaces 125b and 125c are each divided into two planes (reflection surfaces). Each plane is a sector of a circle with one of the vertices, or the apex, being common with the other planes. The present invention is by no means limited to such two planes. It is sufficient if the surfaces 125b and 125c are each composed of two or more planes. Incidentally, in the figure, the bend section including these planes is denoted by 126.

As described in the foregoing, the light guide plates shown in FIGS. 49 and 50 may be said to be a structure which includes a light guide section and a reflection surface. The light guide section guides the light incident from the fifth direction along an illumination surface (surface 121a in the example of FIG. 49) so that the light can exit through the illumination surface. The reflection surface turns the external light incident to a surface opposite the illumination surface into the fifth direction by one reflection so that the light enters the light guide section. The reflection surface is constituted by a plurality of continuous planes. The intersecting lines of those of the planes which are adjacent to each other tilt with respect to the illumination surface. The planes each have a normal thereof pointing in a different direction from the others.

With the structure, analogous to the light guide plate 102 of embodiment 3, the light guide plate 102′ of embodiment 4, and the light guide plate 102″, the light guide plate is again suited for use in reducing the thickness of the backlight device and increasing the illumination surface of the backlight device in area.

The reflection surface is constituted by a plurality of continuous planes. Further, the intersecting lines of those of the planes which are adjacent to each other is tilted with respect to the illumination surface. Therefore, after turning the external light by means of one of the planes, the light is directed to enter the light guide section. In addition, the planes each have a normal thereof pointing in a different direction from the others. Therefore, the light guide plates shown in FIGS. 49 and 50 direct the light turned by the reflection surface so that more uniform and radially traveling light enters the light guide section, than do light guide plates where not all normals of the planes point in different directions.

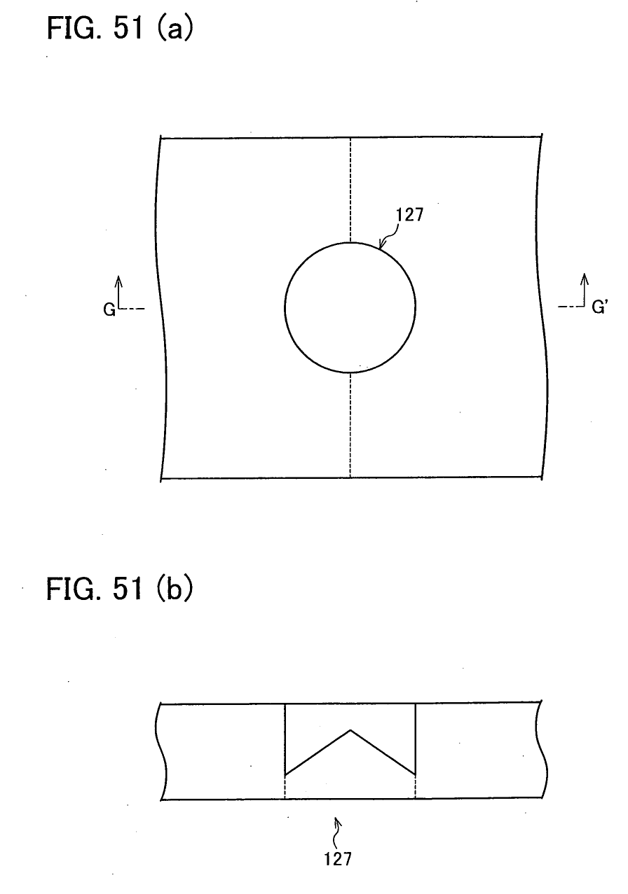

The light guide plate 102″ may be a structure shown in FIGS. 51a and 51b. FIG. 51b is a cross-sectional view taken along line G-G′ in FIG. 51a. The light guide plate shown in FIGS. 51a and 51b has a bend section of a different shape from that of the light guide plate shown in FIG. 50. The light guide plate shown in FIGS. 51a and 51b is shaped so that the surface (reflection surface) turning the light emitted by the LED section is at least partly composed of the curved surface of a circular cone. The structure achieves similar effects to those achieved by the light guide plates shown in FIGS. 49 and 50.

### Embodiment 6

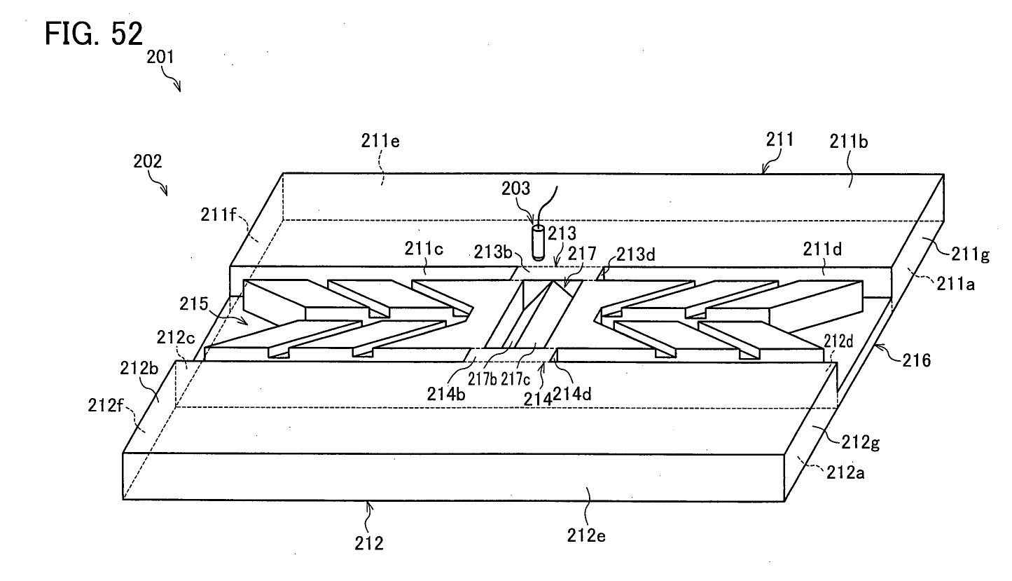

The following will describe another embodiment of the present invention in reference to FIGS. 52 to 65.

FIG. 52 is a schematic, structural perspective view of a backlight in accordance with the present invention. As shown in the figure, a backlight (lighting device) 201 includes a light guide plate 202 and an LED section (light emitting elements) 203.

The light guide plate 202 may be manufactured as a single unit from one transparent substrate by, for example, processing and subsequently surface-treating it. In the following, the light guide plate 202 is divided into several parts for ease of description of its structure.

The light guide plate 202, as shown in the figure, includes a light guide section (ninth light guide section) 211, another light guide section (tenth light guide section) 212, a further light guide section 213, still another light guide section 214, yet another light guide section (other light guide section, seventh light guide section) 215, a further light guide section (other light guide section, eighth light guide section) 216, and a bend section 217.

The bend section 217 is flanked by the light guide sections 213 and 214. The bend section 217 is also flanked by the light guide sections 215 and 216.

In the following, assume that the light guide sections 211 and 212 are symmetric with respect to the bend section 217 and the light guide sections 215 and 216 and also that the light guide sections 213 and 214 are symmetric with respect to the bend section 217. Assume further that the light guide sections 215 and 216 are symmetric with respect to the bend section 217.

The light guide sections 211 and 212 are composed of the same material. The light guide sections 213 and 214 are composed of the same material. The light guide sections 215 and 216 are again composed of the same material.

For these reason, the following description will focus on the bend section 217 and the light guide sections 211, 213, and 215. The description of the light guide sections 212, 214, and 216 will be mostly omitted.

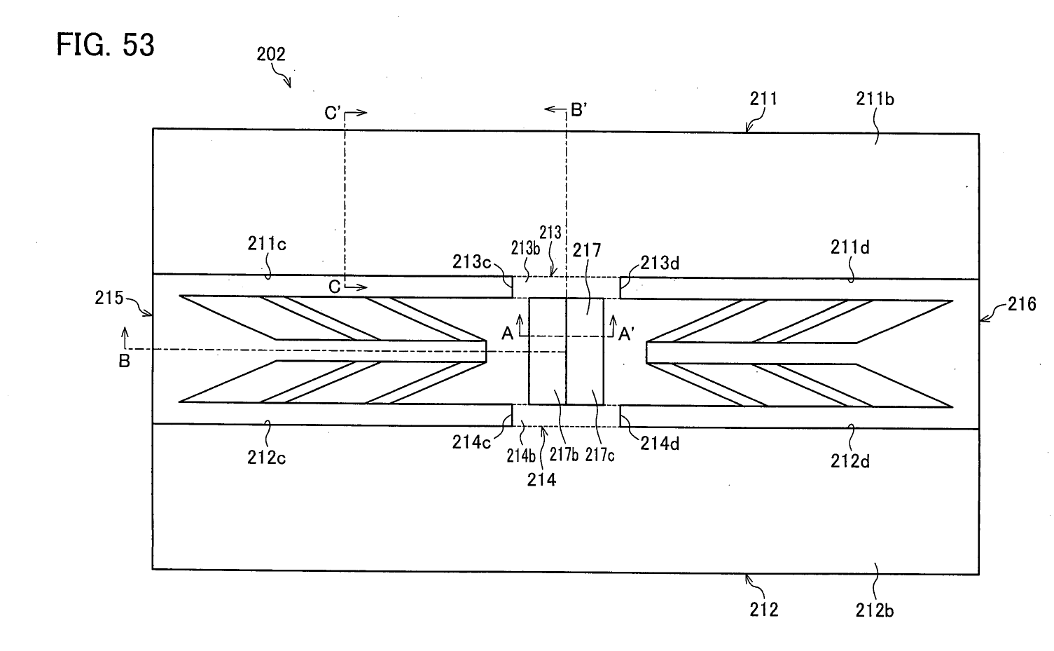

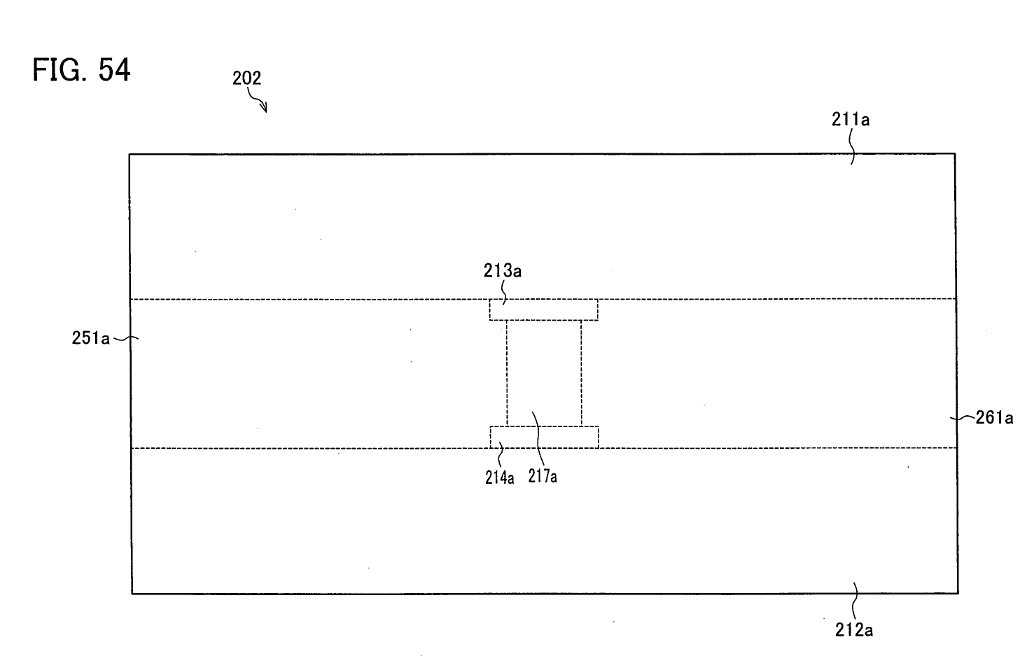

FIG. 53 is a top view of the light guide plate 202. FIG. 54 is a bottom view of the light guide plate 202. For ease of description, the “top” surface refers to the surface of the light guide plate 202 facing an LED section 203, and the “bottom” surface refers to the surface of the light guide plate 202 facing liquid crystal.

The light guide section 211 is of the shape of a rectangular parallelepiped as shown in FIG. 52. The light guide section 211 has surfaces 211a to 211g as shown in FIGS. 52 to 54. The surface (predetermined surface) 211a faces the liquid crystal panel. The surface 211b faces the LED section 3. The surface 211c faces the light guide section 215. The surface 211d faces the light guide section 216. The surfaces 211c and 211d are adjacent to the light guide section 213. The surface 211e is opposite the surfaces 211c and 211d. The remaining surfaces 211f and 211g are on the light guide section 215 and on the light guide section 216 respectively.

The light guide section 212, as shown in FIGS. 52 to 54, has surfaces 212a to 212g which are located analogous to the light guide section 211. The surfaces (212a to 212g) correspond to the surfaces (211a to 211g) of the light guide section 211 respectively. The surface 212a, like the surface 211a, is the predetermined surface recited in claims.

The light guide sections 211 and 212 are composed at least internally of a material capable of guiding light: for example, a transparent acrylic material or a glass material. The surface 211b of the light guide section 211 and the surface 212b of the light guide section 212 have a predetermined light scattering pattern. An example of the pattern is shown in FIG. 77.

The pattern is by no means limited to this example; any of various, publicly known patterns may be used. The pattern only needs to have geometry which grows in size with the distance from the surfaces 211c and 211d and the surfaces 212c and 212d. In the following, the geometry will be referred to as the light scattering sections. The rest of the surface 211b and 212b (i.e., excluding the light scattering sections) will be referred to as the non-scattering region.

The light guide section 213 is of the shape of a rectangular parallelepiped as shown in FIG. 52. The light guide section 213 has surface 213a to 213d as shown in FIGS. 52 to 54. The surface 213a faces the liquid crystal panel. The surface 213b faces the LED section 3. The surface 213c is adjacent to the surface 211c and the light guide section 215. The surface 213d is adjacent to the surface 211d and the light guide section 216.

The light guide section 214, as shown in FIGS. 52 to 54, has surfaces 214a to 214d which are located analogous to the light guide section 213. The surfaces (214a to 214d) correspond to the surfaces (213a to 213d) of the light guide section 213 respectively.

The light guide sections 213 and 214, like the light guide sections 211 and 212, are composed of a material capable of guiding light: for example, a transparent acrylic material or a glass material.

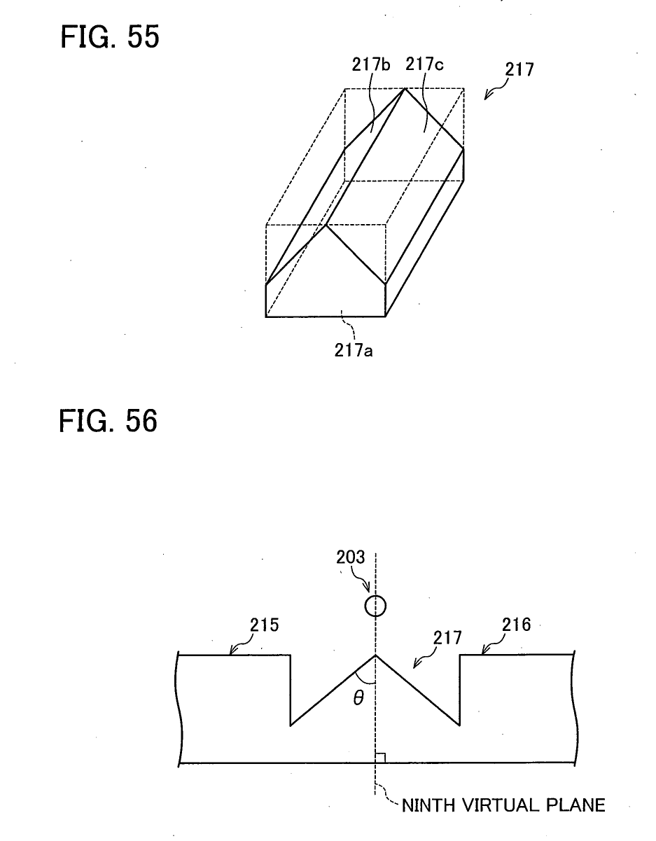

The bend section 217 includes surfaces 217a to 217c as shown in FIG. 55. The surface 217a faces the liquid crystal panel. The surface (first reflection surface for the bend section) 217b faces the LED section 203 and is adjacent to the light guide section 215. The surface (second reflection surface for the bend section) 217c faces the LED section 203 and is adjacent to the light guide section 216.

The surfaces 217b and 217c are adjacent to each other and have an intersecting line parallel to the surfaces 252k and 253k of the light guide section 215 (detailed later). The surfaces 217b has the same shape as the surface 217c. Further, assuming a ninth virtual plane which includes the intersecting line and is perpendicular to the surface 217a, the surfaces 217b and 217c are tilted a predetermined angle θ from the ninth virtual plane in opposite directions as shown in FIG. 56.

The surfaces 217b and 217c of the bend section 217 are composed of a light-reflecting material (for example, aluminum). To prevent the bend section 217 from projecting a shadow, the surfaces 217b and 217c are composed of a material which transmits a small amount of light: for example, a white paint. If the surfaces 217b and 217c are composed of a reflective material which completely blocks light (for example, aluminum), the bend section 217 preferably has a structure allowing light to leak out from some parts of the bend section 217.

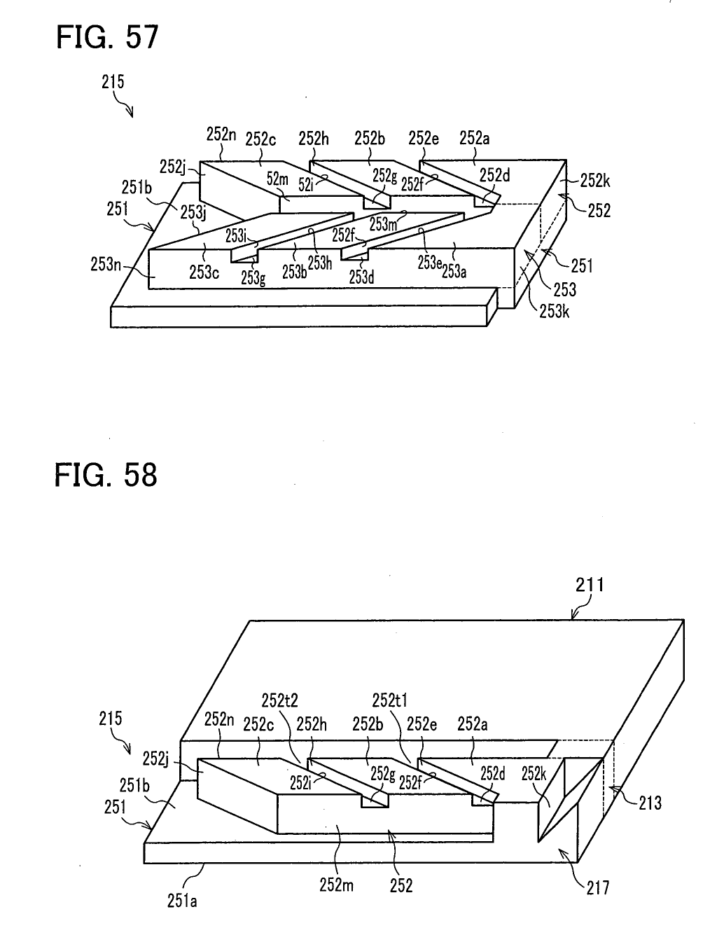

FIG. 57 is a perspective view of the light guide section 215. FIG. 58 is a cross-sectional view taken along line B-B′ in FIG. 53. The light guide section 215 includes a third member 251, a fourth member 252, and a fifth member 253 as shown in FIG. 57.

The third member 251 has a plate shape (having convex sections in some parts thereof, to be more specific) as shown in FIGS. 57 and 58. The third member 251 has surfaces 251a and 251b. The surface 251a faces the liquid crystal panel. The surface 251b faces the LED section 203.

The fourth and fifth members 252 and 253 are disposed on the third member 251. To be more specific, the members 252 and 253 are provided on a plane including the surface 252b. The fourth and fifth members 252 and 253 are symmetric with respect to a surface perpendicular to the ninth virtual plane and includes the center of the surface 217b (“tenth virtual plane”).

As shown in FIG. 58, the fourth member 252 has surfaces 252a to 252c parallel to the surface 251a and facing the LED section 203. Also, the fourth member 252 has groove sections 252t1 and 252t2 facing the LED section 203 in this order when viewed from the bend section 217.

The groove sections 252t1 and 252t2 are formed linear and parallel to each other. The groove sections 252t1 and 252t2 are tilted a predetermined angle from the ninth virtual plane. The tilt angle is specified so that the light guided in the fourth member 252 undergoes sufficiently total reflection from surfaces 252e and 252h (detailed later).

Further, each groove section 252t1 and 252t2 has a square U cross-section perpendicular to the extension of the groove section. Further, as to groove depth, the groove section 252t2 is formed deeper than the groove section 252t1. As to groove length (measured along the extension), the groove sections 252t1 and 252t2 are identical.

The formation of the groove section 252t1 provides a face of the fourth member 252 facing the LED section 203 with a surface 252d which is one of walls constituting the groove section 252t1 parallel to the surface 251a. Also, the formation of the groove section 252t1 provides the fourth member 252 with a surface (reflection surface) 252e and a surface 252f, in this order when viewed from the bend section 217, which are walls constituting the groove section 252t1 perpendicular to the surface 251a.

The formation of the groove section 252t2 provides a face of the fourth member 252 facing the LED section 203 with a surface 252g which is one of walls constituting the groove section 252t2 parallel to surface 251a. The formation of the groove section 252t2 provides the fourth member 252 with a surface (reflection surface) 252h and a surface 252i, in this order when viewed from the bend section 217, which are walls constituting the groove section 252t2 perpendicular to the surface 251a.

A surface (reflection surface) 252j which is an end face of the fourth member 252 opposite the bend section 217 is parallel to the surfaces 252e, 252f, 252h, and 252i. The surface 252j is rectangular and has a side perpendicular to the surface 251b whose length is greater than the depth of the groove section 252t2. Also, the surface 252j has a side parallel to the surface 251b whose length is equal to the length of the groove sections 252t1 and 252t2.

As described in the foregoing, at least the surfaces 252e, 252h, and 252j are parallel to each other. The sides of these surfaces perpendicular to the surface 211a grow longer with the distance from the bend section 217. In addition, the sides of the surfaces 252e, 252h, and 252j parallel to the surface 211a have the same length. As a result, the areas of the surfaces 252e, 252h, and 252j grow larger with the distance from the bend section 217.

The fourth member 252 has a surface 252k parallel to the ninth virtual plane and adjacent to the surface 217b of the bend section 217. The fourth member has a surface 252m facing the fifth member and a surface 252n facing the light guide section 211.

Again, the fifth member 253, as shown in FIG. 57, has surfaces 253a to 253k, 253m, and 253n which are located analogous to the fourth member 252. The surfaces (253a to 253k, 253m, 253n) correspond to the surfaces (252a to 252k, 252m, 252n) of the fourth member 252 respectively. The surfaces 253e, 253h, and 253j are the reflection surface recited in claims.

The members 251 to 253 of the light guide section 215 may be composed of the same material as the interior of the light guide sections 211 and 212.

The light guide sections 216 and 215 are symmetric with respect to the ninth virtual plane. In the following, the surface of the light guide section 216 (the surface facing the liquid crystal panel) which corresponds to the surface 251a of the light guide section 215 will be referred to as the surface 261a.

The surfaces 211a, 212a, 213a, 214a, 251a, 261a and 217a form a single plane (“LC-facing plane”). The LC-facing plane is rectangular.

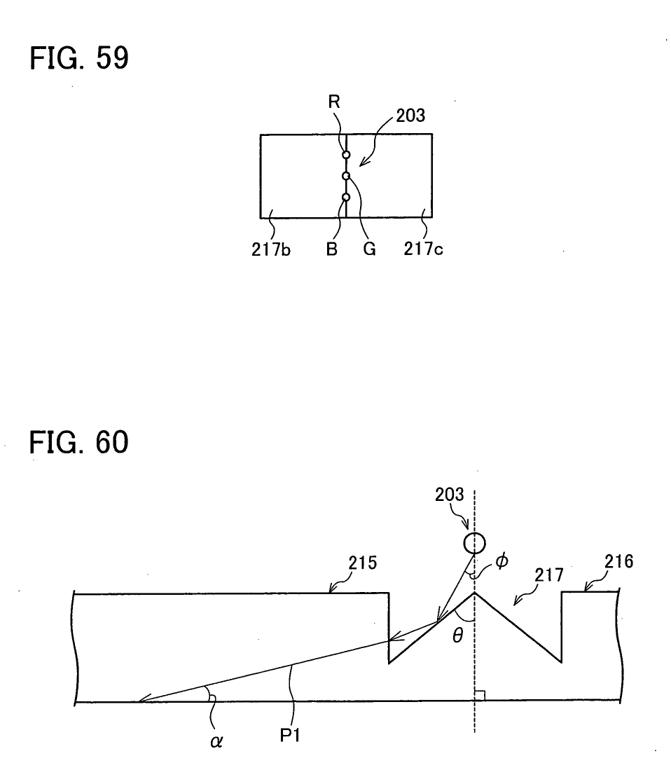

The LED section 203 includes three light emitting diodes (“LED”): a red (R) light emitting diode (“red LED”), a green (G) light emitting diode (“green LED”), and a blue (B) light emitting diode (“blue LED”). The structure enables generation of white light (external light). As shown in FIG. 59, each LED has a light emitting surface in the ninth virtual plane with that plane equally dividing the light emitting surface. The LEDs are the light emitting elements recited in claims.

Next, optical paths when the LED section 203 is lit will be described in reference to FIGS. 60 through 63b. Since the light guide plate 202 is symmetric with respect to the ninth virtual plane, the following description will focus on optical paths in the light guide section 215. Further, since the light guide section 215 is symmetric with respect to the tenth virtual plane, the following description will focus on optical paths in a half of the light guide section 215 with respect to the tenth virtual plane, the half including the fourth member 252. The optical paths below are however a mere example; they are by no means intended to be limiting the invention.

As shown in FIG. 60, light leaves the LED section 3 at a predetermined angle φ with respect to the ninth virtual plane and reflects from the surface 217b of the bend section 217. The reflection passes through the surface 252k and enters the fourth member 252 of the light guide section 215. Upon entering the fourth member 252, the light is refracted by the surface 252k. Some of the light emitted by the LED section 203 is directly incident to the surface 252k, entering the fourth member 252 of the light guide section 215, without being reflected from the surface 217b.

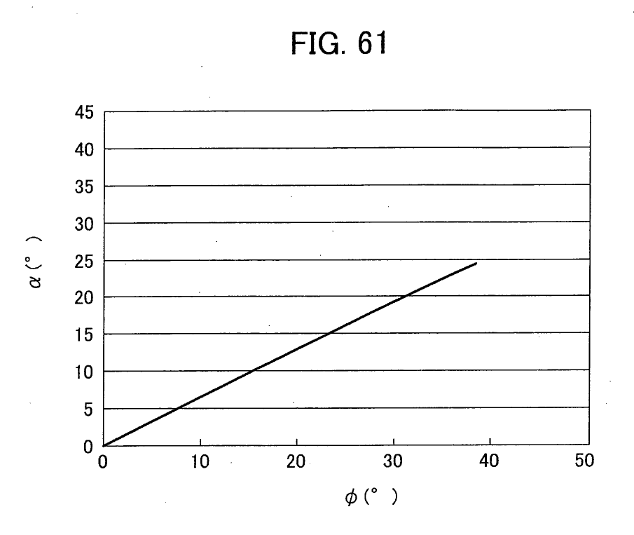

FIG. 61 is a representation of a relationship between the angle φ and an angle α (“fifth angle”). α is the angle of the optical path (P1 in FIG. 60) of light immediately after incident to the surfaces 252k and 253k (that is, after being refracted by the surfaces 252k and 253k) with respect to the LC-facing plane. The figure assumes that θ is 45′. When the light guide section 215 is composed internally of an acrylic material of a refractive index of 1.5, light does not undergo total reflection from the surfaces (interface) 251a and 252a of the light guide section 215 if the fifth angle is in excess of about 48°. However, with this composition and structure, total reflection takes place on the surfaces 251a and 252a of the light guide section 215 even when φ takes a maximum value (here, about 38°) as indicated in FIG. 61. In addition, as mentioned above, the value of α changes with that of φ.

Now, the light entering the fourth member 252 as above will be described.

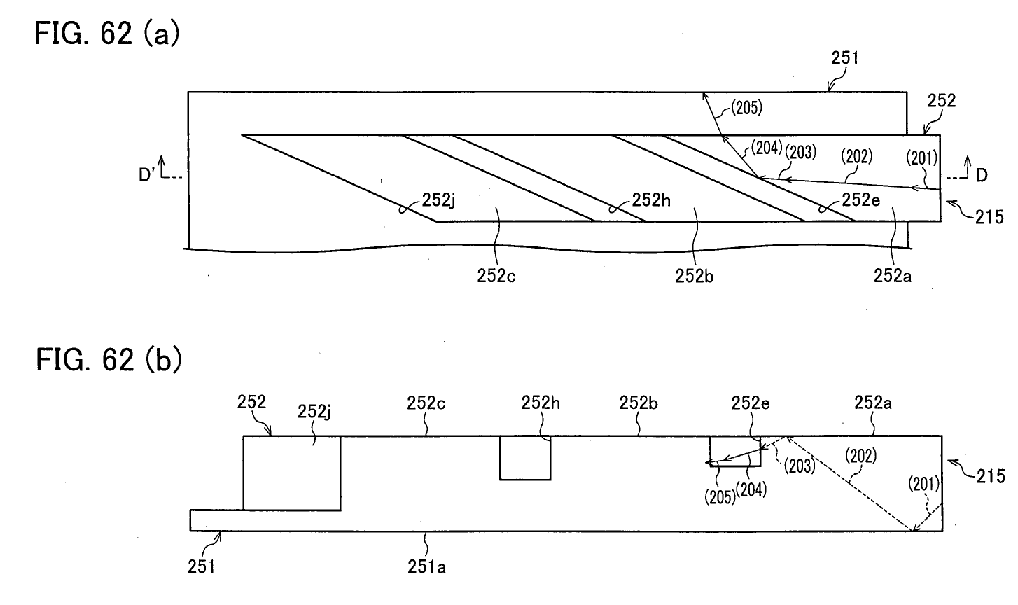

Light incident to the fourth member 252 (“fourth light”) assumes optical path (201) shown in FIGS. 62(a) and 62(b) and undergoes total reflection from the surface 251a. The total reflection from the surface 51a takes optical path (202) in the figures and undergoes total reflection from the surface 252a. The total reflection from the surface 252a assumes optical path (203) in the figures and undergoes total reflection from the surface 252e. The total reflection from the surface 252e assumes optical path (204) shown in the figures to reach the surface 252n. Having reached the surface 252n, the light takes optical path (205) in the figures, passing through the surface 211c of the light guide section 211, and enters the light guide section 211.

The foregoing description gave an example of light which undergoes total reflection from the surface 252e. The light underwent total reflection from the surfaces 251a and 252a before the total reflection from the surface 252e. The light which undergoes total reflection from the surface 252e is by no means limited to the fourth light. For example, the light may reflect from either the surface 251a or 252a. Alternatively, the light may reflect from neither the surface 251a nor 252a, thereby directly reaching the surface 252e. Further, the light may undergo total reflection from the surface 252n before reaching the surface 252e.

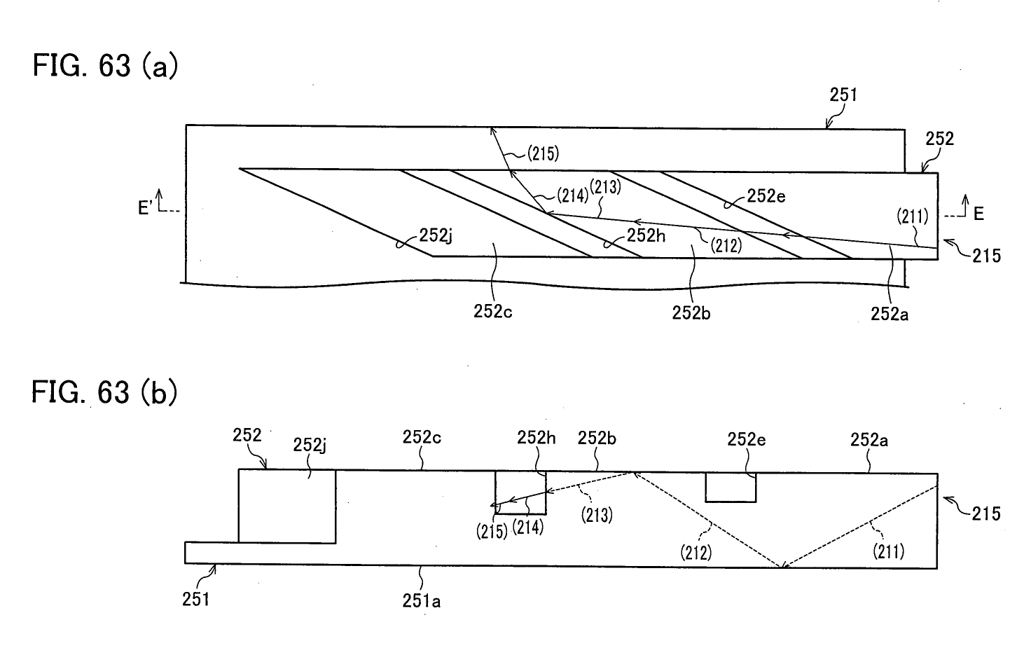

Other part of light entering the fourth member 252 (“fifth light”) assumes optical path (211) shown in FIGS. 63a and 63b and undergoes total reflection from the surface 251a. The total reflection from the surface 251a takes optical path (212) in the figures and undergoes total reflection from the surface 252b. That is, the total reflection from the surface 251a propagates in the fourth member 252 without undergoing total reflection from the surface 252e. The total reflection from the surface 252b assumes optical path (213) in the figures and undergoes total reflection from the surface 252h. The total reflection from the surface 252h assumes optical path (214) in the figures to reach the surface 252n. Having reached the surface 252n, the light assumes optical path (215) in the figures, passing through the surface 211c of the light guide section 211, and enters the light guide section 211.

The total reflection from the surface 252h is by no means limited to the fifth light.

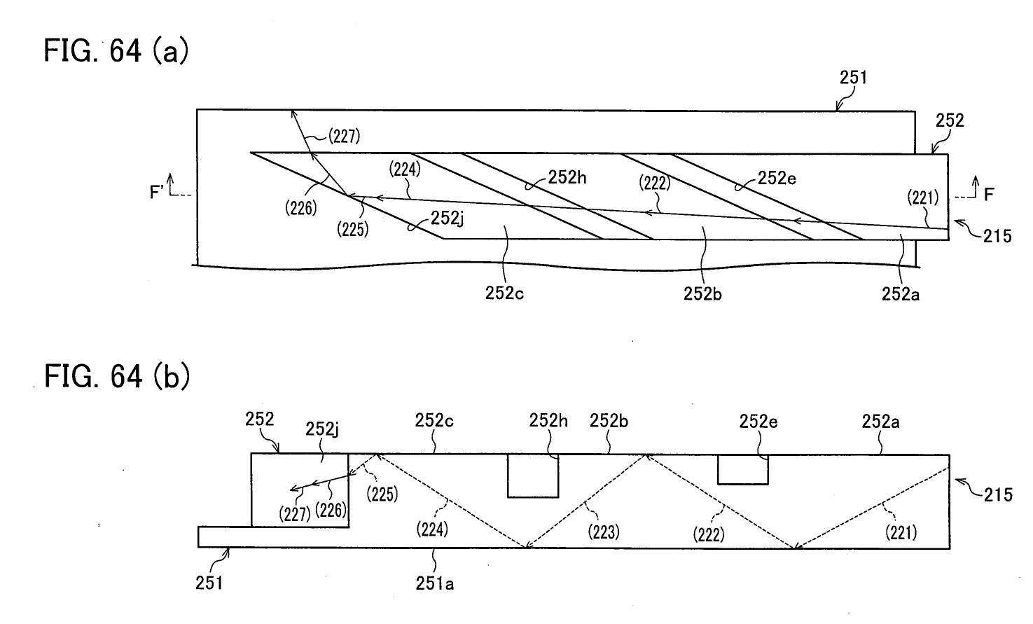

Other part of the light entering the fourth member 252 (“sixth light”) assumes optical path (221) shown in FIGS. 64a and 64b and undergoes total reflection from the surface 251a. The total reflection from the surface 251a assumes optical path (222) in the figures and undergoes total reflection from the surface 252b. That is, the total reflection from the surface 251a propagates in the fourth member 252 without reaching the surface 252e.

The total reflection from the surface 252b assumes optical path (223) in the figures and undergoes total reflection from the surface 251a. The total reflection from the surface 251a assumes optical path (224) in the figures and undergoes total reflection from the surface 252c. That is, the total reflection from the surface 252b propagates in the fourth member 252 without reaching the surface 252h.

The total reflection from the surface 252c assumes optical path (225) in the figures and undergoes total reflection from the surface 252j. The total reflection from the surface 252j assumes optical path (226) in the figures to reach the surface 252n. Having reached the surface 252n, the light assumes optical path (227) in the figures, passing through the surface 211c of the light guide section 211, and enters the light guide section 211.

The total reflection from the surface 252j is by no means limited to the sixth light.

In the foregoing, light passage was described for three cases for ease of description. Actually, light enters the fourth member 252 at various incident angles through the entire surface 252k. Therefore, total reflection occurs all over the surfaces 252e, 252h, and 252j.

Some of the light which reaches the surface 252e does not undergo total reflection from the surface 252e, but exits from the fourth member 252. That is also true with the light reaching the surface 252h and the light reaching the surface 252j.

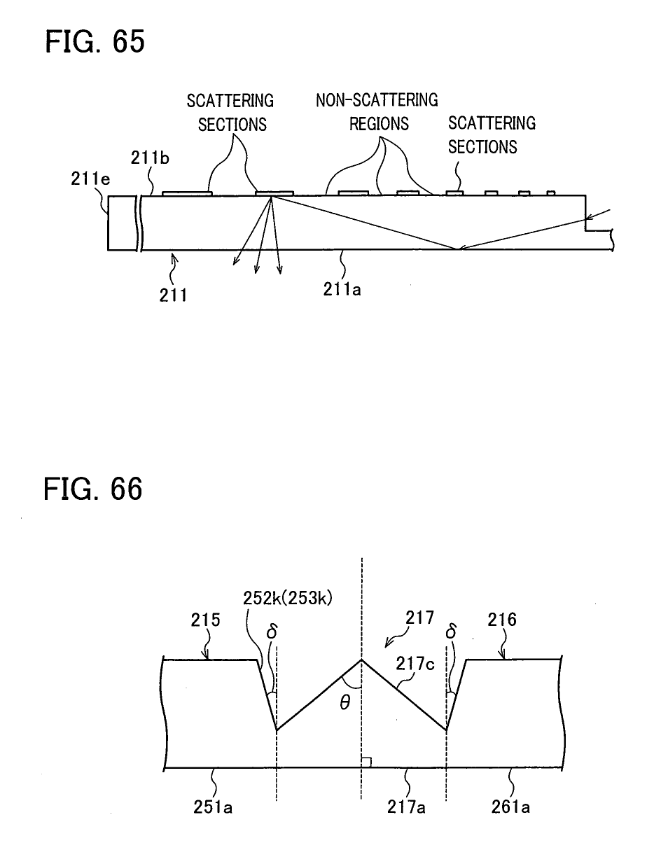

Referring to FIG. 65, next, will be described optical paths of light which travels from the surface 252n of the fourth member 252 through the surface 211c of the light guide section 211 to enter the light guide section 211 (predetermined light). FIG. 65 is a cross-sectional view taken along line C-C′ in FIG. 53.

The light entering the light guide section 211 undergoes total reflection from the non-scattering regions (i.e., interface) of the surfaces 211a and 211b and propagates in the light guide section 211 as shown in the figure. Some of that incident light hits the scattering sections of the surface 211b and scatters from the scattering sections. Some of the scattered light that does not undergo total reflection from the surface 211a, etc. exits through the surface 211a. Thus, the liquid crystal panel is illuminated.

Some of the external light reflected from the surface 217b of the bend section 217 does not travel inside the light guide section 215, but enters the light guide section 213. As described immediately above, the light entering the light guide section 213 directly enters the light guide section 211. Thereafter, that light is guided by the light guide section 211 to exit toward the liquid crystal panel.

To guide a large amount of light to enter the light guide section 215, the surfaces 252e, 252h, and 252j preferably scatter or reflect light. For example, the surfaces may be composed of a white paint (thin film).

To guide a large amount of light toward the liquid crystal panel, the surfaces 252a, 252b, and 252c of the light guide section 215 are preferably composed of a material which efficiently reflects light (for example, a thin film of a white color paint).

Assume a sixth direction which is a direction from the surface 252n to the surface 211c and a seventh direction which is a direction from the surface 217b to the surface 252k. The light guide plate 202 is a structure which includes the light guide section 211, the bend section 217, and the light guide section (other light guide section) 215. The light guide section 211 guides the predetermined light incident from the sixth direction down along the surface (predetermined surface) 211a so that the light exits through the surface 211a. The bend section 217 turns the external light incident to the surface opposite the surface 211a toward the surface 202 by one reflection. The light guide section 215 guides inside thereof the external light turned into the seventh direction by total reflections so that the light reflects from the plurality of surfaces (reflection surfaces) 252e, 252h, and 252j into the sixth direction and enters the light guide section 211. The reflection surfaces grow larger in area with the distance from the bend section 217.

In the structure, the bend section 217 turns the external light incident to the surface opposite the surface 211a into the seventh direction by one reflection. In the light guide section 215, the external light turned into the seventh direction is reflected from the plurality of reflection surfaces into the sixth direction so that the light enters the light guide section 211. Further, the light guide section 211 guides the light reflected into the sixth direction and entering the light guide section to exit through a predetermined surface.

Since a single reflection brings the light into the light guide section 215, the light guide plate itself can be made relatively thin when compared to structures where multiple reflections are involved.

In addition, the light guide section 211 guides the predetermined light down along the surface 211; the light source for external light can therefore be disposed in relatively close proximity to the surface opposite the light guide plate when compared to the structure of conventional direct backlights. Further, since the light source for external light does not need to be disposed on an edge of light guide plate, the predetermined surface can be readily combined with other such surfaces in a matrix when compared to the structure of conventional edge-lit type backlights. These individual factors all facilitate the realization of a large illumination surface.

Therefore, the light guide plate 202 is suited for reducing the thickness of the backlight device and increasing the illumination surface of the backlight device in area.

Further, the light guide section 215 reflects the external light into the sixth direction toward the light guide section 211 by means of the plurality of reflection surfaces. Therefore, the predetermined light entering the light guide section 211 is linear even when the light source, emitting the external light, is a point source. The light guide section 211 then tweaks the linear light so that planar light exits through the predetermined surface.

Therefore, the light source, emitting the external light, can be a point source.

Since the aforementioned reflections of light occur on the reflection surfaces (surfaces 252e, 252h, and 252j) of the light guide section 215, the amount of light (external light) guided inside the light guide section 215 by total reflections decreases with increasing distance from the bend section 217. Therefore, if the reflection surfaces had equal areas, the farther away from the bend section 217 the reflection surface is located, the less amount of light the reflection surface would reflect.

In the light guide plate 202 in accordance with the present invention, however, the reflection surfaces grow in area with increasing distance from the bend section 217. Therefore, the amount of reflected light decreases by a relatively small amount when compared to cases where the reflection surfaces have equal areas.

Therefore, a relatively uniform amount of light (predetermined light) is directed to enter the light guide section when compared to cases where the reflection surfaces have equal areas. Therefore, in the light guide plate 202, a relatively uniform amount of light is projected from the predetermined surface when compared to cases where the reflection surfaces have equal areas.

In contrast, assuming a sixth direction which is the direction from the surface 253n to the surface 212c and a seventh direction which is the direction from the surface 217b to the surface 253k, the light guide plate 202 may be said to be a structure which includes the light guide section 212, the bend section 217, and the light guide section (other light guide section) 215. The light guide section 212 guides the predetermined light incident from the sixth direction down along the surface (predetermined surface) 212a so that the light exits through the surface 212a. The bend section 217 turns the external light incident to the surface opposite the surface 212a into the seventh direction by one reflection. The light guide section 215 guides inside thereof the external light turned into the seventh direction by total reflections so that the light reflects from the plurality of surfaces (reflection surfaces) 253e, 253h, and 253j into the sixth direction and enters the light guide section 212. The reflection surfaces grow larger in area with the distance from the bend section 217. When this is the case, similar effects to those detailed above are achieved.

The light guide plate 202, as described in the foregoing, is a structure in which the reflection surfaces adjacent to each other in the seventh direction are positioned parallel to each other. In the structure, the reflection surfaces adjacent to each other in the seventh direction are positioned parallel to each other; therefore, relatively uniform light is guided to enter the light guide section when compared to cases where the reflection surfaces not positioned parallel to each other. Therefore, a relatively uniform amount of light can exit through the predetermined surface when compared to cases where the reflection surfaces are not positioned parallel to each other.

The light guide plate 202, as described in the foregoing, is a structure in which: the reflection surfaces are formed perpendicular to the surface 211a (surface 212a). In the structure, the reflection surfaces are formed perpendicular to the surface 211a (surface 212a); therefore, light is guided efficiently to enter the light guide section when compared to cases where the reflection surfaces are not formed perpendicular to the surface 211a (surface 212a). Therefore, an increased amount of light is projected from the surface 211a (surface 212a) when compared to cases where the reflection surfaces are not formed perpendicular to the surface 211a (surface 212a).

The light guide plate 202, as described in the foregoing, is a structure in which: the reflection surfaces are rectangular and each have a side of an equal length which is parallel to the surface 211a (surface 212a) and a side of an increasing length with increasing distance from the bend section 217 which is perpendicular to the surface 211a (surface 212a).

In the structure, the sides of the reflection surfaces parallel to the surface 211a (surface 212a) are all of an equal length. The sides perpendicular to the surface 211a (surface 212a) grow in length with increasing distance from the bend section 217. Therefore, the reflection surfaces grow in area with increasing distance from the bend section 217.

The light guide plate 202, as described in the foregoing, is a structure in which: the light guide section 215 has the plurality of groove sections (252t1, 252t2) on the surface opposite the surface 211a (surface 212a); the groove sections (252t1, 252t2) have equal lengths in the direction of the extension of the grooves and grow in depth with increasing distance from the bend section 217; and the groove sections each have a wall, close to the bend section 217 (surfaces 252e and 252h), which provides a reflection surface.

In the structure, the groove sections (252t1, 252t2) have equal lengths in the direction of the extension of the grooves and grow in depth with increasing distance from the bend section; therefore, the farther the groove section is located from the bend section 217, the larger in area the wall of the groove section close to the bend section 217. Further, the groove section each have a wall, close to the bend section 217, which provides a reflection surface.

Therefore, the reflection surfaces grow in area with increasing distance from the bend section 217.

The light guide plate 202, as described in the foregoing, is a structure which includes the light guide section (seventh light guide section) 215 and the light guide section (eighth light guide section) 216. The light guide sections 215 and 216 are disposed to flank the bend section 217. The bend section 217 turns the external light into a direction which is the seventh direction toward the light guide section 215 (“seventh light guide section direction”) and into a direction which is the seventh direction toward the light guide section 216 (“eighth light guide section direction”).

In the structure, the bend section 217 turns the external light incident to the surface opposite the surface 211a (surface 212a) into the seventh light guide section direction and the eighth light guide section direction each by one reflection. Thus, the light travels in the two light guide sections (215 and 216) flanking the bend section 217 and exits through the surfaces (211a and 212a) of the light guide sections 211 and 212.

The light guide plate 202 as described in the foregoing, is a structure which includes the light guide section (ninth light guide section) 211 and the light guide section (tenth light guide section) 212. The light guide sections 211 and 212 are disposed to flank the bend section 217 and the light guide sections 215 and 216. Both the light guide sections 215 and 216 guide light inside thereof and turns into a direction which is the sixth direction toward the light guide section 211 (“ninth light guide section direction”) and into a direction which is the sixth direction toward the light guide section 212 (“tenth light guide section direction”).

In the structure, the light guide section 215 turns the light guided inside thereof into the ninth light guide section direction and the tenth light guide section direction. Also, the light guide section 216 similarly turns the light guided inside thereof into the ninth light guide section direction and the tenth light guide section direction.

Thus, the light travels in the two light guide sections (215 and 216) and exits through the surfaces (211a and 212a) flanking the two light guide sections (211 and 212) of the bend section 217 and the light guide sections 215 and 216.

The light guide plate 202, as described in the foregoing, is a structure in which: the bend section 217 has the surface (first reflection surface for the bend section) 217b and the surface (second reflection surface for the bend section) 217c, both reflecting the external light. The surface 217b turns the external light into the seventh light guide section direction. The surface 217c turns the external light into the eighth light guide section direction.

In the structure, the surface 217b turns the external light into the seventh light guide section direction. The surface 217c turns the external light into the eighth light guide section direction. Therefore, the bend section 217 has a simple structure.

The light guide plate 202, as described in the foregoing, is a structure in which: the surfaces 217b and 217c are identical in shape and provided adjacent to each other to provide two of the side faces of a triangular column, and are tilted the same angle from the ninth virtual plane (specified plane) in mutually opposite directions.

In the structure, the amounts of light reflecting from the surfaces 217b and 217c are made equal to each other by projecting external light from a position on the ninth virtual plane toward the surfaces 211a and 212a. Therefore, the same amounts of light enter the light guide sections 215 and 216.

As mentioned earlier, some of the light emitted by the LED section 203 directly enters the fourth member 252 of the light guide section 215 through the surface 252k, without reflecting from the surface 217b. When this is the case, the light guide section 215 guides inside thereof the light direct entering the light guide section 215 without being turned by the bend section 217 by total reflections. That light also reflects from the reflection surfaces (252e, 252h, and 252j) into the sixth direction to enter the light guide section 211.

Therefore, the light guide section 215 guides also the external light not turned by the bend section 217 and reflects the guided light into the sixth direction so that the light enters the light guide section 11. Therefore, the amount of light exiting through the surface 211a is less affected by the radiation properties of the external light incident to the surface opposite the surface 211a. Therefore, an increased amount of light exits through the surface 211a.

The light guide plate 202 has a gap between the light guide section 211 and the fourth member 252 of the light guide section 215. That is, the fourth member 252 is provided with the surface 252n. The provision of the surface 252n enables part of incident light to undergo total reflection in the light guide section 215 and travel toward the surface 252j. The same is true with the surface 253n.

Also, there is a gap provided between the fourth and fifth members 252 and 253. That is, the fourth member 252 is provided with the surface 252m. The provision of the surface 252m enables part of incident light to undergo total reflection in the light guide section 215 and travel toward the surface 252j. The same is true with the surface 253m.

To increase the amount of light exiting through the surfaces 211a and 212a, the surfaces 211e, 211f, 211g, 212e, 212f, and 212g are preferably adapted to scatter or reflect light. For example, the surfaces may be composed of a white paint (thin film).

If there is provided a reflection sheet facing the surfaces 211b and 212b, the amounts of light exiting through the surfaces 211a and 212a are further increased.

In the light guide plate 202, the surfaces 252k and 253k are adapted to be perpendicular to the LC-facing plane. However, this is by no means intended to be limiting the invention. For example, as shown in FIG. 66, the surfaces 252k and 253k may be tilted with respect to the ninth virtual plane in such an orientation that the surfaces 252k and 253k refract the light turned (reflected) by the surface 217b toward the LC-facing plane. Specifically, the angles between the surfaces 252k and 253k and the surface 217b may be set to a value greater than θ.

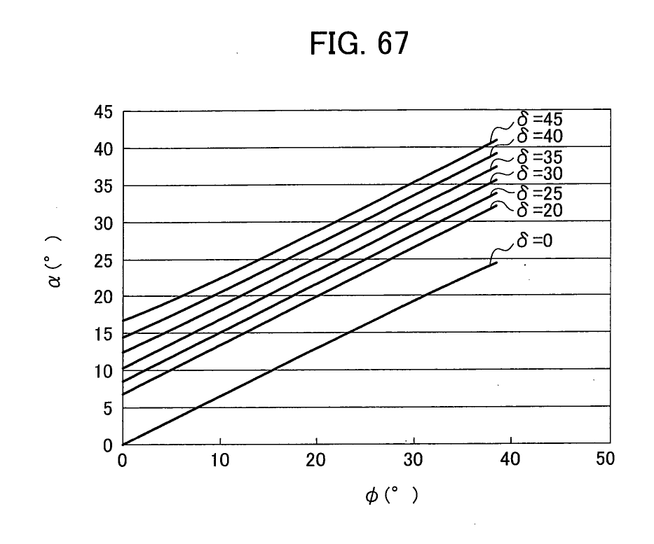

FIG. 67 is a representation of a relationship between the angles φ and α for various δ values with θ=45°.

As shown in the figure, when δ is increased, α is also increased. To put it differently, when δ is increased, the incident angle to the surface 251a is decreased. The figure also indicates that α is no greater than 48° for the maximum φ value when 6=45°, which means that light undergoes total reflection from the surface of the light guide section 215.

Further, the greater the δ value, the more total reflections occur in the light guide section 215. Therefore, the external incident light to the light guide section 215 is reliably reflected from the surfaces 252e and 253e located closely to the bend section 217. Therefore, the light projected onto the surface 211c of the light guide section 211 has an uniform amount.

As described in the foregoing, the light guide plate 202 may be a structure in which: the aforementioned external light enters the light guide section 215 through the surfaces 252k and 253k thereof; and the surfaces 252k and 253k are tilted with respect to the surface perpendicular to the surface 251a in such an orientation that the surfaces 252k and 253k refract the turned external light toward the surface 251a.

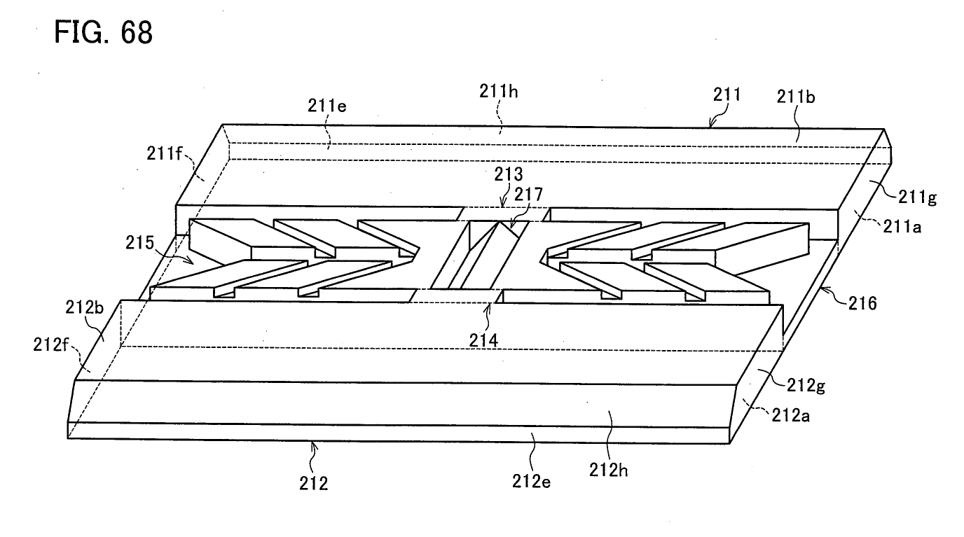

In the light guide plate 202, the light guide sections 211 and 212 are of the shape of a rectangular parallelepiped. This is by no means intended to be limiting the invention. For example, as shown in FIG. 68, the light guide sections 211 and 212 may have a tilt surface 211h and a tilt surface 212h respectively. The tilt surface 211h is adjacent to the surfaces 211b and 211e. The tilt surface 211h is composed of a light-reflecting material or a light-scattering material. The tilt surface 211h is tilted with respect to the LC-facing plane toward the surfaces 211c and 211d. The tilt surface 212h is adjacent to the surfaces 212b and 212e. The tilt surface 212h is composed of a light-reflecting material or a light-scattering material. The tilt surface 212h is tilted with respect to the LC-facing plane toward the surfaces 212c and 212d.

That is, the tilt surface 211h is provided so that the intersecting line of the tilt surface 211h and the surface 211b is closer to the surfaces 211c and 211d than is the intersecting line of the tilt surface 211h and the surface 211e. Also, the tilt surface 212h is provided so that the intersecting line of the tilt surface 212h and the surface 212b is closer to the surfaces 212c and 212d than is the intersecting line of the tilt surface 212h and the surface 212e.

In the structure, the tilt surface 211h at least reflects or scatters light toward the light guide section 211, without allowing light to exit therethrough. Therefore, the external light is more efficiently utilized. Therefore, an increased amount of light exits through the surface 211a when compared to cases where there is no tilt surface 211h being provided. The above description about the light guide section 211 is also true with the light guide section 212.

In addition to the provision of the tilt surfaces 211h and 212h, the surfaces 252k and 253k may also be tilted with respect to the ninth virtual plane as mentioned earlier.

In the light guide plate 2, the light guide sections 211 and 212 are of the same shape. This is by no means intended to be limiting the invention. The surface 211a of the light guide section 211 may differ in area from the surface 212a of the light guide section 212; still, the surfaces 211a and 212a can be adapted to allow the same amount of light per unit area to exit therethrough by changing the patterns of the surfaces 211b and 212b. Therefore, when this is the case, the light guide plate 2 again projects uniform light toward the liquid crystal panel. In addition, if there are restrictions on the position of the LED section 203, the surfaces 211a and 212a can project light by changing the size ratio of the light guide sections 211 and 212.

In the light guide plate 202, the light guide sections 215 and 216 are of the same shape. This is by no means intended to be limiting the invention.

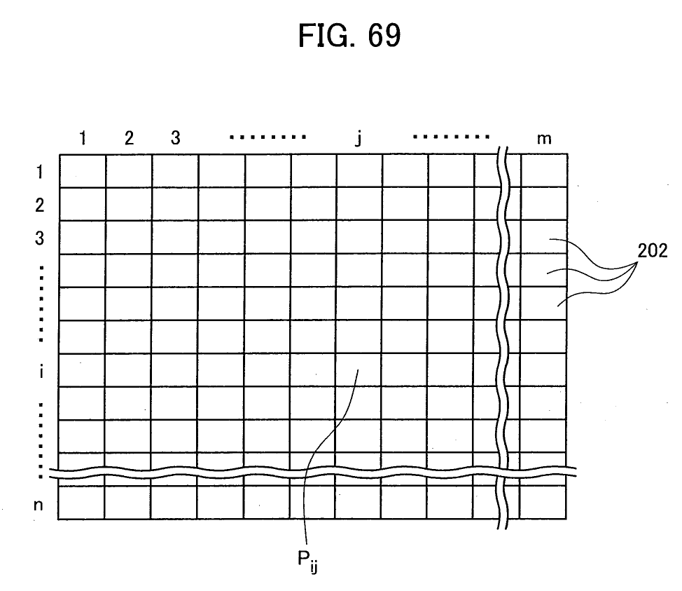

Next, a drive circuit and method for LEDs for an n×m matrix of light guide plates 202 (see FIG. 69) will be described. In the following, each individual light guide plate 202 in the matrix will be denoted by Pij (1≦i≦n, 1≦j≦m).

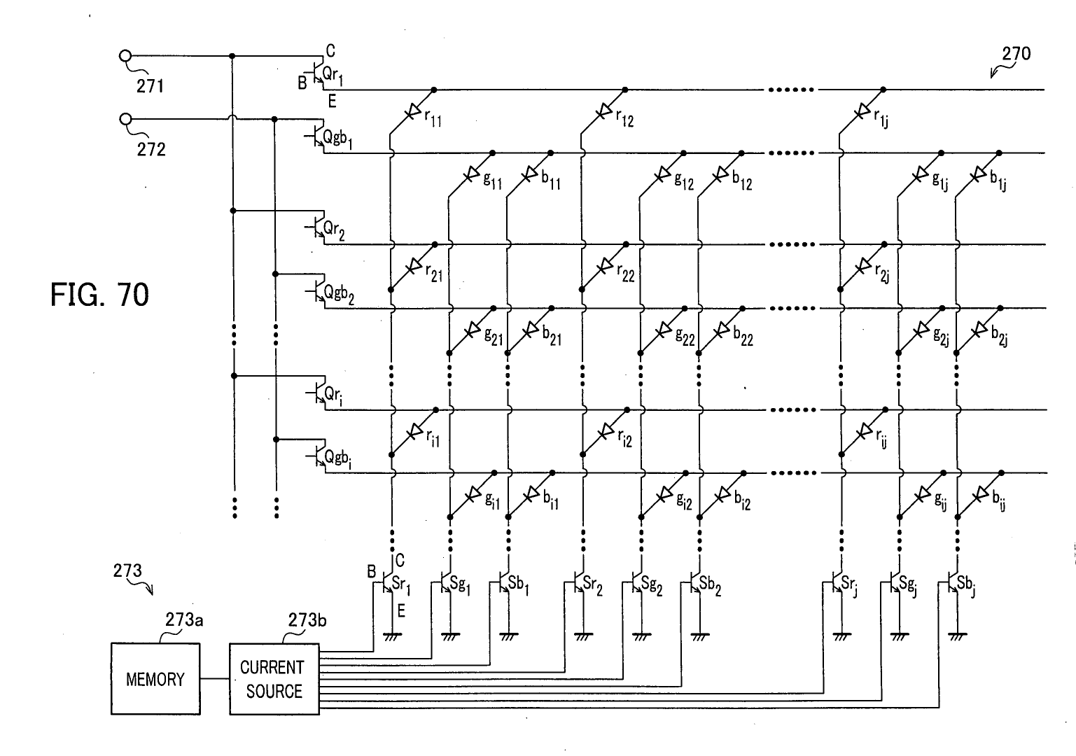

As shown in FIG. 70, a drive circuit 270 includes an LED section 203 for each light guide plates Pij. That is, each light guide plates Pij has its own red LED, green LED, and blue LED. The LEDs are arranged at the positions shown in FIG. 59. In the following, the red, green, and blue LEDs for the plate Pij will be denoted by rij, gij, and bij respectively.

The drive circuit 270 includes a constant voltage source 271, another constant voltage source 272, switching elements Qri and Qgbi, a third controller 273, and a fourth controller (not shown). The third controller 273 includes switching elements Srj, Sgj, and Sbj, a memory 273a, and a current source 273b. The following description will assume that the switching elements Qri and Qgbi and the switching elements Srj, Sgj, and Sbj are all transistors.

In the following, the combined structure of the matrix of light guide plates 202, the LED sections 203, one for each light guide plate 202, and the drive circuit 270 will be referred to as the light guide system.

The constant voltage source 271 applies a constant voltage to the inputs of the red LED ri1, ri2, ri3, . . . , and rim via the switching elements Qri. The constant voltage source 272 applies a constant voltage to the inputs of the switching elements gi1, gi2, gi3, . . . , and gim and to the inputs of the switching elements bi1, bi2, bi3, . . . , and bim via the switching elements Qgbi.

The switching elements Qri and Qgbi conduct the current supplied by the constant voltage sources 271, 272 from the collector (C) to the emitter (E) by means of, for example, the fourth controller supplying current to the base (B). In addition, the fourth controller applies current to the bases of the switching elements Qri and Qgbi (i-th element of each group) at the same time so that the elements start conducting simultaneously. After switching the switching elements Qri and Qgbi from conduction to non-conduction, the fourth controller simultaneously switches the adjacent switching elements Qri+1 and Qgbi+1 to conduction.

The third controller 273 will be next described.

The memory 273a stores information indicating current to be supplied to the bases of all the switching elements Srj, Sgj, and Sbj (3m elements).

The current source 273b simultaneously supplies current to the bases of all the switching elements Srj, Sgj, and Sbj (i.e. 3 m elements) to simultaneously switch the switching elements Srj, Sgj, and Sbj to conduction. The control section (not shown) for the current source 273b determines the current to be supplied to each switching element from the information stored in the memory 273a. Based on the determinations, the current source 273b supplies current to the switch elements.

With the current supply at the base, each switching element Srj, Sgj, and Sbj conducts current from the collector (C) to the emitter (E) in accordance with the base current.

LEDs, even if they generate light of the same color, will still differ in the nature of the light they produce (e.g. luminance and hue). Therefore, the current at which the individual LEDs produce light in the amount predetermined for each color is determined for each LED on the basis of the characteristics of the LED. The memory 273a stores the information on the determined currents. Thus, all the LEDs for each specific color (for example, ri1, ri2, ri3, . . . , and rim for red) produce light in the amount predetermined for that particular color.

Therefore, the LED sections 203, one for each light guide plate Pij, produce the same amount of white light per unit time. Thus, the light guide plates Pij project uniform, white light.

LEDs degrade with time, producing light in progressively decreasing amount. Accordingly, the third controller 273 is first adapted to operate in a mode where the LEDs (rij, gij, bij) for the light guide plates Pij are lit at different timings from one light guide plate to the next, and the three individual LEDs for each plate are lit again at different timings. Further, the drive circuit 270 includes a photodiode (converter) for each LED section 203 at a predetermined position relative to the LED section 203. The photodiode converts to an electric signal an optical signal generated when an LED lights.

The third controller 273 is further adapted to receive the electric signal from each LED, so that the control section of the current source 273b changes the information stored in the memory 273a in accordance with the received signal intensity. Specifically, while the third controller 273 is operating in the above mode, the control section changes the information so that the current supplies to the bases of the switching elements Srj, Sgj, and Sbj increase with a decrease in the received signal intensity.

When the LEDs degrade, this structure is capable of increasing the amount of LED light to a certain extent.

When this is the case, the control section preferably changes the information so that at least the LEDs of the same color emit the same amount of light. This makes it possible to always project uniform light onto the liquid crystal display panel.

As described in the foregoing, the light guide system may be a structure which includes the light guide plates 202, the LED sections (light emitting elements) 203, one for each light guide plate 202, and the third controller 273. The light guide plates 202 are arranged in a matrix. The LED sections 203 generate the external light. The third controller 273 controls the current supply to each LED section 203.

The light guide system may be a structure which includes photodiodes (converters), one for each light emitting element. The photodiode converts to an electric signal an optical signal generated when the LED section (light emitting elements) 203 is lit.

The drive circuit 270 may be a structure which includes the light guide plates 202, the LED sections (light emitting elements) 203, one for each light guide plate 202, and the third controller 273. The light guide plates 202 are arranged in a matrix. The LED sections 203 generate the external light. The light guide plates 202 and the LED sections 203 essentially form a lighting device. The drive circuit 270 supplies current to each LED section 203 in the lighting device. The third controller 273 controls the current supply to each LED section 203.

The drive circuit 270 may be said to be a structure which includes photodiodes (converters), one for each LED section 203. The photodiode converts to an electric signal an optical signal generated when the LED section 203 is lit.

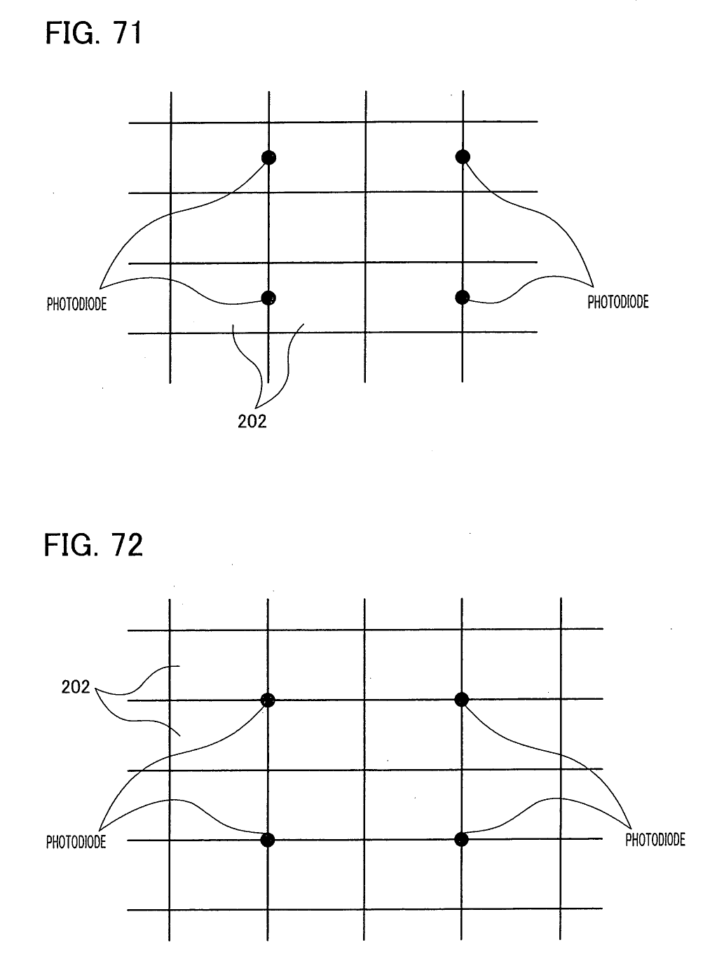

Further, in the foregoing, a photodiode was disposed for each LED section 203. This is by no means intended to be limiting the invention. For example, a photodiode may be disposed on the boarder of every two adjacent light guide plates that are paired up as shown in FIG. 71.

So, the light guide system may be a structure in which: two adjacent light guide plates are paired; and there is provided a photodiode (converter) for each pair on the boarder of those light guide plates. The photodiode converts to an electric signal an optical signal generated when the LED section (light emitting elements) 203 is lit. If the LED sections 203, one for each pair of light guide plates, are lit at different timings, the photodiodes convert to electric signals the optical signals generated when the LED sections 203 are lit.

In the structure, a single photodiode converts to electric signals optical signals generated when the two LED sections 203 which are provided for that single photodiode are lit. Therefore, the amount of light generated when each LED section 203 is lit is determined in terms of electric signal levels. Therefore, by controlling the current supply to each LED section 203 in accordance with the electric signal levels, uniform light is always projected through the predetermined surface.

Further, since there is provided one photodiode for every two LED sections 203, cost is reduced when compared to structures in which there is provided one photodiode for each LED section 203. The total photodiode count is decreased, allowing for lowering of the manufacturing cost of the drive circuit 270.

Moreover, since there is one photodiode provided on the boarder of each pair of LED sections 203, the electric signal levels obtained from optical signals generated when those LED sections 203 are lit are compared using a common reference.

Another example is sets of four (2×2) light guide plates shown in FIG. 72 where one photodiode is disposed at the center of those light guide plates.

So, the light guide system may be a structure in which: four (2×2) light guide plates are grouped; and three is provided a photodiode (converter) for each group at the center of those light guide plates. The photodiode converts to an electric signal an optical signal generated when the LED section (light emitting element) 203 is lit. If the LED section 203, one for each group of light guide plates, are lit at different timings, the photodiodes convert to an electric signals the optical signals generated when the LED sections 203 are lit.

In the structure, a single photodiode converts to an electric signal an optical signal generated when the four light emitting elements which are provided for that single photodiode are lit. Therefore, the amount of light generated when each LED section 203 is lit is determined in terms of electric signal levels. Therefore, by controlling the current supply to each light emitting element in accordance with the electric signal levels, uniform light is always projected through the predetermined surface.

Further, since there is provided one photodiode for every four light emitting elements, cost is reduced when compared to structures in which there is provided one photodiode for each LED section 203. The total photodiode count is decreased further, allowing for further lowering of the manufacturing cost of the drive circuit 270.

Moreover, since there is one photodiode provided at the center of each group of light guide plates, the electric signal levels obtained from optical signals generated when those LED sections 203 are lit are compared using a common reference.

FIG. 70 shows an example where a green LED and a blue LED are driven by the same line. This is by no means intended to be limiting the invention. For example, the switching elements Qgbi may be replaced with color-specific switching elements Qgi and switching elements Qbi to drive the green LEDs and the blue LEDs separately.

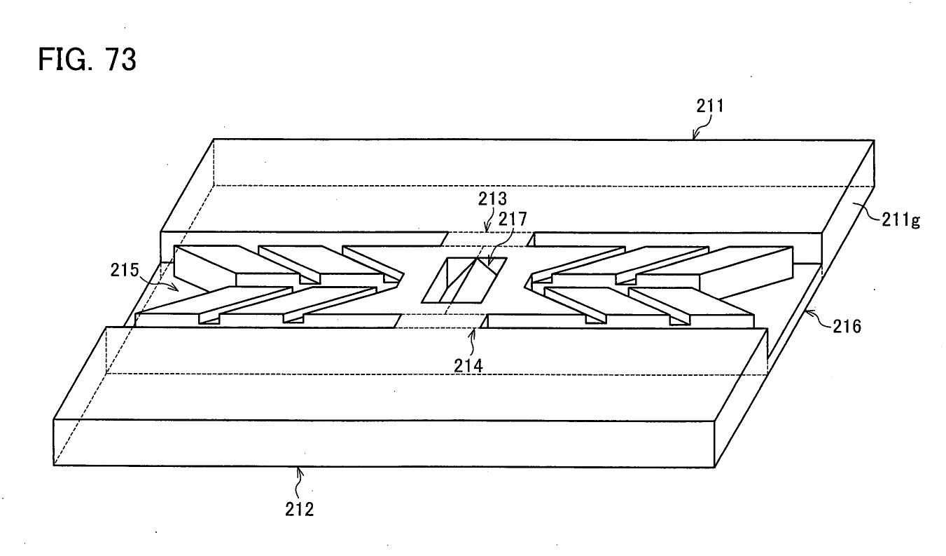

The light guide sections 15 and 216 may be shaped, as shown in FIG. 73, to encircle the bend section 217.

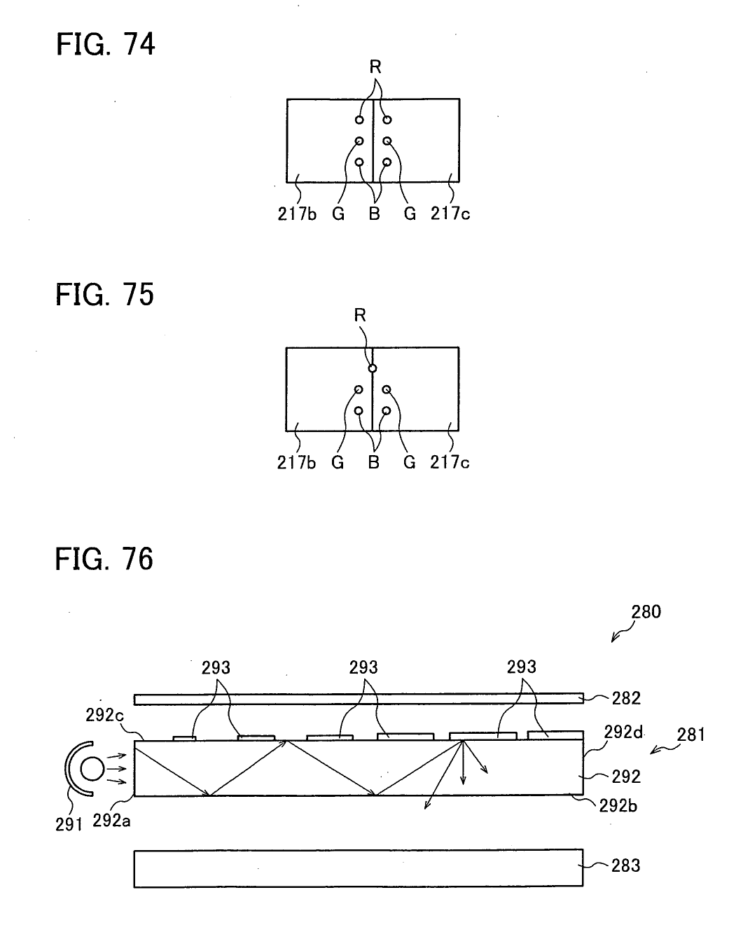

The LED section 203 with three LEDs shown in FIG. 59 was used for the light guide plate 202. This is by no means intended to be limiting the invention. For example, as shown in FIG. 74, there may be provided two red LEDs, two green LEDs, and two blue LEDs with each of LEDs of the same color being positioned symmetric with respect to the intersecting line thereof.

Further, the LED section 203 may have one LED for one of the colors (for example, R) and two LEDs for each of the remaining colors. When this is the case, as shown in FIG. 75, the green LEDs and the blue LEDs may be positioned so that they are symmetric with respect to the intersecting line thereof.

In the above embodiment, the light emitted by the LED section 203 have been reflected (turned) from the two surfaces 217b and 217c of the bend section 217. This is by no means intended to be limiting the invention.

Any structure that reflects the light emitted by the LED section 203 may be used. An example is the side surface of a circular cone. Another example is four sides of a quadrilateral cone.

In the above embodiment, the surfaces 217b and 217c have been composed of a material that efficiently reflects light. The surfaces 217b and 217c however do not need to be entirely composed of such a material. The surfaces 217b and 217c may have a pattern consisting of regions where the surface is made of the material and those where the surface is made of something else, so that the light emitted by the LED section 203 is partly guided to directly enter the bend section 217.

In the foregoing, the point sources (light emitting elements) were LEDs. This is by no means limiting the invention. Light sources other than LEDs may be used.

Further, the point sources may be replaced by line light sources disposed along the intersecting lines.

The above embodiment has described an example where, for example, the fourth member 252 of the light guide section 215 has two groove sections. The number of groove sections is by no means limited to two.

In the foregoing, the light guide sections 211 to 216 and the bend section 217 may be made separately and subsequently combined to form the light guide plate 202.

The light guide sections 215 and 216 are by no means limited to the aforementioned shape. For example, the third member 251 may be omitted. When this is the case, it would be sufficient if light undergoes total reflection from the surfaces of the fourth and fifth members facing the liquid crystal, in lieu of the surface 251a.

There is absolutely only one requirement: the light guide sections 215 and 216 have reflection surfaces which at least grow in area with increasing distance from the bend section 217.

A light guide plate in accordance with the present invention, to solve the problems, is characterized in that it includes: a light guide section for guiding predetermined light incident from a pre-set direction along a predetermined surface so that the incident light exits through the predetermined surface; and a bend section for turning external light incident to a surface opposite the predetermined surface into the pre-set direction by one reflection so that the external light enters the light guide section.

According to the structure, the bend section turns the external light incident to a surface opposite the predetermined surface into the pre-set direction by one reflection so that the light enters the light guide section. In addition, the light guide section guides the light turned into the pre-set direction and entering the light guide section so that the light exits through the predetermined surface.

Since a single reflection brings the light into the light guide section, the light guide plate itself can be made relatively thin when compared to structures where multiple reflections are involved.

In addition, the light guide section guides the predetermined light along a predetermined surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface.

Therefore, the resultant light guide plate is suitable for reducing the thickness of the backlight device and increasing the illumination surface of the backlight device in area.

The light guide plate in accordance with the present invention, in the foregoing light guide plate, is characterized in that: the predetermined light is incident to a first surface of the light guide section; and the first surface is tilted with respect to a surface perpendicular to the predetermined surface in such an orientation that the first surface refracts the turned external light toward the predetermined surface.

According to the structure, the first surface is tilted with respect to the surface perpendicular to the predetermined surface in such an orientation that the first surface refracts the turned external light toward the predetermined surface.

Therefore, the incident angle to the predetermined surface is made relatively small when compared to cases where the first surface is not tilted with respect to the perpendicular surface.

Therefore, light can exit through a part of the predetermined surface which is relatively close to the bend section when compared to cases where the first surface is not tilted.

Therefore, the light exiting through the predetermined surface has increased uniformity.

The light guide plate in accordance with the present invention, in the foregoing light guide plate, is characterized in that: the predetermined light is incident to a first surface of the light guide section; and the light guide section has an end surface, opposite the first surface, to which is applied a light-reflecting material or a light-scattering material; and the end surface has a tilt surface tilted with respect to the predetermined surface toward the first surface.

According to the structure, the tilt surface at least reflects or scatters the light guided to the end surface toward the light guide section without letting the light exiting through the end surface.

Therefore, the external light is efficiently utilized.

Therefore, an increased amount of light exits through the predetermined surface when compared to cases where no tilt surface is provided.

The light guide plate in accordance with the present invention, in the foregoing light guide plate, is characterized in that: the light guide section is divided into a first light guide section and a second light guide section; the first and second light guide sections are disposed to flank the bend section; and the bend section turns the external light into a first direction which is the pre-set direction toward the first light guide section and into a second direction which is the pre-set direction toward the second light guide section.

According to the structure, the bend section turns the external light incident to a surface opposite the predetermined surface into the first and second directions individually by one reflection.

Therefore, the first and second light guide sections flanking the bend section project light. In addition, if there are restrictions on the position of the light source emitting the external light, the predetermined surface can project light by changing the size ratio of the first and second light guide sections.

The light guide plate in accordance with the present invention, in the foregoing light guide plate, is characterized in that: the bend section has a first reflection surface and a second reflection surface both reflecting the external light; and the first reflection surface turns the external light into the first direction, and the second reflection surface turns the external light into the second direction.

According to the structure, the first reflection surface turns the external light into the first direction. In addition, the second reflection surface turns the external light into the second direction.

Therefore, the bend section has a simple structure.

The light guide plate in accordance with the present invention, in the foregoing light guide plate, is characterized in that: the first and second reflection surfaces are identical in shape and disposed adjacent to each other to provide two side faces of a triangular column; and the first and second reflection surfaces are tilted an equal angle with respect to a specified plane in mutually opposite directions, the specified plane being perpendicular to the predetermined surface and including an intersecting line of the first and second reflection surfaces.

According to the structure, the amounts of light reflecting from the first and second reflection surfaces are made equal to each other by projecting external light from a position on the specified plane toward the predetermined surface.

Therefore, the same amounts of light (predetermined light) enter the first and second light guide sections.

The light guide plate in accordance with the present invention, in the foregoing light guide plate, is characterized in that the first and second light guide sections are symmetric.

According to the structure, the first and second light guide sections are symmetric.

Therefore, the structure of the light guide plate is relatively when compared to the first and second light guide sections are non-symmetric.

A light guide plate in accordance with the present invention, to solve the problems, is characterized in that it includes: a light guide section for guiding predetermined light incident from a pre-set direction along a predetermined surface so that the incident light exits through the predetermined surface; a bend section for turning external light incident to a surface opposite the predetermined surface into a predetermined direction by one reflection; and another light guide section for guiding inside thereof the external light turned into the predetermined direction by total reflection and turning that light into the pre-set direction at a plurality of predetermined positions so that the light enters the light guide section.

According to the structure, the bend section turns the external light incident to a surface opposite the predetermined surface into the predetermined direction by one reflection. In addition, the other light guide section turns the external light turned into the predetermined direction into the pre-set direction at the plurality of predetermined positions so that the light enters the light guide section. Further, the light guide section guides the light turned into the pre-set direction and entering the light guide section so that the light exits through the predetermined surface.

Since a single reflection brings the light into the light guide section, the light guide plate itself can be made relatively thin when compared to structures where multiple reflections are involved.

In addition, the light guide section guides the predetermined light along a predetermined surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface.

Therefore, the resultant light guide plate is suitable for reducing the thickness of the backlight device and increasing the illumination surface of the backlight device in area.

Further, the other light guide section turns the external light into the predetermined direction toward the light guide section at the plurality of predetermined positions. Therefore, the predetermined light entering the light guide section is linear even when the light source, emitting the external light, is a point source. The light guide section then tweaks the linear light so that planar light exits through the predetermined surface.

Therefore, the light source, emitting the external light, can be a point source.

The light guide plate in accordance with the present invention, in the foregoing light guide plate, is characterized in that: the other light guide section is divided into a first light guide section and a second light guide section; the first and second light guide sections are disposed to flank the bend section; and the bend section turns the external light into a first direction which is the predetermined direction toward the first light guide section and into a second direction which is the predetermined direction toward the second light guide section.

According to the structure, the bend section turns the external light incident to a surface opposite the predetermined surface into the first and second directions individually by one reflection.

Thus, the light travels in the two light guide sections (first and second light guide sections) flanking the bend section and exits through the predetermined surface of the light guide section.

The light guide plate in accordance with the present invention, in the foregoing light guide plate, is characterized in that: the light guide section is divided into a third light guide section and a fourth light guide section; the third and fourth light guide sections are disposed to flank the bend section and the first and second light guide sections; both the first and second light guide sections turn the internally guided light into a third direction which is the pre-set direction toward the third light guide section and into a fourth direction which is the pre-set direction toward the fourth light guide section.

According to the structure, the first light guide section turns the internally guided light into a third direction which is the pre-set direction toward the third light guide section and into a fourth direction which is the pre-set direction toward the fourth light guide section. Similarly, the second light guide section turns the internally guided light into the third and fourth directions.

Thus, the light travels in the two light guide sections (first and second light guide sections) and exits through the predetermined surface of the two light guide sections (third and fourth light guide sections) flanking the bend section and the first and second light guide sections.

The light guide plate in accordance with the present invention, in the foregoing light guide plate, is characterized in that: the external light is emitted by an LED.

According to the structure, the external light is emitted by an LED.

Therefore, the light source, emitting the external light, can be an LED.

A lighting device in accordance with the present invention, to solve the problems, is characterized in that it includes the light guide plate and a light emitting element emitting the external light, the light emitting element being disposed so that a light emitting surface thereof is symmetric with respect to the specified plane.

According to the structure, the external light is projected toward the predetermined surface from the light emitting surface positioned symmetric with respect to the specified plane.

Therefore, the amounts of light reflecting from the first and second reflection surfaces are made equal to each other.

A lighting device in accordance with the present invention, in the foregoing lighting device, is characterized in that: it further includes light emitting elements emitting different colors of light, each light emitting element being disposed so that a light emitting surface thereof is symmetric with respect to the specified plane.

According to the structure, the external light is projected toward the predetermined surface from the light emitting surface of each light emitting element positioned symmetric with respect to the specified plane.

Therefore, the amounts of light reflecting from the first and second reflection surfaces are made equal to each other for each light emitting element.

A light guide device in accordance with the present invention, to solve the problems, is characterized in that it includes a combination of light guide plates, the light guide plates differing in predetermined surface size from each other, exit light exiting through the predetermined surface of a first light guide plate being used as the external light for a second light guide plate, the first light guide plate being one of the light guide plates which has a smaller predetermined surface, the second light guide plate being one of the light guide plates which has a larger predetermined surface.

According to the structure, the exit light exiting through the predetermined surface of the first light guide plate can be used as the external light for the second light guide plate.

The external light for the second light guide plate incident to the second light guide plate is linear even when the light source, emitting the external light incident to the first light guide plate, is a point source. The second light guide plate then tweaks the linear light so that planar light exits through the predetermined surface of the second light guide plate.

Therefore, the light source, emitting the external light, can be a point source.

A light guide system in accordance with the present invention, to solve the problems, is characterized in that it includes: a matrix of light guide plates; light emitting elements corresponding to the light guide plates, the light emitting elements emitting the external light; and a controller for controlling current supplies to the light emitting elements.

According to the structure, the controller controls the current supplies to the light emitting elements corresponding to the light guide plates.

Light emitting elements, even if they generate light of the same color, will still differ in their nature. Therefore, if the light emitting elements are fed with the same current, they produce different light (luminance in the case of those elements which produce light of the same color and luminance or hue in the case of those which produce light of different colors).

Therefore, by controlling the current supplies to the light emitting elements, the light emitting elements come to produce identical light.

Therefore, uniform light is projected through the predetermined surface of each light guide plate.

A light guide system in accordance with the present invention, to solve the problems, is characterized in that it includes: a matrix of second light guide plates in light guide devices; light emitting elements corresponding to the light guide devices, the light emitting elements emitting the external light; and a controller for controlling current supplies to the light emitting elements.

According to the structure, the controller controls the current supplies to the light emitting elements corresponding to the light guide devices.

Light emitting elements, even if they generate light of the same color, will still differ in their nature. Therefore, if the light emitting elements are fed with the same current, they produce different light (luminance in the case of those elements which produce light of the same color and luminance or hue in the case of those which produce light of different colors).

Therefore, by controlling the current supplies to the light emitting elements, the light emitting elements come to produce identical light.

Therefore, uniform light is projected through the predetermined surface of the second light guide plate in each light guide device.

The light guide system in accordance with the present invention, in the foregoing light guide system, is characterized in that it further includes converters, one for each of the light emitting elements, the converters converting optical signals generated when the light emitting elements are lit to electric signals.

According to the structure, the converters convert optical signals generated when the light emitting elements are lit to electric signals.

Therefore, the amounts of light generated when the light emitting elements are lit are individually determined in terms of electric signal levels.

Therefore, by controlling the current supplies to the light emitting elements in accordance with the electric signal levels, uniform light is always projected through the predetermined surface.

The light guide system in accordance with the present invention, in the foregoing light guide system, is characterized in that it further includes converters, one for each pair of two adjacent light guide plates, provided on boarders of the light guide plates, the converters converting optical signals generated when the light emitting elements are lit to electric signals, wherein: one light emitting element is provided for each pair of light guide plates; and the converters convert optical signals generated when the light emitting elements are lit at different timings to corresponding electric signals.

According to the structure, a single converter converts to an electric signal an optical signal generated when one of the two light emitting elements associated with that converter are lit.

Therefore, the amounts of light generated when the light emitting elements are lit are individually determined in terms of electric signal levels.

Therefore, by controlling the current supplies to the light emitting elements in accordance with the electric signal levels, uniform light is always projected through the predetermined surface.

Further, every two light emitting elements are provided with one converter; cost is thus lowered when compared to structures where every light emitting element is provided with one converter. In addition, since the converter is provided on the boarder, the electric signal levels obtained from the optical signals generated when the paired light emitting elements are lit are compared using a common reference.

The light guide system in accordance with the present invention, in the foregoing light guide system, is characterized in that it further includes: converters, one for each group of 2×2=4 light guide plates, provided at centers of the light guide plates, the converters converting optical signals generated when the light emitting elements are lit to electric signals, wherein: one light emitting element is provided for each group of light guide plates; and the converters convert optical signals generated when the light emitting elements are lit at different timings to corresponding electric signals.

According to the structure, a single converter converts to an electric signal an optical signal generated when one of the four light emitting elements associated with that converter are lit.

Therefore, the amounts of light generated when the light emitting elements are lit are individually determined in terms of electric signal levels.

Therefore, by controlling the current supplies to the light emitting elements in accordance with the electric signal levels, uniform light is always projected through the predetermined surface.

Further, every four light emitting elements are provided with one converter; cost is thus lowered when compared to structures where every light emitting element is provided with one converter.

Since the converter is provided at the center of the grouped light guide plates, the electric signal levels obtained from the optical signals generated when the grouped light emitting elements are lit are compared using a common reference.

The light guide system in accordance with the present invention, in the foregoing light guide system, is characterized in that: the controller changes the current supplies to the light emitting elements on the basis of the electric signals.

According to the structure, the controller changes the current supplies to the light emitting elements on the basis of the electric signals.

Therefore, uniform light is always projected through the predetermined surface.

A drive circuit in accordance with the present invention, to solve the problems, is characterized in that it is a drive circuit for supplying current to light emitting elements in a lighting device, the lighting device including: a matrix of light guide plates; and the light emitting elements corresponding to the light guide plates, the light emitting elements emitting the external light, the drive circuit including a controller for controlling current supplies to the light emitting elements.

According to the structure, the controller controls the current supplies to the light emitting elements corresponding to the light guide plates of the lighting device.

Light emitting elements, even if they generate light of the same color, will still differ in their nature. Therefore, if the light emitting elements are fed with the same current, they produce different light (luminance in the case of those elements which produce light of the same color and luminance or hue in the case of those which produce light of different colors).

Therefore, by controlling the current supplies to the light emitting elements, the light emitting elements come to produce identical light.

Therefore, uniform light is projected through the predetermined surface of each light guide plate in the lighting device.

The drive circuit in accordance with the present invention, to solve the problems, is characterized in that it is a drive circuit for supplying current to light emitting elements in a lighting device, the lighting device including: a matrix of second light guide plates in light guide devices; and the light emitting elements corresponding to the light guide devices, the light emitting elements emitting the external light, the drive circuit including a controller for controlling current supplies to the light emitting elements.

According to the structure, the controller controls the current supplies to the light emitting elements corresponding to the light guide devices of the lighting device.

Light emitting elements, even if they generate light of the same color, will still differ in their nature. Therefore, if the light emitting elements are fed with the same current, they produce different light (luminance in the case of those elements which produce light of the same color and luminance or hue in the case of those which produce light of different colors).

Therefore, by controlling the current supplies to the light emitting elements, the light emitting elements come to produce identical light.

Therefore, uniform light is projected through the predetermined surface of the second light guide plate in each light guide device of the lighting device.

The drive circuit in accordance with the present invention, in the foregoing drive circuit, is characterized in that it further includes converters, one for each of the light emitting elements, the converters converting optical signals generated when the light emitting elements are lit to electric signals.

According to the structure, the converters convert optical signals generated when the light emitting elements are lit to electric signals.

Therefore, the amounts of light generated when the light emitting elements are lit are individually determined in terms of electric signal levels.

Therefore, by controlling the current supplies to the light emitting elements in accordance with the electric signal levels, uniform light is always projected through the predetermined surface.

A light guide plate in accordance with the present invention, as described in the foregoing, is a structure which includes: a light guide section for guiding predetermined light incident from a pre-set direction along a predetermined surface so that the incident light exits through the predetermined surface; and a bend section for turning external light incident to a surface opposite the predetermined surface into the pre-set direction by one reflection so that the external light enters the light guide section.

Therefore, the resultant light guide plate is suitable for reducing the thickness of the backlight device and increasing the illumination surface of the backlight device in area.

A light guide plate in accordance with the present invention, as described in the foregoing, is a structure which includes: a light guide section for guiding predetermined light incident from a pre-set direction along a predetermined surface so that the incident light exits through the predetermined surface; a bend section for turning external light incident to a surface opposite the predetermined surface into a predetermined direction by one reflection; and another light guide section for guiding inside thereof the external light turned into the predetermined direction by total reflection and turning that light into the pre-set direction at a plurality of predetermined positions so that the light enters the light guide section.

Therefore, the resultant light guide plate is suitable for reducing the thickness of the backlight device and increasing the illumination surface of the backlight device in area. In addition, the light source, emitting the external light, can be a point source.

A light guide device in accordance with the present invention, as described in the foregoing, is a structure which includes a combination of light guide plates, the light guide plates differing in predetermined surface size from each other, exit light exiting through the predetermined surface of a first light guide plate being used as the external light for a second light guide plate, the first light guide plate being one of the light guide plates which has a smaller predetermined surface, the second light guide plate being one of the light guide plates which has a larger predetermined surface.

Therefore, the light source, emitting the external light, can be a point source.

A light guide system in accordance with the present invention, as described in the foregoing, is a structure which includes: a matrix of light guide plates; light emitting elements corresponding to the light guide plates, the light emitting elements emitting the external light; and a controller for controlling current supplies to the light emitting elements.

Therefore, uniform light is projected through the predetermined surface of each light guide plate.

A light guide system in accordance with the present invention, as described in the foregoing, is a structure which includes: a matrix of second light guide plates in light guide devices; light emitting elements corresponding to the light guide device, the light emitting elements emitting the external light; and a controller for controlling current supplies to the light emitting elements.

Therefore, uniform light is projected through the predetermined surface of the second light guide plate in each light guide device.

A drive circuit in accordance with the present invention, as described in the foregoing, is a structure which includes a controller for controlling current supplies to the light emitting elements in a lighting device, the lighting device including: a matrix of light guide plates; and the light emitting elements corresponding to the light guide plates, the light emitting elements emitting the external light.

Therefore, uniform light is projected through the predetermined surface of each light guide plate in the lighting device.

A drive circuit in accordance with the present invention, as described in the foregoing, is a structure which includes a controller for controlling current supplies to the light emitting elements, the lighting device including: a matrix of second light guide plates in light guide devices; and the light emitting elements corresponding to the light guide devices, the light emitting elements emitting the external light,

Therefore, uniform light is projected through the predetermined surface of the second light guide plate in each light guide device of the lighting device.

A light guide plate in accordance with the present invention, to solve the problems, is characterized in that it includes: a light guide section for guiding light incident from a fifth direction along an illumination surface so that the incident light exits through the illumination surface; and a second surface including: a reflection region for turning external light incident to a surface opposite the illumination surface into the fifth direction by one reflection so that the external light enters the light guide section; and a transmission region allowing the external light to pass therethrough toward the illumination surface.

According to the structure, the reflection region of the second surface turns the external light incident to a surface opposite the illumination surface into the fifth direction by one reflection so that the light enters the light guide section. In addition, the light guide section guides the light turned into the fifth direction and entering the light guide section so that the light exits through the illumination surface.

Since a single reflection brings the light into the light guide section, the light guide plate itself can be made relatively thin when compared to structures where multiple reflections are involved.

In addition, the light guide section guides the light incident from the first direction along the illumination surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the illumination surface can be readily combined with other such surfaces in a matrix when compared to the structure of conventional edge-lit type backlights. These individual factors all facilitate the realization of a large illumination surface for a backlight device.

Therefore, the resultant light guide plate is suitable for reducing the thickness of the backlight device and increasing the illumination surface of the backlight device in area.

With the light guide plate in accordance with the present invention, the transmission region of the second surface allows passage of the external light therethrough toward the illumination surface. Therefore, the external light is projected also through the illumination surface of the second surface toward the illumination surface. Therefore, relatively uniform light is projected toward the illumination surface when compared to light guide plates of which the entire second surface is the reflection region.

The light guide plate in accordance with the present invention, in the foregoing light guide plate, is characterized in that it further includes scattering means for scattering the light transmitted through the transmission region toward the illumination surface.

According to the structure, the scattering means scatters the light passed through the transmission region toward the illumination surface.

Therefore, relatively uniform light is projected from the illumination surface when compared to structures including no scattering means.

The light guide plate in accordance with the present invention, in the foregoing light guide plate, is characterized in that it further includes reflection means for reflecting the light transmitted through the transmission region and guiding the light toward the illumination surface.

According to the structure, the reflection means reflects the light transmitted through the transmission region. Further, the reflection means guides the transmitted light toward the illumination surface.

Therefore, the paths of the light transmitted through the transmission region and exiting the light guide plate is extended when compared to structures including no reflection means.

Therefore, in the structure where the light source emitting the external light radiates the external light, relatively uniform light is projected from the illumination surface when compared to structures including no reflection means.

The light guide plate in accordance with the present invention, in the foregoing light guide plate, is characterized in that it further includes scattering means for scattering the light reflected from the reflection means toward the illumination surface.

According to the structure, the scattering means scatters the light transmitted through the transmission region toward the illumination surface.

Therefore, relatively uniform light is projected from the illumination surface when compared to structures including no scattering means.

The light guide plate in accordance with the present invention, in the foregoing light guide plate, is characterized in that the second surface includes a plurality of transmission regions.

According to the structure, the second surface includes the plurality of transmission regions.

Therefore, relatively uniform light is projected from the illumination surface when compared to structures including only one transmission region.

The light guide plate in accordance with the present invention, in the foregoing light guide plate, is characterized in that: the light guide section is divided into a fifth light guide section and a sixth light guide section; the fifth and sixth light guide sections are disposed to flank the second surface; and the reflection region of the second surface turns the external light into a fifth light guide section direction which is the fifth direction toward the fifth light guide section and into a sixth light guide section direction which is the fifth direction toward the sixth light guide section.

According to the structure, the second surface turns the external light incident to the surface opposite the illumination surface into the fifth and sixth light guide section directions individually by one reflection.

Therefore, the fifth and sixth light guide sections flanking the second surface project light. In addition, if there are restrictions on the position of the light source emitting the external light, the illumination surface can project light by changing the size ratio of the fifth and sixth light guide sections.

A light guide plate in accordance with the present invention, to solve the problems, is characterized in that it includes: a light guide section for guiding light incident from a fifth direction along an illumination surface so that the incident light exits through the illumination surface; and a reflection surface for turning external light incident to a surface opposite the illumination surface into the fifth direction by one reflection so that the external light enters the light guide section, the reflection surface including at least a third reflection surface and a fourth reflection surface both being tilted with respect to the illumination surface, the fourth reflection surface being tilted with respect to the illumination surface by a smaller tilt angle than the third reflection surface and disposed opposite the illumination surface with respect to the third reflection surface.

According to the structure, the reflection surface turns the external light incident to the surface opposite the illumination surface into the fifth direction by one reflection so that the light enters the light guide section. In addition, the light guide section guides the light turned into the fifth direction and entering the light guide section so that the light exits through the illumination surface.

Since a single reflection brings the light into the light guide section, the light guide plate itself can be made relatively thin when compared to structures where multiple reflections are involved.

In addition, the light guide section guides the light incident from the fifth direction along the illumination surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface for a backlight device.

Therefore, the resultant light guide plate is suitable for reducing the thickness of the backlight device and increasing the illumination surface of the backlight device in area.

With the light guide plate in accordance with the present invention, the reflection surface includes the third and fourth reflection surfaces. The fourth reflection surface is tilted with respect to the illumination surface by a smaller tilt angle than the third reflection surface. Further, the fourth reflection surface is disposed opposite the illumination surface with respect to the third reflection surface.

Therefore, the light turned by the reflection surfaces is incident to a surface of the light guide section, thus entering the light guide section, at positions on that incident surface which are relatively far from the illumination surface of the light guide section, when compared to light guide plates which include only reflection surfaces having the same tilt angle as the third reflection surface. As a result, the light reflects from positions close to the incident surface after entering the light guide section, when compared to light guide plates which include only reflection surfaces having the same tilt angle as the third reflection surface.

Therefore, the light guide plate outputs light at positions closer to the fourth reflection surface than light guide plates which include only reflection surfaces having the same tilt angle as the third reflection surface. Therefore, uniform light is projected when compared to light guide plates which include only reflection surfaces having the same tilt angle as the third reflection surface.

The light guide plate in accordance with the present invention, in the foregoing light guide plate, is characterized in that: the light guide section is divided into a fifth light guide section and a sixth light guide section; the fifth and sixth light guide sections are disposed to flank the reflection surface; and the reflection surface reflects the external light into a fifth light guide section direction which is the fifth direction toward the fifth light guide section and into a sixth light guide section direction which is the fifth direction toward the sixth light guide section.

According to the structure, the reflection surface turns the external light incident to the surface opposite the illumination surface into the fifth and sixth light guide section directions individually by one reflection.

Therefore, the fifth and sixth light guide sections flanking the reflection surface project light. In addition, if there are restrictions on the position of the light source emitting the external light, the illumination surface can project light by changing the size ratio of the fifth and sixth light guide sections.

A light guide plate in accordance with the present invention, to solve the problems, is characterized in that it includes: a light guide section for guiding light incident from a fifth direction along an illumination surface so that the incident light exits through the illumination surface; and a reflection surface for turning external light incident to a surface opposite the illumination surface into the fifth direction by one reflection so that the external light enters the light guide section, wherein: the light guide section includes a plurality of continuous incident surfaces which allows the external light turned by the reflection surface to enter the light guide section therethrough; and those of the continuous incident surfaces which are adjacent to each other make an angle greater than 90°.

According to the structure, the reflection surface turns the external light incident to the surface opposite the illumination surface into the first direction by one reflection so that the light enters the light guide section. In addition, the light guide section guides the light turned into the fifth direction and entering the light guide section so that the light exits through the illumination surface.

Since a single reflection brings the light into the light guide section, the light guide plate itself can be made relatively thin when compared to structures where multiple reflections are involved.

In addition, the light guide section guides the light incident from the fifth direction along the illumination surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface for a backlight device.

Therefore, the resultant light guide plate is suitable for reducing the thickness of the backlight device and increasing the illumination surface of the backlight device in area.

The light guide section includes the plurality of continuous incident surfaces which guide the external light turned by the reflection surface so that the light enters the light guide section. Therefore, the light turned by the reflection surface enters the light guide section through one of the incident surfaces. Further, the continuous incident surfaces which are adjacent to each other make angle greater than 90°. the light guide plate therefore guides an increased amount of external light to positions farther away from the incident surfaces in the light guide section, when compared to light guide plates in which every pair of adjacent incident surfaces makes a right angle.

Therefore, to project a fixed amount of light through the illumination surface, the light guide section can be longer in the fifth direction than light guide plates in which every pair of adjacent incident surfaces makes a right angle.

A light guide plate in accordance with the present invention, to solve the problems, is characterized in that it includes: a light guide section for guiding light incident from a fifth direction along an illumination surface so that the incident light exits through the illumination surface; and a reflection surface for turning external light incident to a surface opposite the illumination surface into the fifth direction by one reflection so that the external light enters the light guide section, wherein: the reflection surface is constituted by a plurality of continuous planes; those of the planes which are adjacent to each other have an intersecting line thereof being tilted with respect to the illumination surface; and the planes each have a normal thereof pointing in a different direction from the others.

According to the structure, the reflection surface turns external light incident to the surface opposite the illumination surface into the fifth direction by one reflection so that the light enters the light guide section. In addition, the light guide section guides the light turned into the fifth direction and entering the light guide section so that the light exits through the illumination surface.

Since a single reflection brings the light into the light guide section, the light guide plate itself can be made relatively thin when compared to structures where multiple reflections are involved.

In addition, the light guide section guides the light incident from the fifth direction along the illumination surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface for a backlight device.

Therefore, the resultant light guide plate is suitable for reducing the thickness of the backlight device and increasing the illumination surface of the backlight device in area.

The reflection surface is constituted by the plurality of continuous planes. Further, the planes which are adjacent to each other have an intersecting line thereof being tilted with respect to the illumination surface. Therefore, after turning the external light by means of one of the planes, the light is directed to enter the light guide section.

In addition, the planes each have a normal thereof pointing in a different direction from the others. Therefore, the light guide plate directs the light turned by the reflection surface so that more uniform and radially traveling light enters the light guide section, than do light guide plates where not all normals of the plurality of planes point in different directions.

The light guide plate may be a structure in which each of the planes is a triangle with one of vertices, or an apex, thereof being common with the other planes.

The light guide plate may be a structure in which each of the planes is a sector of a circle with an intersecting point of two straight lines of the sector being common with the other planes.

A lighting device in accordance with the present invention is characterized in that it includes: the light guide plate; and a light emitting element emitting the external light.

According to the structure, the lighting device achieves the same effects as the aforementioned light guide plate.

The lighting device in accordance with the present invention, in the foregoing lighting device, is characterized in that the external light is emitted by an LED.

According to the structure, the external light is emitted by an LED.

Therefore, the light source, emitting the external light, can be an LED.

A light guide plate in accordance with the present invention, as described in the foregoing, is a structure which includes: a light guide section for guiding light incident from a fifth direction along an illumination surface so that the incident light exits through the illumination surface; and a second surface including: a reflection region for turning external light incident to a surface opposite the illumination surface into the fifth direction by one reflection so that the external light enters the light guide section; and a transmission region allowing the external light to pass therethrough toward the illumination surface.

Therefore, the resultant light guide plate is suitable for reducing the thickness of the backlight device and increasing the illumination surface of the backlight device in area. In addition, relatively uniform light is projected toward the illumination surface when compared to light guide plates of which the entire second surface is the reflection region.

A light guide plate in accordance with the present invention, as described in the foregoing, is a structure which includes: a light guide section for guiding light incident from a fifth direction along an illumination surface so that the incident light exits through the illumination surface; and a reflection surface for turning external light incident to a surface opposite the illumination surface into the fifth direction by one reflection so that the external light enters the light guide section, the reflection surface including at least a third reflection surface and a fourth reflection surface both being tilted with respect to the illumination surface, the fourth reflection surface being tilted with respect to the illumination surface by a smaller tilt angle than the third reflection surface and disposed opposite the illumination surface with respect to the third reflection surface.

Therefore, the resultant light guide plate is suitable for reducing the thickness of the backlight device and increasing the illumination surface of the backlight device in area. In addition, relatively uniform light is projected when compared to light guide plates of which the entire reflection surface is the third reflection surface.

The light guide plate in accordance with the present invention, as described in the foregoing, is a structure which includes: a light guide section for guiding light incident from a fifth direction along an illumination surface so that the incident light exits through the illumination surface; and a reflection surface for turning external light incident to a surface opposite the illumination surface into the fifth direction by one reflection so that the external light enters the light guide section, wherein: the light guide section includes a plurality of continuous incident surfaces which allows the external light turned by the reflection surface to enter the light guide section therethrough; and those of the continuous incident surfaces which are adjacent to each other make an angle greater than 90°.

Therefore, the resultant light guide plate is suitable for reducing the thickness of the backlight device and increasing the illumination surface of the backlight device in area. In addition, to project a fixed amount of light through the illumination surface, the light guide section can be longer in the fifth direction than light guide plates in which every pair of adjacent incident surfaces makes a right angle.

A light guide plate in accordance with the present invention, as described in the foregoing, is a structure which includes: a light guide section for guiding light incident from a fifth direction along an illumination surface so that the incident light exits through the illumination surface; and a reflection surface for turning external light incident to a surface opposite the illumination surface into the fifth direction by one reflection so that the external light enters the light guide section, wherein: the reflection surface is constituted by a plurality of continuous planes; those of the planes which are adjacent to each other have an intersecting line thereof being tilted with respect to the illumination surface; and the planes each have a normal thereof pointing in a different direction from the others.

Therefore, the resultant light guide plate is suitable for reducing the thickness of the backlight device and increasing the illumination surface of the backlight device in area. In addition, the light guide plate directs the light turned by the reflection surface so that more uniform and radially traveling light enters the light guide section, than do light guide plates where not all normals of the plurality of planes point in different directions.

A lighting device in accordance with the present invention, as described in the foregoing, is a structure which includes the light guide plate and the light emitting elements emitting the external light.

Therefore, the lighting device achieves the same effects as the aforementioned light guide plate.

A light guide plate in accordance with the present invention, to solve the problems, is characterized in that it includes: a light guide section for guiding predetermined light incident from a sixth direction along a predetermined surface so that the incident light exits through the predetermined surface; a bend section for turning external light incident to a surface opposite the predetermined surface into a seventh direction by one reflection; and another light guide section for guiding inside thereof the external light turned into the seventh direction by total reflection and reflecting that light into the sixth direction from a plurality of reflection surfaces so that the light enters the light guide section, wherein the reflection surfaces grow in area with increasing distance from the bend section.

According to the structure, the bend section turns the external light incident to a surface opposite the predetermined surface into the seventh direction by one reflection. In addition, the other light guide section reflects the external light turned into the seventh direction into the sixth direction from the reflection surfaces so that the light enters the light guide section. Further, the light guide section guides the light reflecting into the sixth direction and entering the light guide section so that the light exits through the predetermined surface.

Since a single reflection brings the light into the light guide section, the light guide plate itself can be made relatively thin when compared to structures where multiple reflections are involved.

In addition, the light guide section guides the predetermined light along a predetermined surface; the light source, emitting the external light, can therefore be disposed in relatively close proximity to the surface opposite the light guide plate when compared to the structure of conventional direct backlights.

Further, since the light source, emitting the external light, does not need to be disposed on an edge of the light guide plate, the predetermined surface can be readily combined with other such surfaces in a matrix when compared to the structure of conventional edge-lit type backlights. These individual factors all facilitate the realization of a large illumination surface.

Therefore, the resultant light guide plate is suitable for reducing the thickness of the backlight device and increasing the illumination surface of the backlight device in area.

The other light guide section reflects the external light from the reflection surfaces into the sixth direction toward the light guide section. Therefore, the predetermined light entering the light guide section is linear even when the light source, emitting the external light, is a point source. The light guide section then tweaks the linear light so that planar light exits through the predetermined surface.

Therefore, the light source, emitting the external light, can be a point source.

Since the aforementioned reflections of light occur on the reflection surfaces of the other light guide section, the amount of light (external light) guided inside the other light guide section by total reflections decreases with increasing distance from the bend section. Therefore, if the reflection surfaces had equal areas, the farther away from the bend section the reflection surface is located, the less amount of light the reflection surface would reflect.

In the light guide plate in accordance with the present invention, however, the reflection surfaces grow in area with increasing distance from the bend section. Therefore, the amount of reflected light decreases by a relatively small amount when compared to cases where the reflection surfaces have equal areas.

Therefore, a relatively uniform amount of light (predetermined light) is directed to enter the light guide section when compared to cases where the reflection surfaces have equal areas.

Therefore, a relatively uniform amount of light is projected from the predetermined surface when compared to cases where the reflection surfaces have equal areas.

The light guide plate in accordance with the present invention, in the foregoing light guide plate, is characterized in that: those of the reflection surfaces which are adjacent to each other in the seventh direction are parallel to each other.

According to the structure, the reflection surfaces adjacent to each other in the second direction are parallel to each other. Therefore, relatively uniform light enters the light guide section when compared to cases where the reflection surfaces are not parallel to each other.

Therefore, a relatively uniform amount of light is projected from the predetermined surface when compared to cases where the reflection surfaces are not parallel to each other.

The light guide plate in accordance with the present invention, in the foregoing light guide plate, is characterized in that: the reflection surfaces are perpendicular to the predetermined surface.

According to the structure, the reflection surfaces are perpendicular to the predetermined surface. Therefore, light is guided efficiently to enter the light guide section when compared to cases where the reflection surfaces are not perpendicular to the predetermined surface.

Therefore, an increased amount of light is projected from the predetermined surface when compared to cases where the reflection surfaces are not perpendicular to the predetermined surface.

The light guide plate in accordance with the present invention, in the foregoing light guide plate, is characterized in that: the reflection surfaces are rectangular, each having sides parallel to the predetermined surface and sides perpendicular to the predetermined surface; the parallel sides are all of an equal length; and the perpendicular sides grow in length with increasing distance from the bend section.

According to the structure, the sides of the reflection surfaces parallel to the predetermined surface are all of an equal length. The sides perpendicular to the predetermined surface grow in length with increasing distance from the bend section.

Therefore, the reflection surfaces grow in area with increasing distance from the bend section.

The light guide plate in accordance with the present invention, in the foregoing light guide plate, is characterized in that: the other light guide section includes a plurality of groove sections on a surface opposite the predetermined surface; the groove sections have equal lengths in a direction of extension of grooves; the groove sections grow in depth with increasing distance from the bend section; and the groove sections each have a wall, close to the bend section, which provides a reflection surface.

According to the structure, the groove sections have equal lengths in the direction of the extension of the grooves and grow in depth with increasing distance from the bend section; therefore, the farther the groove section is located from the bend section, the larger in area the wall of the groove section close to the bend section. Further, the groove section each have a wall, close to the bend section, which provides the reflection surface.

Therefore, the reflection surfaces grow in area with increasing distance from the bend section.

The light guide plate in accordance with the present invention, in the foregoing light guide plate, is characterized in that: the other light guide section is divided into a seventh light guide section and an eighth light guide section; the seventh and eighth light guide sections are disposed to flank the bend section; and the bend section turns the external light incident to a surface opposite the predetermined surface into a seventh light guide section direction which is the seventh direction toward the seventh light guide section and into an eighth light guide section direction which is the seventh direction toward the eighth light guide section.

According to the structure, the bend section turns the external light incident to a surface opposite the predetermined surface into the seventh and eighth light guide section directions individually by one reflection.

Thus, the light travels in the two light guide sections (seventh and eighth light guide sections) flanking the bend section and exits through the predetermined surface of the light guide section.

The light guide plate in accordance with the present invention, in the foregoing light guide plate, is characterized in that: the light guide section is divided into a ninth light guide section and a tenth light guide section; the ninth and tenth light guide sections are disposed to flank the bend section and the seventh and eighth light guide sections; and both the seventh and eighth light guide sections turn the internally guided light into a ninth light guide section direction which is the sixth direction toward the ninth light guide section and into a tenth light guide section direction which is the sixth direction toward the tenth light guide section.

According to the structure, the seventh light guide section turns the internally guided light into a ninth light guide section direction which is the sixth direction toward the ninth light guide section and into a tenth light guide section direction which is the sixth direction toward the tenth light guide section. Similarly, the eighth light guide section turns the internally guided light into the ninth and tenth light guide section directions.

Thus, the light travels in the two light guide sections (seventh and eighth light guide sections) and exits through the predetermined surface of the two light guide sections (ninth and tenth light guide sections) flanking the bend section and the seventh and eighth light guide sections.

The light guide plate in accordance with the present invention, in the foregoing light guide plate, is characterized in that: the bend section has a first reflection surface for the bend section and a second reflection surface for the bend section both reflecting the external light; and the first reflection surface for the bend section turns the external light incident to a surface opposite the predetermined surface into the seventh light guide section direction, and the second reflection surface for the bend section turns the external light incident to a surface opposite the predetermined surface into the eighth light guide section direction.

According to the structure, the first reflection surface for the bend section turns the external light incident to a surface opposite the predetermined surface into the seventh light guide section direction. In addition, the second reflection surface for the bend section turns the external light incident to a surface opposite the predetermined surface into the eighth light guide section direction.

Therefore, the bend section has a simple structure.

The light guide plate in accordance with the present invention, in the foregoing light guide plate, is characterized in that: the first and second reflection surfaces for the bend section are identical in shape and disposed adjacent to each other to provide two side faces of a triangular column; and the first and second reflection surfaces for the bend section are tilted an equal angle with respect to a specified plane in mutually opposite directions, the specified plane being perpendicular to the predetermined surface and including an intersecting line of the first and second reflection surfaces for the bend section.

According to the structure, the amounts of light reflecting from the first and second reflection surfaces for the bend section are made equal to each other by projecting external light from a position on the specified plane toward the predetermined surface.

Therefore, the same amounts of light enter the seventh and eighth light guide sections.

The light guide plate in accordance with the present invention, in the foregoing light guide plate, is characterized in that: the other light guide section guides inside thereof by total reflection the external light incident to a surface opposite the predetermined surface which directly enters the other light guide section without being turned by the bend section, and the other light guide section then reflects that external light from the reflection surfaces into the sixth direction so that the light enters the light guide section.

According to the structure, the other light guide section guides inside thereof also the external light not turned by the bend section and reflects the guided light into the sixth direction so that the light enters the light guide section.

Therefore, the amount of light exiting through the predetermined surface is less affected by the radiation properties of the external light incident to the surface opposite the predetermined surface.

Therefore, an increased amount of light exits through the predetermined surface.

A lighting device in accordance with the present invention, to solve the problems, is characterized in that in includes: the light guide plate of; and a light emitting element emitting the external light.

According to the structure, the lighting device achieves the same effects as the aforementioned light guide plate.

A light guide plate in accordance with the present invention, to solve the problems, is characterized in that it includes: the light guide plate; and a light emitting element emitting the external light, the light emitting element being disposed so that a light emitting surface thereof is symmetric with respect to the specified plane.

According to the structure, the external light is projected toward the predetermined surface from the light emitting surface positioned symmetric with respect to the specified plane.

Therefore, a lighting device is provided in which the amounts of light reflecting from the first and second reflection surfaces for the bend section are made equal to each other.

The lighting device in accordance with the present invention, in the foregoing lighting device, is characterized in that: the external light is emitted by an LED.

According to the structure, the external light is emitted by an LED.

Therefore, the light source, emitting the external light, can be an LED.

The light guide plate in accordance with the present invention, as described in the foregoing, is a structure which includes: a light guide section for guiding predetermined light incident from a sixth direction along a predetermined surface so that the incident light exits through the predetermined surface; a bend section for turning external light incident to a surface opposite the predetermined surface into a seventh direction by one reflection; and another light guide section for guiding inside thereof the external light turned into the seventh direction by total reflection and reflecting that light into the sixth direction from a plurality of reflection surfaces so that the light enters the light guide section, wherein the reflection surfaces grow in area with increasing distance from the bend section.

Therefore, the resultant light guide plate is suitable for reducing the thickness of the backlight device and increasing the illumination surface of the backlight device in area. In addition, the light source, emitting the external light, can be a point source. Further, a relatively uniform amount of light exits through the predetermined surface when compared to cases where the reflection surfaces have equal areas.

The lighting device in accordance with the present invention, as described in the foregoing, is a structure which includes: the light guide plate and a light emitting element emitting the external light.

Therefore, the lighting device achieves the same effects as the aforementioned light guide plate.

The light guide plate in accordance with the present invention, as described in the foregoing, is a structure which includes: the light guide plate; and a light emitting element emitting the external light, the light emitting element being disposed so that a light emitting surface thereof is symmetric with respect to the specified plane.

Therefore, a lighting device is provided in which the amounts of light reflecting from the first and second reflection surfaces for the bend section are made equal to each other.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A light guide plate, comprising:
a light guide section for guiding predetermined light incident from a pre-set direction along a predetermined surface so that the incident light exits through the predetermined surface; and
a bend section for turning external light incident to a surface opposite the predetermined surface into the pre-set direction by one reflection so that the external light enters the light guide section.

2. The light guide plate of claim 1, wherein:
the predetermined light is incident to a first surface of the light guide section; and
the first surface is tilted with respect to a surface perpendicular to the predetermined surface in such an orientation that the first surface refracts the turned external light toward the predetermined surface.

3. The light guide plate of claim 1, wherein:
the predetermined light is incident to a first surface of the light guide section; and
the light guide section has an end surface, opposite the first surface, to which is applied a light-reflecting material or a light-scattering material; and
the end surface has a tilt surface tilted with respect to the predetermined surface toward the first surface.

4. The light guide plate of claim 1, wherein:
the light guide section is divided into a first light guide section and a second light guide section;
the first and second light guide sections are disposed to flank the bend section; and
the bend section turns the external light into a first direction which is the pre-set direction toward the first light guide section and into a second direction which is the pre-set direction toward the second light guide section.

5. The light guide plate of claim 4, wherein:
the bend section has a first reflection surface and a second reflection surface both reflecting the external light; and
the first reflection surface turns the external light into the first direction, and the second reflection surface turns the external light into the second direction.

6. The light guide plate of claim 5, wherein:
the first and second reflection surfaces are identical in shape and disposed adjacent to each other to provide two side faces of a triangular column; and
the first and second reflection surfaces are tilted an equal angle with respect to a specified plane in mutually opposite directions, the specified plane being perpendicular to the predetermined surface and including an intersecting line of the first and second reflection surfaces.

7. The light guide plate of claim 4, wherein
the first and second light guide sections are symmetric.

8. A light guide plate, comprising:
a light guide section for guiding predetermined light incident from a pre-set direction along a predetermined surface so that the incident light exits through the predetermined surface;
a bend section for turning external light incident to a surface opposite the predetermined surface into a predetermined direction by one reflection; and
another light guide section for guiding inside thereof the external light turned into the predetermined direction by total reflection and turning that light into the pre-set direction at a plurality of predetermined positions so that the light enters the light guide section.

9. The light guide plate of claim 8, wherein:
the other light guide section is divided into a first light guide section and a second light guide section;
the first and second light guide sections are disposed to flank the bend section; and
the bend section turns the external light into a first direction which is the predetermined direction toward the first light guide section and into a second direction which is the predetermined direction toward the second light guide section.

10. The light guide plate of claim 9, wherein:
the light guide section is divided into a third light guide section and a fourth light guide section;
the third and fourth light guide sections are disposed to flank the bend section and the first and second light guide sections;
both the first and second light guide sections turn the internally guided light into a third direction which is the pre-set direction toward the third light guide section and into a fourth direction which is the pre-set direction toward the fourth light guide section.

11. The light guide plate of claim 1, wherein
the external light is emitted by an LED.

12. A lighting device, comprising:
the light guide plate of claim 6; and
a light emitting element emitting the external light, the light emitting element being disposed so that a light emitting surface thereof is symmetric with respect to the specified plane.

13. The lighting device of claim 12, further comprising
light emitting elements emitting different colors of light, each light emitting element being disposed so that a light emitting surface thereof is symmetric with respect to the specified plane.

14. A light guide device, comprising a combination of light guide plates of claim 4, the light guide plates differing in predetermined surface size from each other,
exit light exiting through the predetermined surface of a first light guide plate being used as the external light for a second light guide plate, the first light guide plate being one of the light guide plates which has a smaller predetermined surface, the second light guide plate being one of the light guide plates which has a larger predetermined surface.

15. A light guide system, comprising:
a matrix of light guide plates of claim 1;
light emitting elements corresponding to the light guide plates, the light emitting elements emitting the external light; and
a controller for controlling current supplies to the light emitting elements.

16. A light guide system, comprising:
a matrix of second light guide plates in light guide devices of claim 14;
light emitting elements corresponding to the light guide devices, the light emitting elements emitting the external light; and
a controller for controlling current supplies to the light emitting elements.

17. The light guide system of claim 15, further comprising
converters, one for each of the light emitting elements, the converters converting optical signals generated when the light emitting elements are lit to electric signals.

18. The light guide system of claim 15, further comprising
converters, one for each pair of two adjacent light guide plates, provided on boarders of the light guide plates, the converters converting optical signals generated when the light emitting elements are lit to electric signals,
wherein:
one light emitting element is provided for each pair of light guide plates; and
the converters convert optical signals generated when the light emitting elements are lit at different timings to corresponding electric signals.

19. The light guide system of claim 15, further comprising
converters, one for each group of 2×2=4 light guide plates, provided at centers of the light guide plates, the converters converting optical signals generated when the light emitting elements are lit to electric signals,
wherein:
one light emitting element is provided for each group of light guide plates; and
the converters convert optical signals generated when the light emitting elements are lit at different timings to corresponding electric signals.

20. The light guide system of claim 17, wherein:
the controller changes the current supplies to the light emitting elements on the basis of the electric signals.

21. A drive circuit for supplying current to light emitting elements in a lighting device, the lighting device including: a matrix of light guide plates of claim 1; and the light emitting elements corresponding to the light guide plates, the light emitting elements emitting the external light,
the drive circuit comprising a controller for controlling current supplies to the light emitting elements.

22. A drive circuit for supplying current to light emitting elements in a lighting device, the lighting device including: a matrix of second light guide plates in light guide devices of claim 14; and the light emitting elements corresponding to the light guide devices, the light emitting elements emitting the external light,
the drive circuit comprising a controller for controlling current supplies to the light emitting elements.

23. The drive circuit of claim 21, further comprising
converters, one for each of the light emitting elements, the converters converting optical signals generated when the light emitting elements are lit to electric signals.

24. A light guide plate, comprising:
a light guide section for guiding light incident from a fifth direction along an illumination surface so that the incident light exits through the illumination surface; and
a second surface including: a reflection region for turning external light incident to a surface opposite the illumination surface into the fifth direction by one reflection so that the external light enters the light guide section; and a transmission region allowing the external light to pass therethrough toward the illumination surface.

25. The light guide plate of claim 24, further comprising
scattering means for scattering the light transmitted through the transmission region toward the illumination surface.

26. The light guide plate of claim 24, further comprising
reflection means for reflecting the light transmitted through the transmission region and guiding the light toward the illumination surface.

27. The light guide plate of claim 26, further comprising
scattering means for scattering the light reflected from the reflection means toward the illumination surface.

28. The light guide plate of claim 24, wherein:
the second surface includes a plurality of transmission regions.

29. The light guide plate of claim 24, wherein:
the light guide section is divided into a fifth light guide section and a sixth light guide section;
the fifth and sixth light guide sections are disposed to flank the second surface; and
the reflection region of the second surface turns the external light into a fifth light guide section direction which is the fifth direction toward the fifth light guide section and into a sixth light guide section direction which is the fifth direction toward the sixth light guide section.

30. A light guide plate, comprising:
a light guide section for guiding light incident from a fifth direction along an illumination surface so that the incident light exits through the illumination surface; and
a reflection surface for turning external light incident to a surface opposite the illumination surface into the fifth direction by one reflection so that the external light enters the light guide section, the reflection surface including at least a third reflection surface and a fourth reflection surface both being tilted with respect to the illumination surface, the fourth reflection surface being tilted with respect to the illumination surface by a smaller tilt angle than the third reflection surface and disposed opposite the illumination surface with respect to the third reflection surface.

31. The light guide plate of claim 30, wherein:
the light guide section is divided into a fifth light guide section and a sixth light guide section;
the fifth and sixth light guide sections are disposed to flank the reflection surface; and
the reflection surface reflects the external light into a fifth light guide section direction which is the fifth direction toward the fifth light guide section and into a sixth light guide section direction which is the fifth direction toward the sixth light guide section.

32. A light guide plate, comprising:
a light guide section for guiding light incident from a fifth direction along an illumination surface so that the incident light exits through the illumination surface; and
a reflection surface for turning external light incident to a surface opposite the illumination surface into the fifth direction by one reflection so that the external light enters the light guide section,
wherein:
the light guide section includes a plurality of continuous incident surfaces which allows the external light turned by the reflection surface to enter the light guide section therethrough; and
those of the continuous incident surfaces which are adjacent to each other make an angle greater than 90°.

33. A light guide plate, comprising:
a light guide section for guiding light incident from a fifth direction along an illumination surface so that the incident light exits through the illumination surface; and
a reflection surface for turning external light incident to a surface opposite the illumination surface into the fifth direction by one reflection so that the external light enters the light guide section,
wherein:
the reflection surface is constituted by a plurality of continuous planes;
those of the planes which are adjacent to each other have an intersecting line thereof being tilted with respect to the illumination surface; and
the planes each have a normal thereof pointing in a different direction from the others.

34. The light guide plate of claim 33, wherein:
each of the planes is a triangle with one of vertices, or an apex, thereof being common with the other planes.

35. The light guide plate of claim 33, wherein:
each of the planes is a sector of a circle with an intersecting point of two straight lines of the sector being common with the other planes.

36. A lighting device, compromising:
the light guide plate of claim 1; and
a light emitting element emitting the external light.

37. The lighting device of claim 36, wherein:
the external light is emitted by an LED.

38. A light guide plate, comprising:
a light guide section for guiding predetermined light incident from a sixth direction along a predetermined surface so that the incident light exits through the predetermined surface;
a bend section for turning external light incident to a surface opposite the predetermined surface into a seventh direction by one reflection; and
another light guide section for guiding inside thereof the external light turned into the seventh direction by total reflection and reflecting that light into the sixth direction from a plurality of reflection surfaces so that the light enters the light guide section,
wherein
the reflection surfaces grow in area with increasing distance from the bend section.

39. The light guide plate of claim 38, wherein:
those of the reflection surfaces which are adjacent to each other in the seventh direction are parallel to each other.

40. The light guide plate of claim 38, wherein:
the reflection surfaces are perpendicular to the predetermined surface.

41. The light guide plate of claim 40, wherein:
the reflection surfaces are rectangular, each having sides parallel to the predetermined surface and sides perpendicular to the predetermined surface;
the parallel sides are all of an equal length; and
the perpendicular sides grow in length with increasing distance from the bend section.

42. The light guide plate of claim 38, wherein:
the other light guide section includes a plurality of groove sections on a surface opposite the predetermined surface;
the groove sections have equal lengths in a direction of extension of grooves;
the groove sections grow in depth with increasing distance from the bend section; and
the groove sections each have a wall, close to the bend section, which provides a reflection surface.

43. The light guide plate of claim 38, wherein:
the other light guide section is divided into a seventh light guide section and an eighth light guide section;
the seventh and eighth light guide sections are disposed to flank the bend section; and
the bend section turns the external light incident to a surface opposite the predetermined surface into a seventh light guide section direction which is the seventh direction toward the seventh light guide section and into an eighth light guide section direction which is the seventh direction toward the eighth light guide section.

44. The light guide plate of claim 43, wherein:
the light guide section is divided into a ninth light guide section and a tenth light guide section;
the ninth and tenth light guide sections are disposed to flank the bend section and the seventh and eighth light guide sections; and
both the seventh and eighth light guide sections turn the internally guided light into a ninth light guide section direction which is the sixth direction toward the ninth light guide section and into a tenth light guide section direction which is the sixth direction toward the tenth light guide section.

45. The light guide plate of claim 43, wherein:
the bend section has a first reflection surface for the bend section and a second reflection surface for the bend section both reflecting the external light; and
the first reflection surface for the bend section turns the external light incident to a surface opposite the predetermined surface into the seventh light guide section direction, and the second reflection surface for the bend section turns the external light incident to a surface opposite the predetermined surface into the eighth light guide section direction.

46. The light guide plate of claim 45, wherein:
the first and second reflection surfaces for the bend section are identical in shape and disposed adjacent to each other to provide two side faces of a triangular column; and
the first and second reflection surfaces for the bend section are tilted an equal angle with respect to a specified plane in mutually opposite directions, the specified plane being perpendicular to the predetermined surface and including an intersecting line of the first and second reflection surfaces for the bend section.

47. The light guide plate of claim 38, wherein:
the other light guide section guides inside thereof by total reflection the external light incident to a surface opposite the predetermined surface which directly enters the other light guide section without being turned by the bend section, and the other light guide section then reflects that external light from the reflection surfaces into the sixth direction so that the light enters the light guide section.

48. A lighting device, comprising:
the light guide plate of claim 38; and
a light emitting element emitting the external light.

49. A lighting device, comprising:
the light guide plate of claim 46; and
a light emitting element emitting the external light, the light emitting element being disposed so that a light emitting surface thereof is symmetric with respect to the specified plane.

50. The lighting device of claim 48, wherein:
the external light is emitted by an LED.
